(19) United States
(12) Patent Application Publication
(10) Pub. No.: US 2021/0155814 A1
(43) Pub. Date: May 27, 2021

(54) ACTIVE-ENERGY-RAY-CURABLE AQUEOUS COMPOSITION, ACTIVE-ENERGY-RAY-CURABLE AQUEOUS INK, STORED CONTAINER, IMAGE FORMING APPARATUS, IMAGE FORMING METHOD, CURED PRODUCT, AND DECORATED PRODUCT

(71) Applicants: Masahide Kobayashi, Kanagawa (JP); Mitsunobu Morita, Shizuoka (JP); Takashi Okada, Kanagawa (JP); Takenori Suenaga, Kanagawa (JP); Soh Noguchi, Kanagawa (JP); Tatsuki Yamaguchi, Kanagawa (JP)

(72) Inventors: Masahide Kobayashi, Kanagawa (JP); Mitsunobu Morita, Shizuoka (JP); Takashi Okada, Kanagawa (JP); Takenori Suenaga, Kanagawa (JP); Soh Noguchi, Kanagawa (JP); Tatsuki Yamaguchi, Kanagawa (JP)

(21) Appl. No.: 17/104,622

(22) Filed: Nov. 25, 2020

(30) Foreign Application Priority Data
Nov. 26, 2019 (JP) 2019-213476

(51) Int. Cl. C09D 11/101; B41J 11/00; B41J 2/175; B33Y 70/00; B33Y 80/00; B33Y 30/00; B33Y 10/00; B29C 64/264; C08F 220/58

(52) U.S. Cl. CPC C09D 11/101; B41J 11/002; B41J 2/17503; B33Y 70/00; B29C 64/124; B33Y 30/00; B33Y 10/00; B29C 64/264; C08F 220/58; B33Y 80/00

(57) ABSTRACT

An active-energy-ray-curable aqueous composition is provided that contains water, a polymerizable compound that undergoes radical polymerization in response to active energy rays, and a polymerization initiator (C1) that produces radicals in response to active energy rays. The polymerizable compound contains an acrylamide compound (A1) represented by General formula (1) or (4), and a bifunctional or higher polymerizable compound (B1):

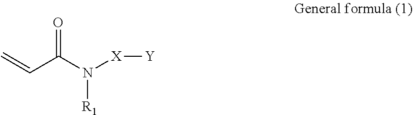

where R₁ represents a C1-C6 alkyl group, X represents a C1-C6 alkylene, and Y represents a group represented by General formula (2) or (3):

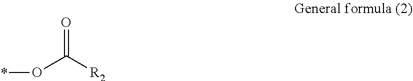

where R₂ represents a C1-C10 alkyl group, and * represents a binding site with the X:

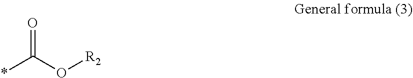

whererR₂ represents a C1-C10 alkyl group, and * represents a binding site with the X:

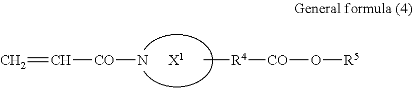

where the ring X¹ represents a ring structure containing a nitrogen atom and from two through five carbon atoms, R⁴ represents a single bond, or a straight-chained or branched C1-C3 alkylene group, and R⁵ represents a straight-chained or branched C1-C10 alkyl group.

### CROSS-REFERENCE TO RELATED APPLICATIONS

This patent application is based on and claims priority pursuant to 35 U.S.C. § 119(a) to Japanese Patent Application No. 2019-213476, filed on Nov. 26, 2019, in the Japan Patent Office, the entire disclosure of which is hereby incorporated by reference herein.

### BACKGROUND

### Technical Field

The present disclosure relates to an active-energy-ray-curable aqueous composition, an active-energy-ray-curable aqueous ink, a stored container, an image forming apparatus, an image forming method, a cured product, and a decorated product.

### Description of the Related Art

In recent years, inkjet printing methods have been rapidly spreading for the reasons that the inkjet recording methods can easily print color images and have low running costs.

As the inkjet printing inks, aqueous dye inks obtained by dissolving dyes in aqueous media and solvent inks obtained by dissolving oil-soluble dyes in organic solvents are used. From environment and safety-related viewpoints, inks obtained by dissolving water-soluble dyes in water or in water and water-soluble organic solvents are generally used in offices and households.

Aqueous pigment inks obtained by dispersing particulate pigments in water have been paid attention. Inkjet printing inks using water-dispersible pigments are known to be excellent in water resistance and light resistance.

In recent years, an aqueous pigment ink has been proposed which contains water as a main agent and a radical reactive polymerizable material having an acrylate structure in part of the structure thereof, where the ink can form an ink film having scratch resistance through a radical reaction.

### SUMMARY

According to an aspect of the present disclosure, an active-energy-ray-curable aqueous composition of the present disclosure contains water, a polymerizable compound that undergoes radical polymerization in response to active energy rays, and a polymerization initiator (C1) that produces radicals in response to active energy rays. The polymerizable compound contains at least one kind of an acrylamide compound (A1) selected from the group consisting of acrylamide compounds represented by General formula (1) below and acrylamide compounds represented by General formula (4) below, and a bifunctional or higher polymerizable compound (B1).

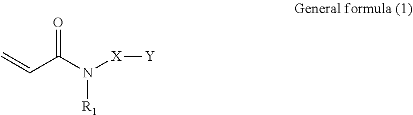

In General formula (1), R₁ represents an alkyl group containing from one through six carbon atoms, X represents an alkylene group containing from one through six carbon atoms, and Y represents a group represented by General formula (2) below or General formula (3) below.

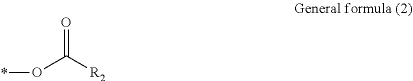

In General formula (2), R₂ represents an alkyl group containing from one through ten carbon atoms, and * represents a binding site with the X.

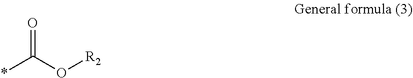

In General formula (3), R₂ represents an alkyl group containing from one through ten carbon atoms, and * represents a binding site with the X.

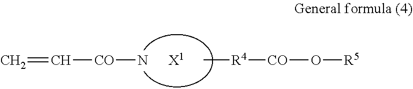

In General formula (4), the ring X¹ represents a ring structure containing a nitrogen atom and from two through five carbon atoms, R⁴ represents a single bond, or a straight-chained or branched alkylene group containing from one through three carbon atoms, and R⁵ represents a straight-chained or branched alkyl group containing from one through ten carbon atoms.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic view illustrating an example of an image forming apparatus of the present disclosure;

FIG. 2 is a schematic view illustrating another example of an image forming apparatus of the present disclosure; and

FIGS. 3A to 3D are schematic views illustrating yet another example of an image forming apparatus of the present disclosure.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

The present disclosure can provide an active-energy-ray-curable aqueous composition excellent in scratch resistance and storage stability and safe in skin sensitizing potential. Safety in skin sensitizing potential means that a SI value, which is a degree of sensitizing potential, is 3 or lower in a skin sensitization test by the LLNA method.

The “LLNA method” mentioned above is a skin sensitization test stipulated in OECD (Organisation for Economic Co-operation and Development) Test Guidelines. As described in literatures (e.g., “Functional Material”, September 2005 issue, Vol. 25, No. 9, p. 55), LLNA method judges that a stimulation index (SI value) of 3 or lower as a degree of skin sensitizing potential is non-problematic in terms of skin sensitizing potential.

### (Active-Energy-Ray-Curable Aqueous Composition)

An active-energy-ray-curable aqueous composition of the present disclosure is an active-energy-ray-curable aqueous composition containing water, a polymerizable compound that undergoes radical polymerization in response to active energy rays, and a polymerization initiator (C1) that produces radicals in response to active energy rays. The polymerizable compound contains at least one kind of an acrylamide compound (A1) selected from the group consisting of acrylamide compounds represented by General formula (1) below and acrylamide compounds represented by General formula (4) below, and a bifunctional or higher polymerizable compound (B1). The active-energy-ray-curable aqueous composition further contains other components as needed.

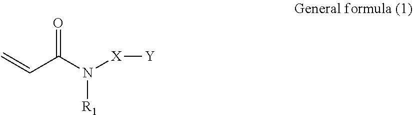

In General formula (1), R₁ represents an alkyl group containing from one through six carbon atoms, X represents an alkylene group containing from one through six carbon atoms, and Y represents a group represented by General formula (2) below or General formula (3) below.

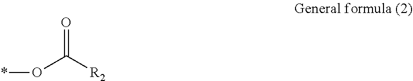

In General formula (2), R₂ represents an alkyl group containing from one through ten carbon atoms, and * represents a binding site with the X.

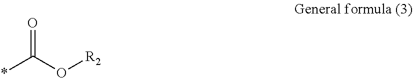

In General formula (3), R₂ represents an alkyl group containing from one through ten carbon atoms, and * represents a binding site with the X.

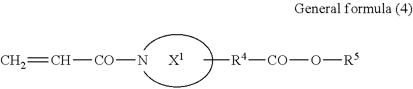

In General formula (4), the ring X¹ represents a ring structure containing a nitrogen atom and from two through five carbon atoms, R⁴ represents a single bond, or a straight-chained or branched alkylene group containing from one through three carbon atoms, and R⁵ represents a straight-chained or branched alkyl group containing from one through ten carbon atoms.

The present inventors have obtained the following findings from studies into a curable aqueous composition excellent in scratch resistance and storage stability and safe in skin sensitizing potential.

For example, existing inks containing water-soluble dyes are problematic in a poor scratch resistance of printed images formed and a poor dischargeability.

In addition, for example, existing aqueous pigment inks are problematic when they are printed over non-absorbable media, because pigments serving as colorants form coating films while remaining over the surface of gloss paper, so when the printed surfaces, which hence have a poor scratch resistance, are scratched after printing, the printed coating films peel or extend to non-printed portions, thus generating contaminations of scratched products, compared with when pigment inks are printed over plain paper or when printing is performed with dye inks that can permeate the inside of ink receiving layers. Moreover, existing aqueous pigment inks are problematic in odor, skin stimulativeness, and skin sensitizing potential due to monomers and polymerization initiators. Particularly, most (meth)acrylic acid ester compounds that are inexpensive and easily available have a high toxicity in terms of skin sensitizing potential of causing allergies by touching skin. Existing techniques have not given solutions to this problem.

Hence, the present inventors have found that an active-energy-ray curable aqueous composition containing water, a polymerizable compound that undergoes radical polymerization in response to active energy rays, and a polymerization initiator (C1) that produces radicals in response to active energy rays has a low skin sensitizing potential when the polymerizable compound contains at least one kind of an acrylamide compound (A1) selected from the group consisting of acrylamide compounds represented by General formula (1) above and acrylamide compounds represented by General formula (4) above, and a bifunctional or higher polymerizable compound (B1). The acrylamide compound represented by General formula (1) provides an excellent storage stability. The bifunctional or higher polymerizable compound (B1) provides an excellent scratch resistance. Moreover, inclusion of a dispersion containing resin particles having a polymerizable group provides an even more excellent scratch resistance. Furthermore, inclusion of a specific amine compound provides an excellent discharging stability.

The volume average particle diameter (D50) of the resin particles contained in the dispersion is preferably 5 nm or greater but 50 nm or less.

The method for measuring the volume average particle diameter is not particularly limited and may be appropriately selected depending on the intended purpose. For example, the volume average particle diameter can be measured with, for example, a particle size distribution analyzer (available from Nikkiso Co., Ltd., NANOTRAC UPA-EX150).

It is preferable that the active-energy-ray-curable aqueous composition contain an organic amine compound having a boiling point of from 120 degrees C. through 200 degrees C. and a molecular weight of 100 or less. This suppresses viscosity rise when moisture evaporation occurs and better improves discharging stability and maintainability. The reason is as follows. An amine compound having a low molecular weight serves as a substituent as counter ions of a water-dispersible resin. An ink containing an amine compound having a boiling point higher than water can maintain a stable dispersed state and can be suppressed from ink viscosity rise because the counter ions of resin particles served by such an amine compound can be prevented from being evaporated even when moisture evaporation occurs.

<Acrylamide compound (A1)>

The acrylamide compound (A1), which is at least one kind selected from the group consisting of acrylamide compounds represented by General formula (1) below and acrylamide compounds represented by General formula (4) below, contains an acrylamide group and an ester structure, and is a polymerizable monomer in the active-energy-ray-curable composition.

An acrylamide group refers to a group that has polymerizability and is a bond formed between an acryloyl group (CH₂═CH—CO—) and a nitrogen atom of an amine compound.

The method for synthesizing the acrylamide compound (A1) is not particularly limited. Examples of the method include, but are not limited to, a method of allowing a compound containing an activated acryloyl group such as acrylic acid chloride and acrylic anhydride to undergo a reaction with an amine compound. An amine compound that can be used when synthesizing the acrylamide compound (A1) may be any selected from primary amines and secondary amines. Secondary amines are preferable because tertiary amides that are free of hydrogen bonding between amide groups and advantageous in anti-thickening can be obtained.

The ester structure contained in the acrylamide compound (A1) is preferably a straight-chained or branched alkyl ester group containing from one through ten carbon atoms. Examples of the straight-chained or branched alkyl group containing from one through ten carbon atoms include, but are not limited to, a methyl group, an ethyl group, a propyl group, an isopropyl group, a butyl group, a sec-butyl group, an isobutyl group, and a tert-butyl group.

The acrylamide compound (A1) is preferably a compound represented by General formula (1) below.

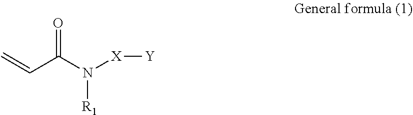

In General formula (1), R₁ represents an alkyl group containing from one through six carbon atoms, X represents an alkylene group containing from one through six carbon atoms, and Y represents a group represented by General formula (2) below or General formula (3) below.

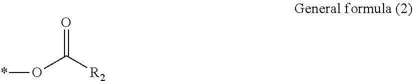

In General formula (2), R₂ represents an alkyl group containing from one through ten carbon atoms, and * represents a binding site with the X.

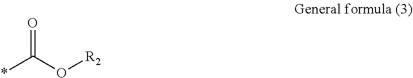

In General formula (3), R₂ represents an alkyl group containing from one through ten carbon atoms, and * represents a binding site with the X.

In General formula (1), R₁ represents a straight-chained or branched alkyl group containing from one through six carbon atoms, and is preferably a straight-chained or branched alkyl group containing from one through four carbon atoms. Examples of R₁ include, but are not limited to, a methyl group, an ethyl group, a propyl group, an isopropyl group, a butyl group, a sec-butyl group, an isobutyl group, and a tert-butyl group.

In General formula (1), X represents a straight-chained or branched alkylene group containing from one through six carbon atoms. Examples of X include, but are not limited to, a methylene group, an ethane-1,1-diyl group, an ethane-1,2-diyl group, a propane-1,1-diyl group, a propane-1,2-diyl group, a propane-1,3-diyl group, a butane-1,1-diyl group, a butane-1,2-diyl group, a butane-1,3-diyl group, a butane-1,4-diyl group, a 2-methylpropane-1,1-diyl group, a 2-methylpropane-1,2-diyl group, and a 2-methylpropane-1,3-diyl group.

In General formula (2) and General formula (3), R₂ represents a straight-chained or branched alkyl group containing from one through ten carbon atoms, and is preferably an alkyl group containing from one through two carbon atoms. Examples of R₂ include, but are not limited to, a methyl group, an ethyl group, a propyl group, an isopropyl group, a butyl group, a sec-butyl group, an isobutyl group, and a tert-butyl group.

The acrylamide compound (A1) is preferably a compound represented by General formula (4) below.

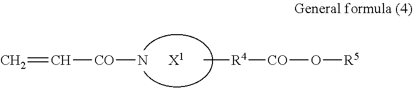

In General formula (4), a ring X¹ represents a nitrogen atom-containing ring structure containing from two through five carbon atoms, R⁴ represents a single bond, or a straight-chained or branched alkylene group containing from one through three carbon atoms, and R⁵ represents a straight-chained or branched alkyl group containing from one through ten carbon atoms.

In General formula (4), the ring X¹ represents a nitrogen atom-containing ring structure containing from two through five carbon atoms. Examples of the ring X¹ include, but are not limited to, aziridine, azetidine, pyrrolidine, and piperidine. Pyrrolidine and piperidine are preferable.

In General formula (4), R⁴ represents a single bond, or a straight-chained or branched alkylene group containing from one through three carbon atoms. Examples of R⁴ include, but are not limited to, a single bond, a methylene group, an ethane-1,1-diyl group, an ethane-1,2-diyl group, a propane-1,1-diyl group, a propane-1,2-diyl group, and a propane-1,3-diyl group.

In General formula (4), R⁵ represents a straight-chained or branched alkyl group containing from one through ten carbon atoms. Examples of R⁵ include, but are not limited to, a methyl group, an ethyl group, a propyl group, and an isopropyl group.

The compound represented by General formula (1) or (4) is preferably, for example, N-acryloyl-N-alkylamino acid alkyl ester (including N-acryloylproline alkyl ester), and N-acryloylpiperidine carboxylic acid alkyl ester. The alkyl group in the compound is preferably a straight-chain or branched alkyl group containing from one through four carbon atoms. Particularly preferable examples of the alkyl group include, but are not limited to, an alkyl group containing one or two carbon atoms (i.e., a methyl group or an ethyl group).

Specific examples of the N-acryloyl-N-alkylamino acid alkyl ester include, but are not limited to, N-acryloyl-N-methylglycine methyl ester, N-acryloyl-N-methylglycine ethyl ester, N-acryloyl-N-methylglycine propyl ester, N-acryloyl-N-methylglycine butyl ester, N-acryloyl-N-ethylglycine methyl ester, N-acryloyl-N-ethylglycine ethyl ester, N-acryloyl-N-ethylglycine propyl ester, N-acryloyl-N-propylglycine methyl ester, N-acryloyl-N-propylglycine ethyl ester, N-acryloyl-N-butylglycine methyl ester, N-acryloyl-N-methylalanine methyl ester, N-acryloyl-N-methylalanine ethyl ester, N-acryloyl-N-methylalanine propyl ester, N-acryloyl-N-ethylalanine methyl ester, N-acryloyl-N-ethylalanine ethyl ester, N-acryloyl-N-propylalanine methyl ester, N-acryloyl-N-methyl-β-alaninemethyl ester, N-acryloyl-N-methyl-β-alanine ethyl ester, N-acryloyl-N-ethyl-β-alanine methyl ester, N-acryloyl-N-ethyl-β-alanine ethyl ester, N-acryloyl-N-methylvaline methyl ester, N-acryloylproline methyl ester, and N-acryloylproline ethyl ester.

Specific examples of the N-acryloylpiperidine carboxylic acid alkyl ester include, but are not limited to, methyl N-acryloylpiperidine-2-carboxylate, methyl N-acryloylpiperidine-3-carboxylate, and methyl N-acryloylpiperidine-4-carboxylate.

Specific examples of a compound that is represented by General formula (1) or (4) and is other than the N-acryloyl-N-alkylamino acid alkyl ester and N-acryloylpiperidine carboxylic acid alkyl ester include, but are not limited to, acryloyloxyethyl acrylamide.

When the acrylamide compound (A1) is at least one kind selected from the group consisting of acrylamide compounds represented by General formula (1) and acrylamide compounds represented by General formula (4), a skin sensitizing potential due to the polymerizable monomer contained in the composition of the present disclosure can be suppressed.

For application to an inkjet printing method, it is preferable that the acrylamide compound (A1) be a clear and colorless or clear and light-yellow liquid having a low viscosity (100 mPa·s or lower) at normal temperature (25 degrees C.). In terms of safety of the user, it is preferable that the acrylamide compound (A1) be not strongly acid or basic, and be free of toxic formaldehyde as an impurity.

Many commercially available products of an acrylamide compound containing a polymerizable acrylamide group but free of an ester structure are sold (e.g., N-acryloylmorpholine, N,N-dimethylacrylamide, N,N-diethylacrylamide, N-isopropylacrylamide, N-(2-hydroxyethyl)acrylamide, N-(hydroxymethyl)acrylamide, N-(butoxymethyl)acrylamide, N-[3-(dimethylamino)propyl]acrylamide, N-(1,1-dimethyl-3-oxobutyl)acrylamide, and 2-acrylamide-2-methylpropane sulfonic acid). However, it is impossible to find out a commercially available product that satisfies all of the effects of the present disclosure. The present disclosure is based on the finding that the acrylamide compound (A1) satisfies the effects of the present disclosure by containing an ester structure that is neutral and has an adequate polarity.

It is preferable that the acrylamide compound (A1) be contained by 4.8% by mass or greater but 94.8% by mass or less, more preferably 74.8% by mass or less, and yet more preferably 54.8% by mass or less relative to the total amount of the composition of the present disclosure. It is preferable that the content of the acrylamide compound (A1) be 4.8% by mass or greater because an adhesive agent used for assembling an ink discharging head has a better liquid contact property with the composition. It is preferable that the content of the acrylamide compound (A1) be 94.8% by mass or less because the composition has an excellent curability when irradiated with active energy rays. One kind of the acrylamide compound (A1) may be used alone or two or more kinds of the acrylamide compound (A1) may be used in combination.

Specific examples of the acrylamide compound represented by General formula (1) or (4) include, but are not limited to, compounds included in the group “a” to group “i” of example compounds presented below.

Examples of compounds in the group “a” of example compounds include, but are not limited to, the compounds of the groups a1 to a6 presented below. One of these compounds may be used alone or two or more of these compounds may be used in combination.

### <<Group a1 of Example Compounds>>

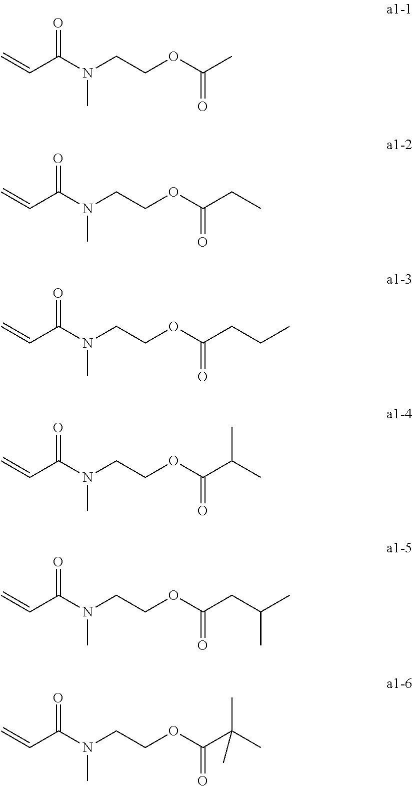

### <<Group a2 of Example Compounds>>

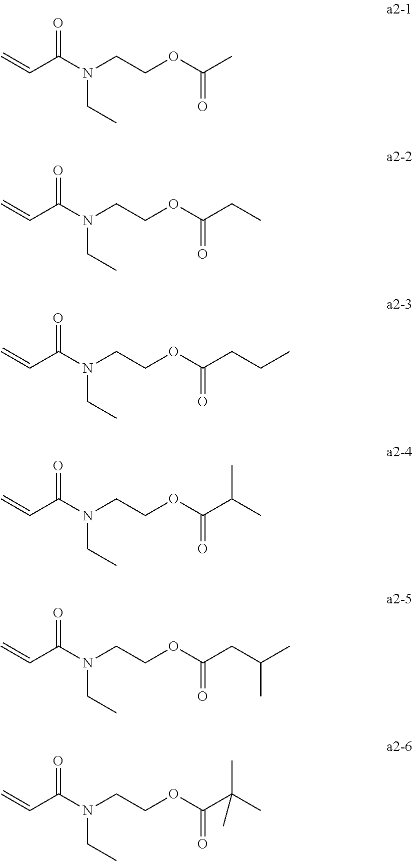

### <<Group a3 of Example Compounds>>

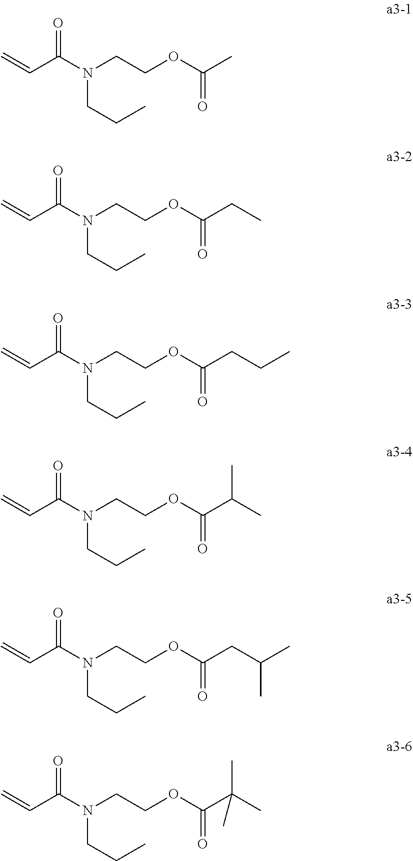

### <<Group a4 of Example Compounds>>

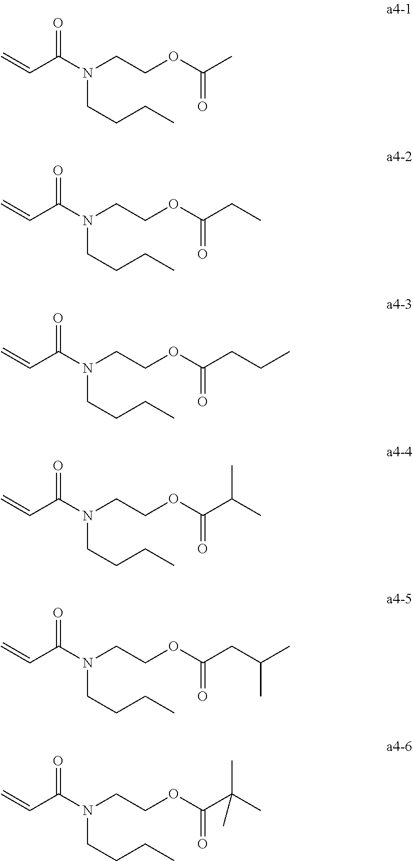

### <<Group a5 of Example Compounds>>

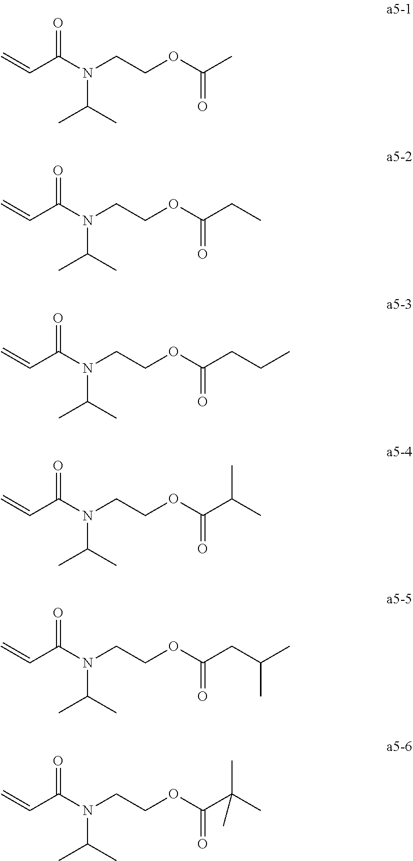

### <<Group a6 of Example Compounds>>

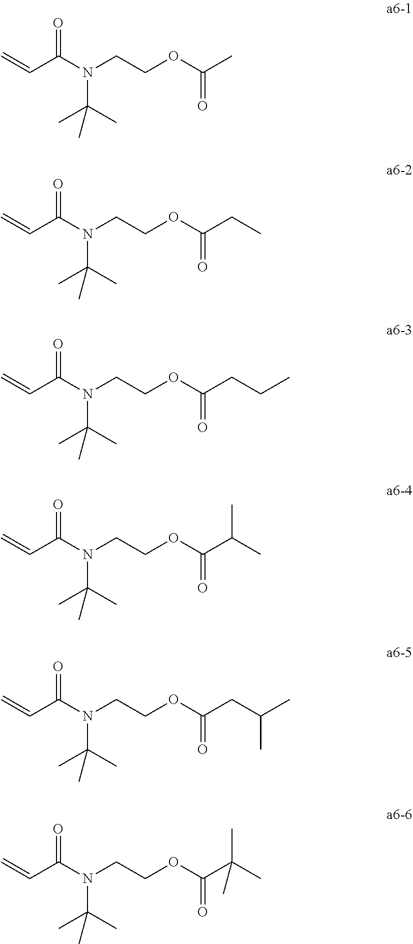

Examples of compounds in the group “b” of example compounds include, but are not limited to, the compounds of the groups b1 to b6 presented below. One of these compounds may be used alone or two or more of these compounds may be used in combination.

### <<Group b1 of Example Compounds>>

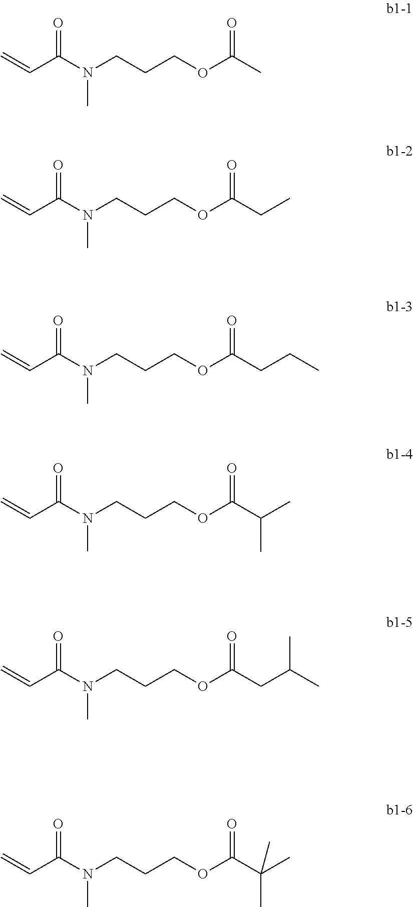

### <<Group b2 of Example Compounds>>

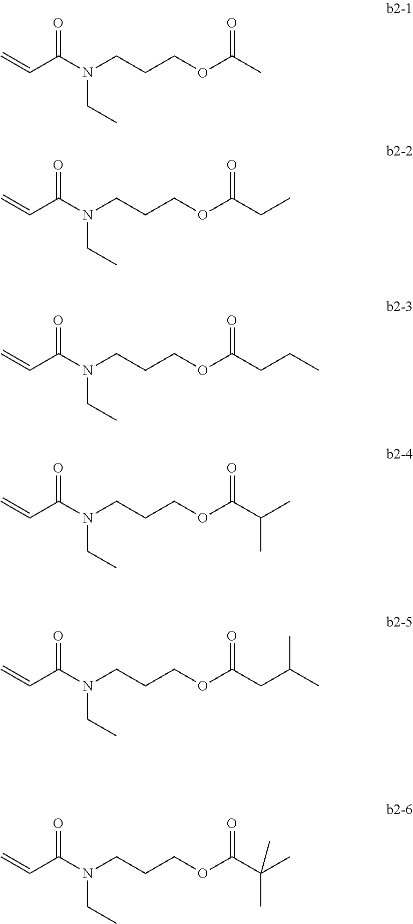

### <<Group b3 of Example Compounds>>

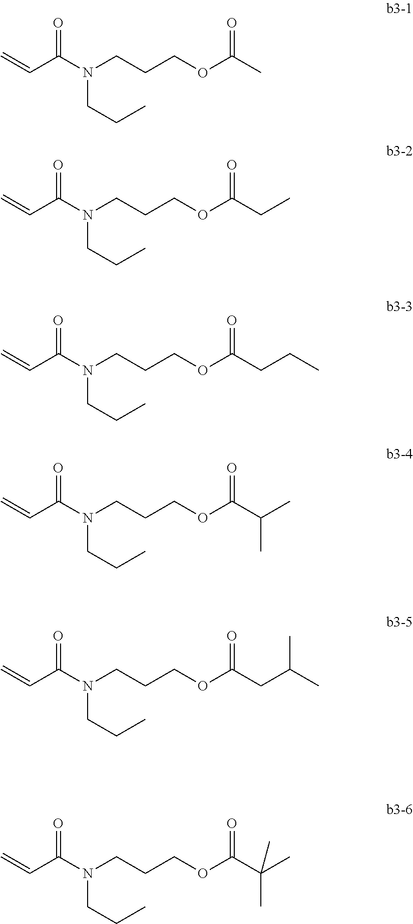

### <<Group b4 of Example Compounds>>

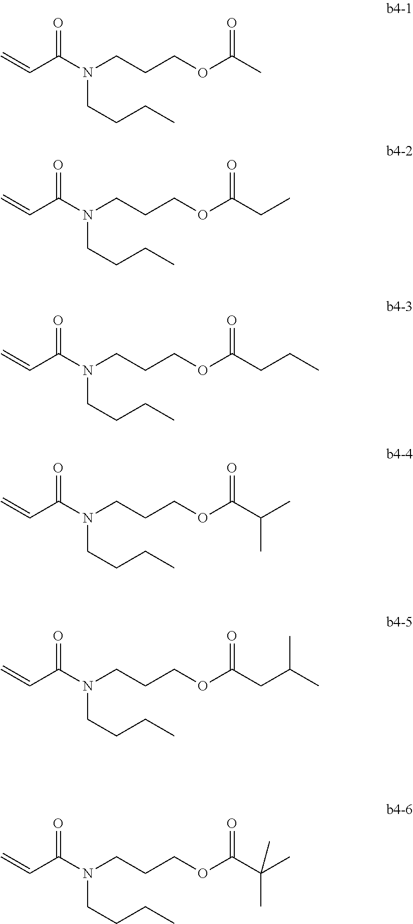

### <<Group b5 of Example Compounds>>

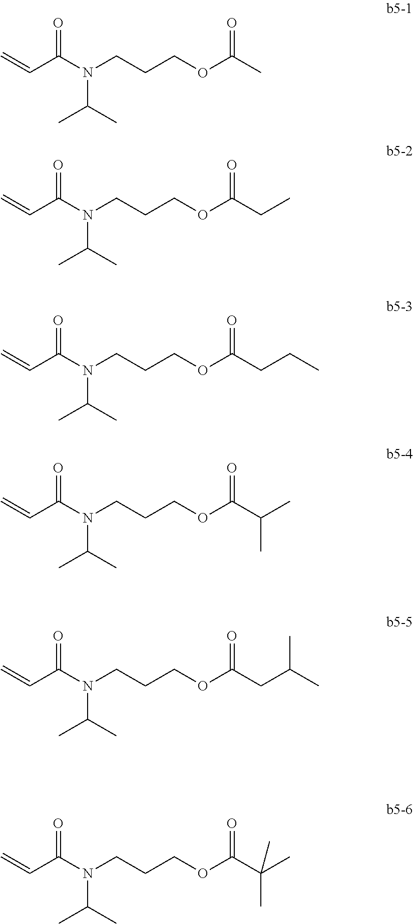

### <<Group b6 of Example Compounds>>

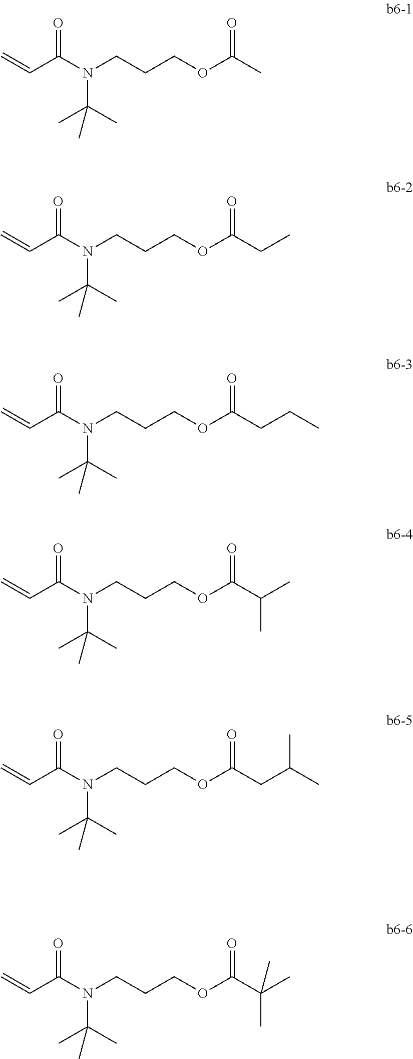

Examples of compounds in the group “c” of example compounds include, but are not limited to, the compounds of the groups c1 to c6 presented below. One of these compounds may be used alone or two or more of these compounds may be used in combination.

### <<Group c1 of Example Compounds>>

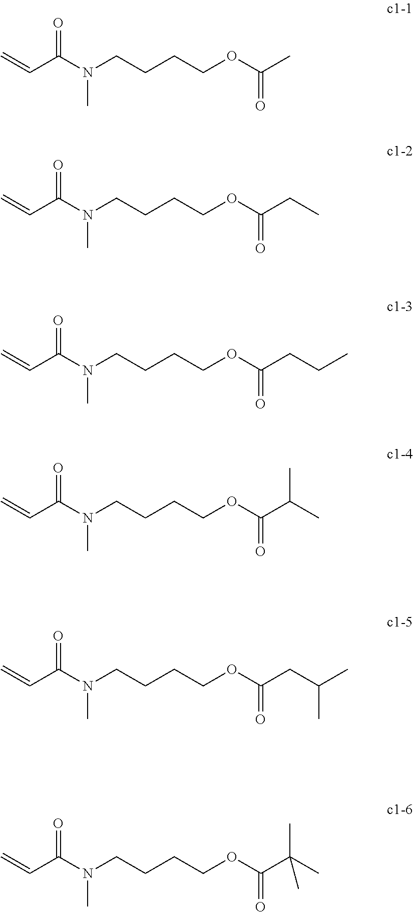

### <<Group c2 of Example Compounds>>

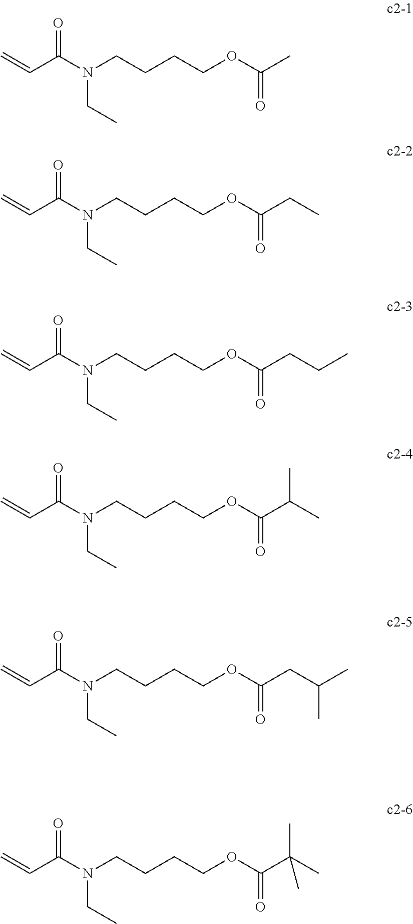

### <<Group c3 of Example Compounds>>

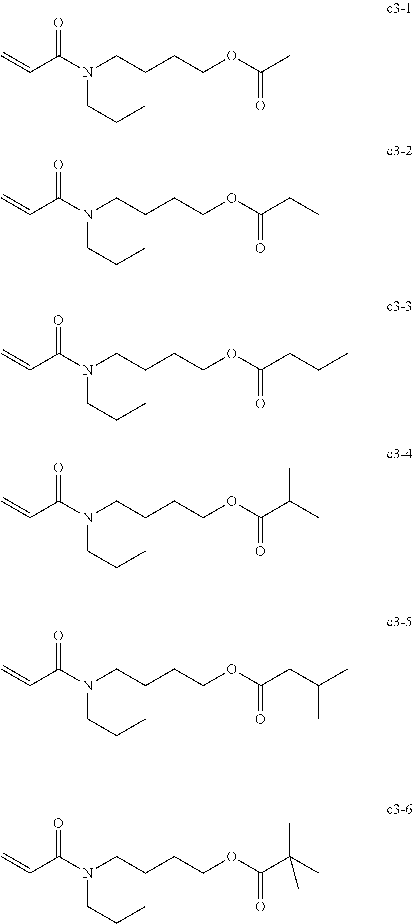

### <<Group c4 of Example Compounds>>

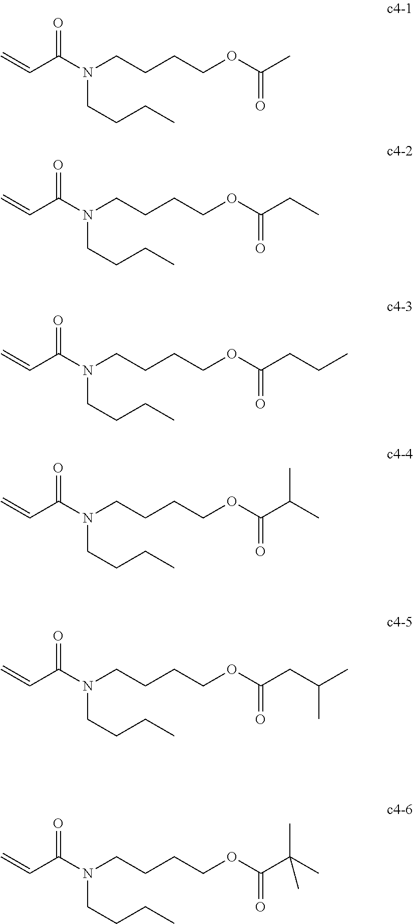

### <<Group c5 of Example Compounds>>

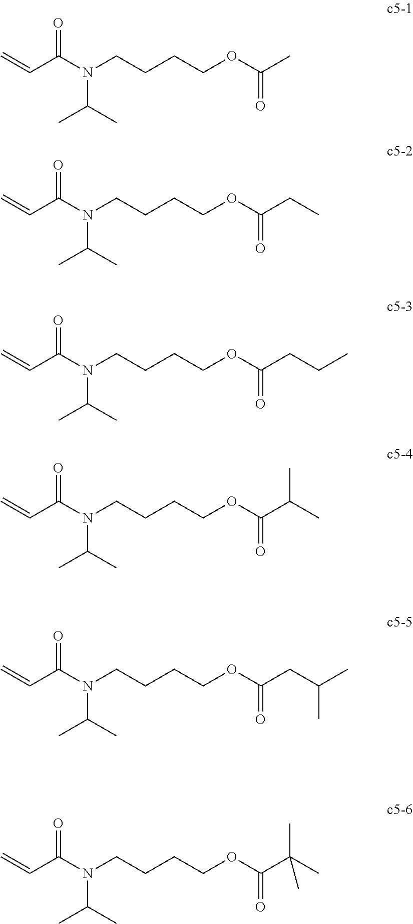

### <<Group c6 of Example Compounds>>

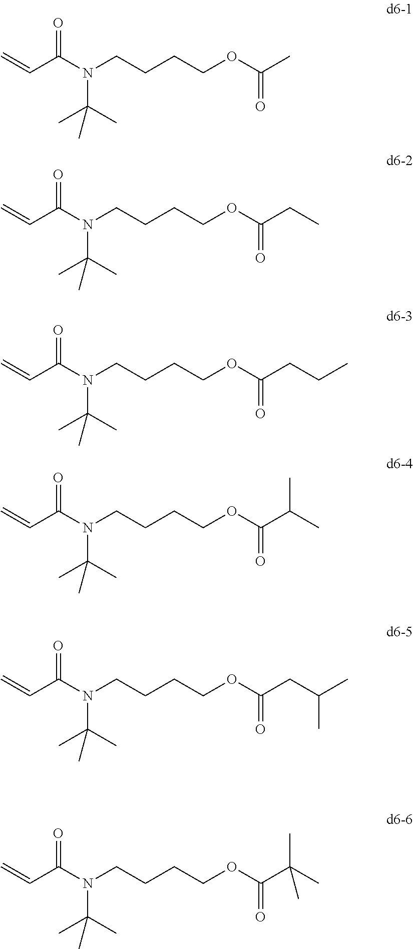

Examples of compounds in the group “d” of example compounds include, but are not limited to, the compounds of the groups d1 to d6 presented below. One of these compounds may be used alone or two or more of these compounds may be used in combination.

### <<Group d1 of Example Compounds>>

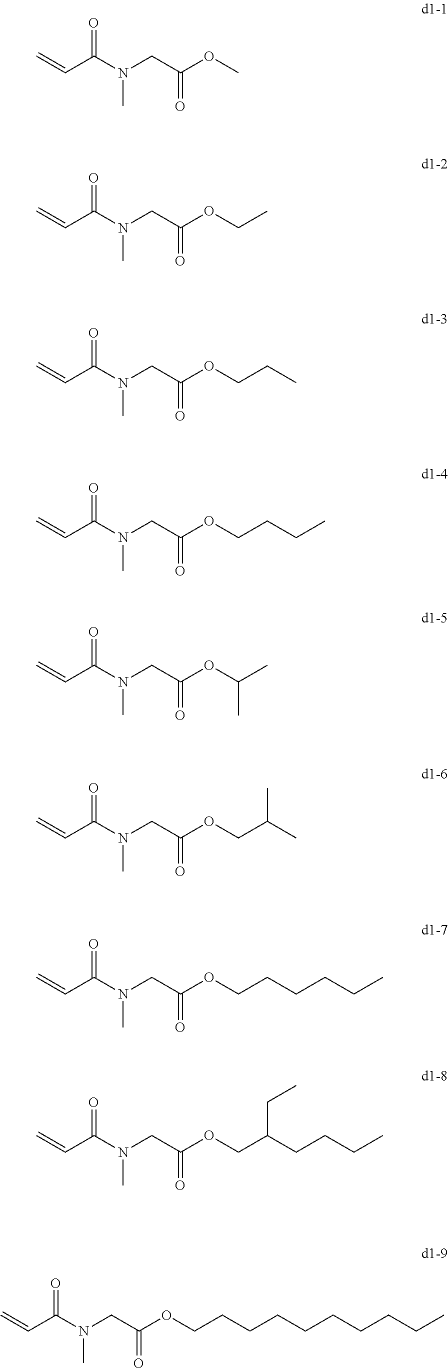

### <<Group d2 of Example Compounds>>

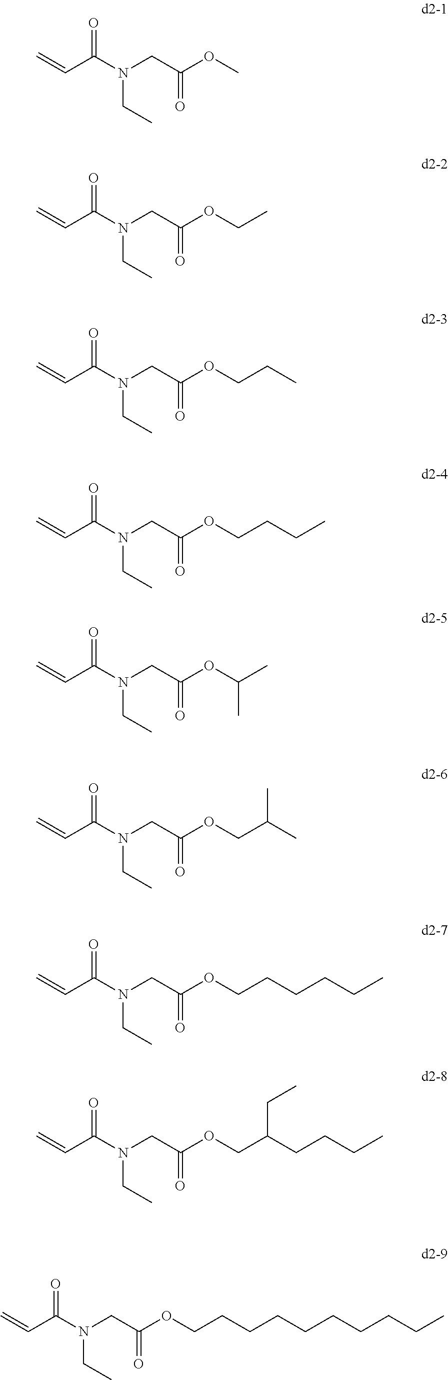

### <<Group d3 of Example Compounds>>

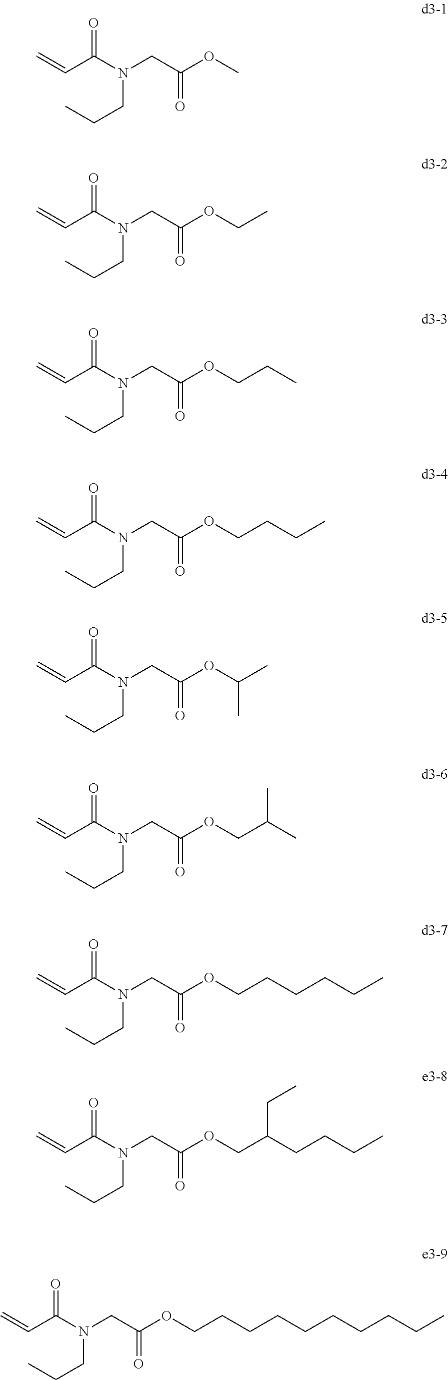

### <<Group d4 of Example Compounds>>

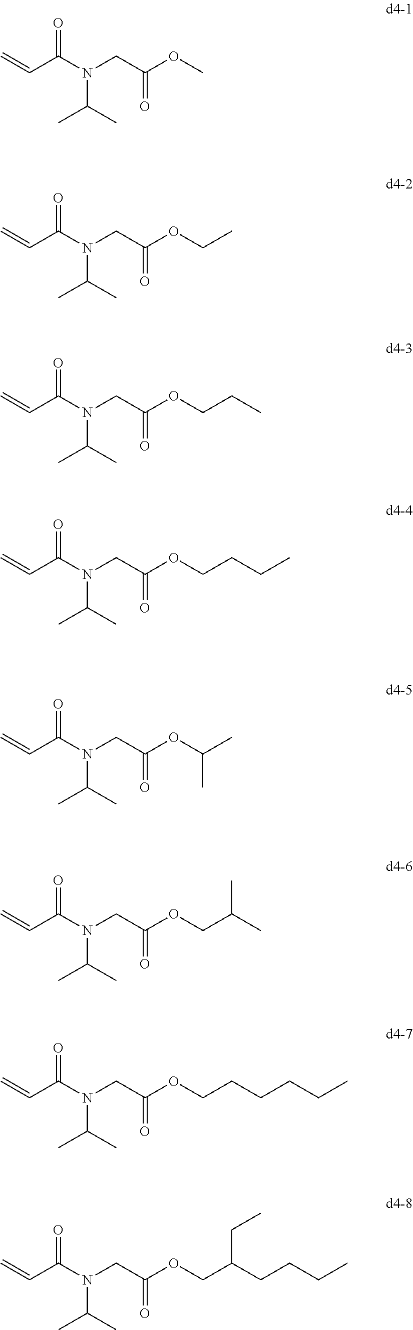

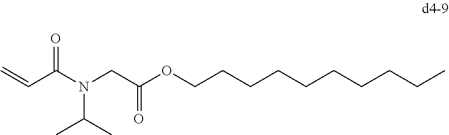 [SMILES: C=CC(=O)N(CC(=O)OCCCCCCCCCC)C(C)C]

### <<Group d5 of Example Compounds>>

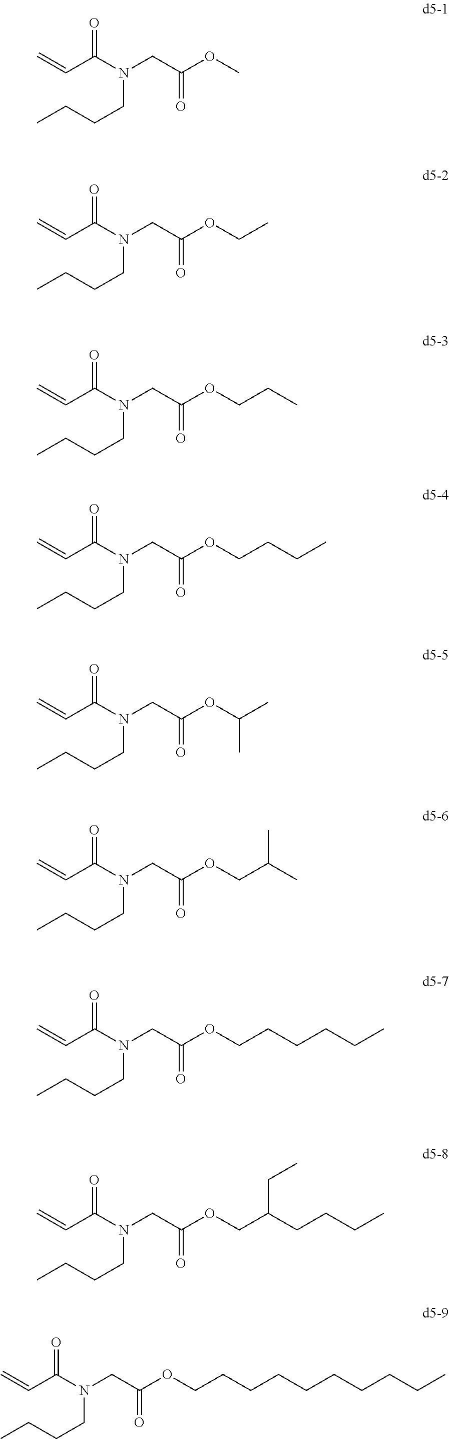

### <<Group d6 of Example Compounds>>

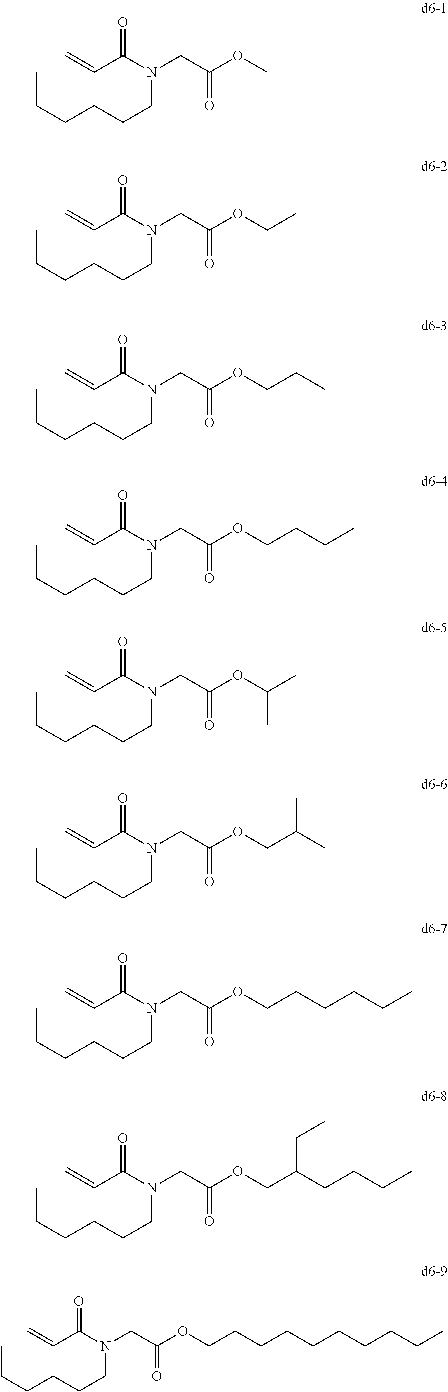

Examples of compounds in the group “e” of example compounds include, but are not limited to, the compounds of the groups e1 to e6 presented below. One of these compounds may be used alone or two or more of these compounds may be used in combination.

### <<Group e1 of Example Compounds>>

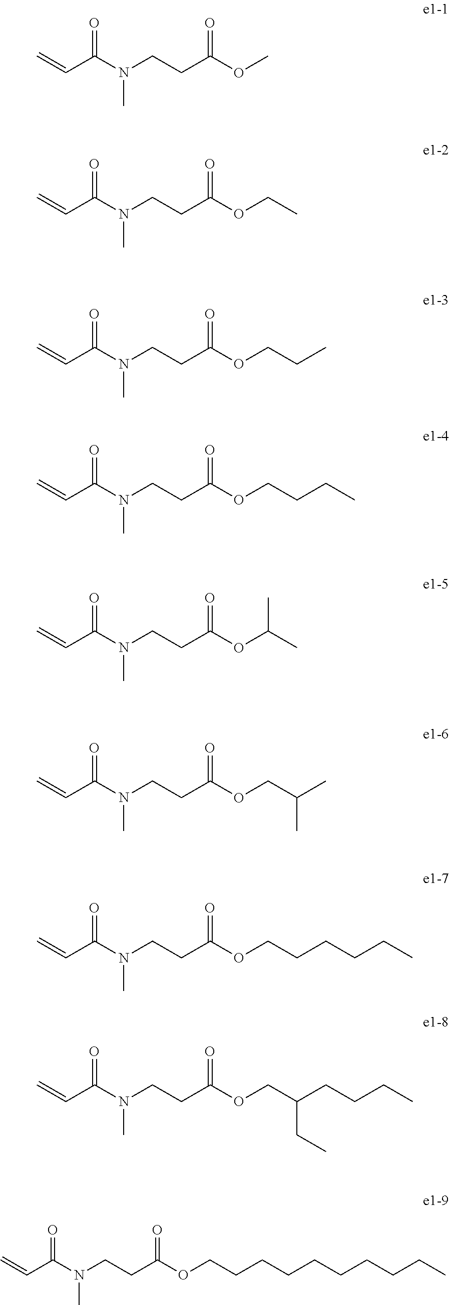

### <<Group e2 of Example Compounds>>

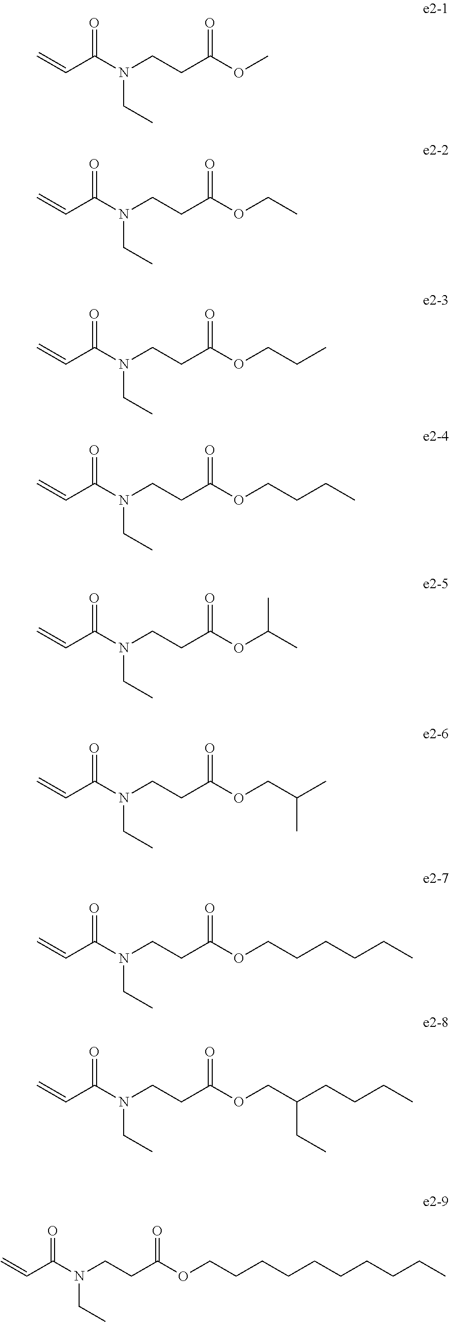

### <<Group e3 of Example Compounds>>

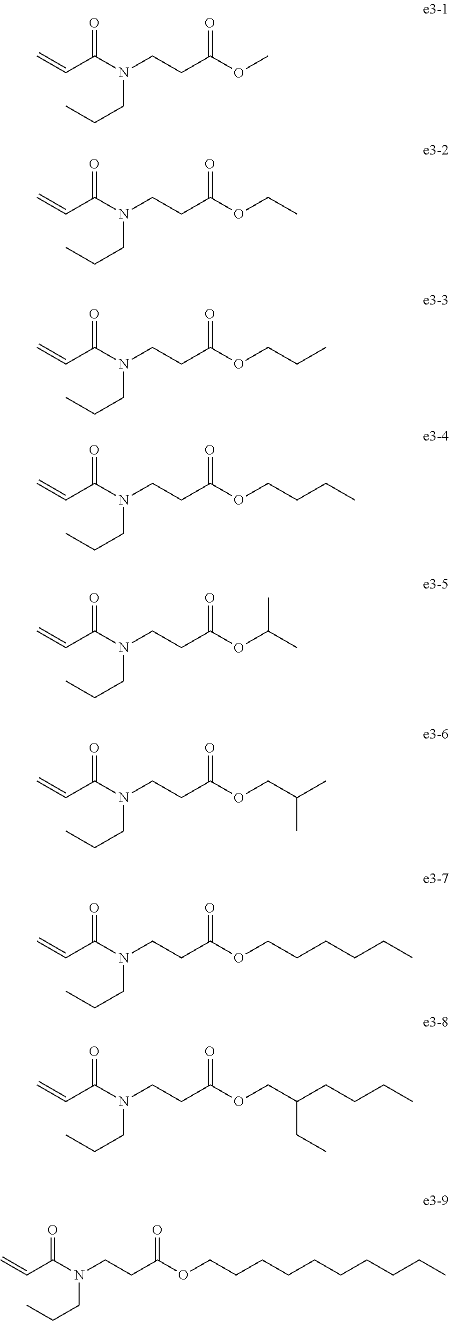

### <<Group e4 of Example Compounds>>

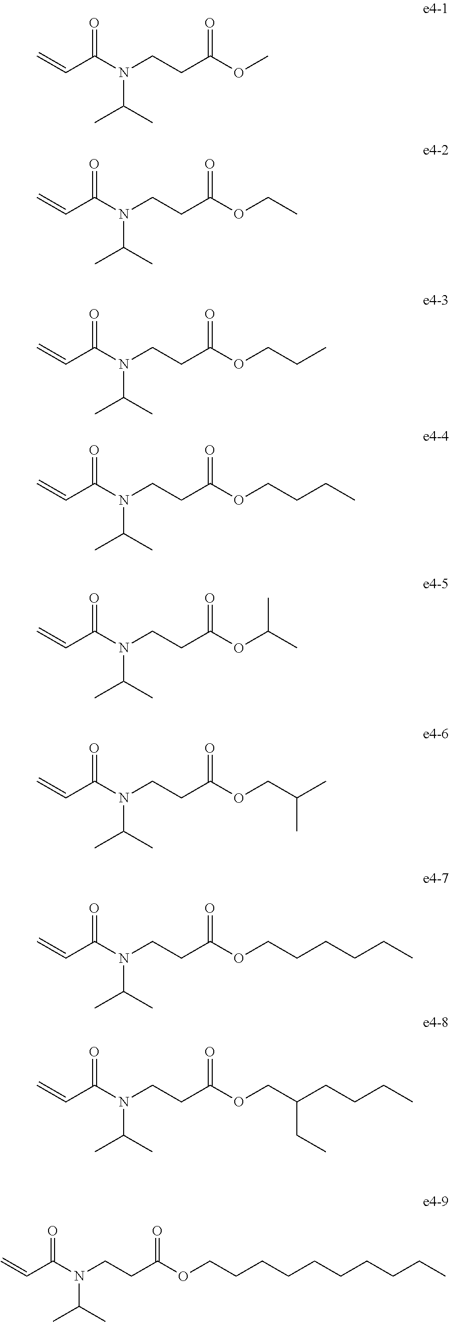

### <<Group e5 of Example Compounds>>

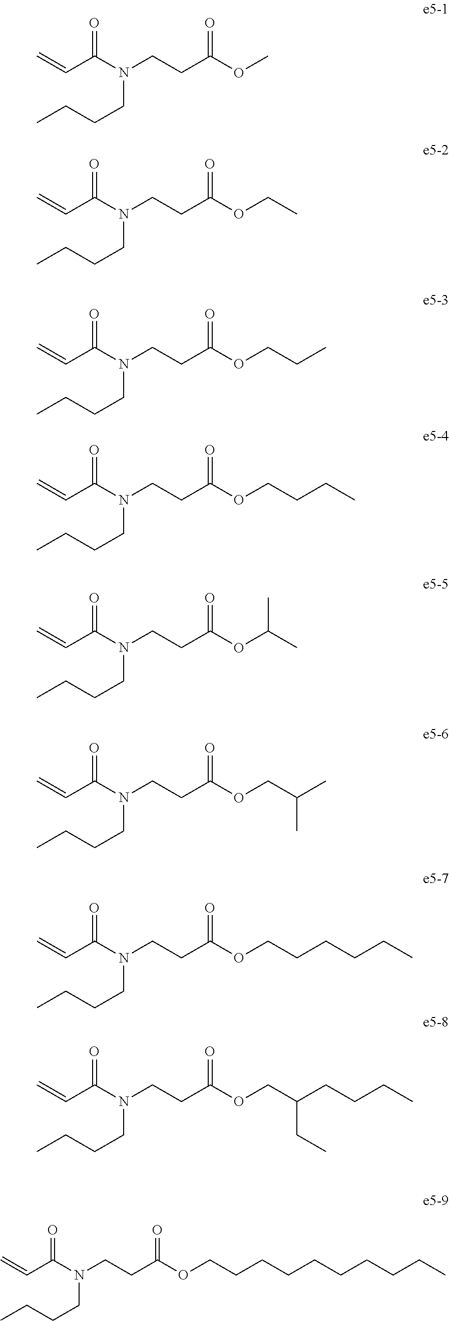

### <<Group e6 of Example Compounds>>

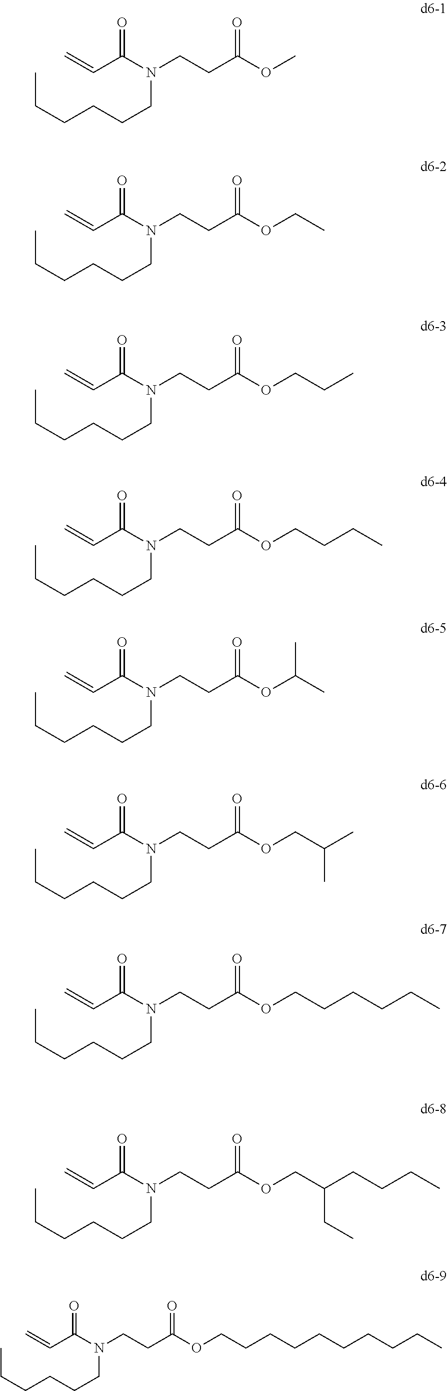

Examples of compounds in the group “f” of example compounds include, but are not limited to, the compounds of the group f1 presented below. One of these compounds may be used alone or two or more of these compounds may be used in combination.

### <<Group f1 of Example Compounds>>

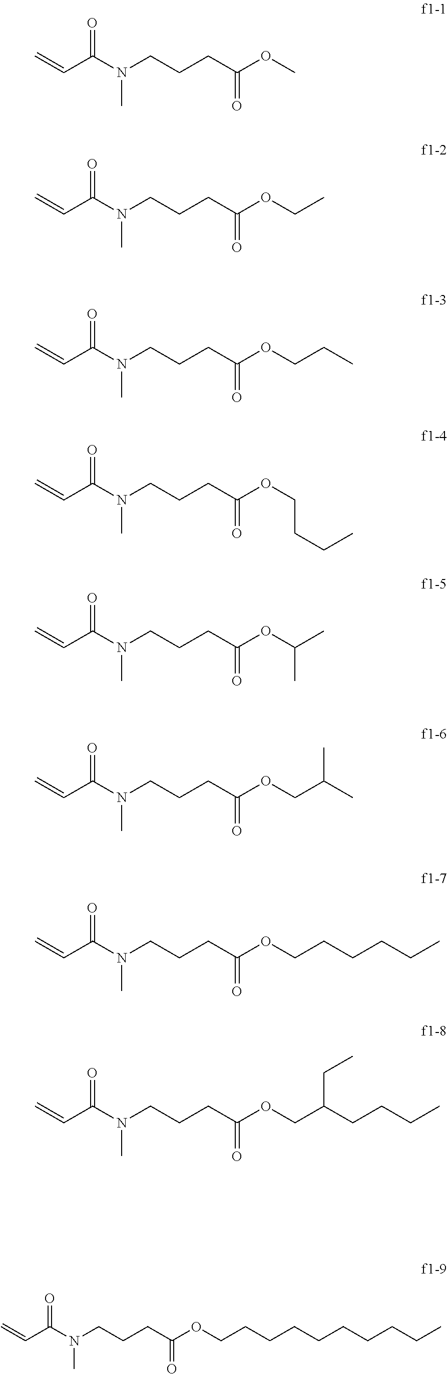

Examples of compounds in the group “g” of example compounds include, but are not limited to, the compounds of the groups g1 to g6 presented below. One of these compounds may be used alone or two or more of these compounds may be used in combination.

### <<Group g1 of Example Compounds>>

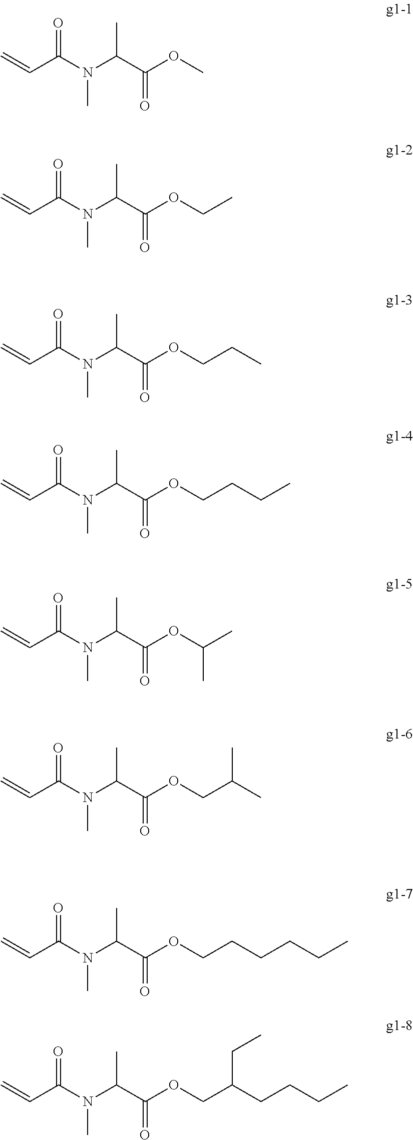

### <<Group g2 of Example Compounds>>

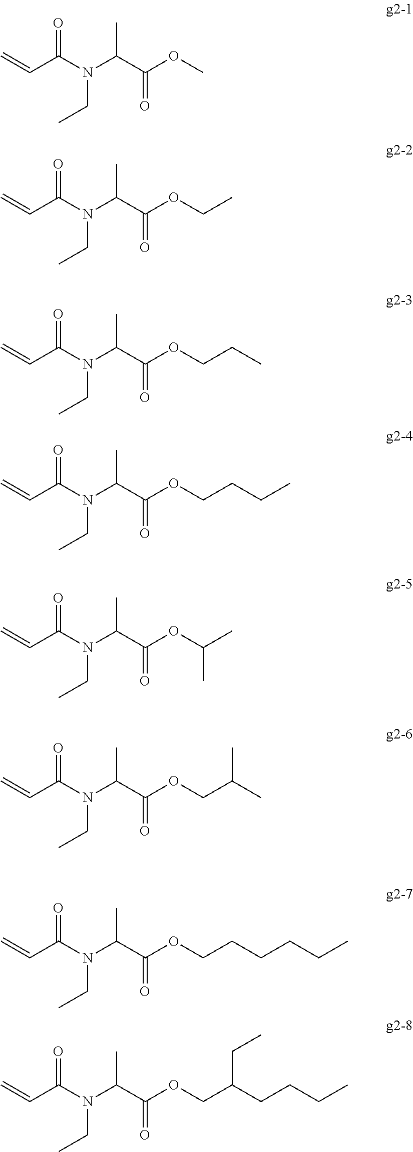

### <<Group g3 of Example Compounds>>

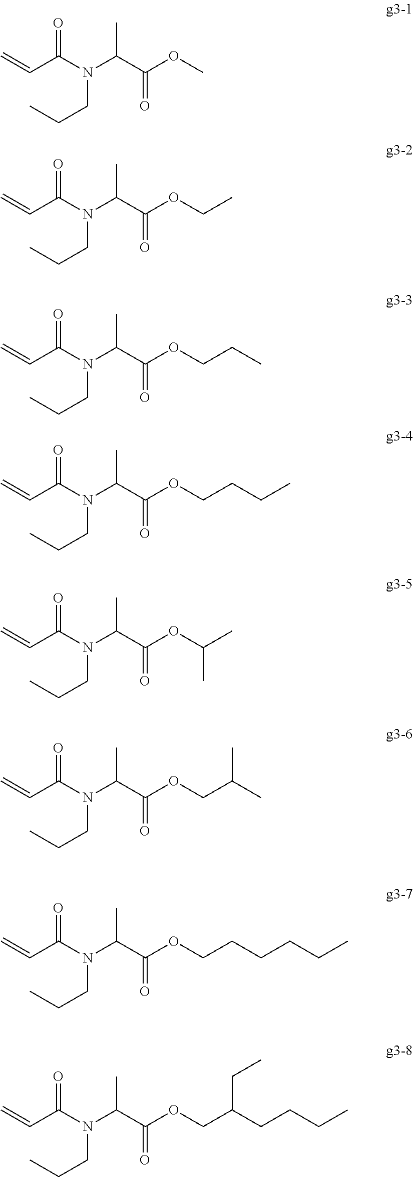

### <<Group g4 of Example Compounds>>

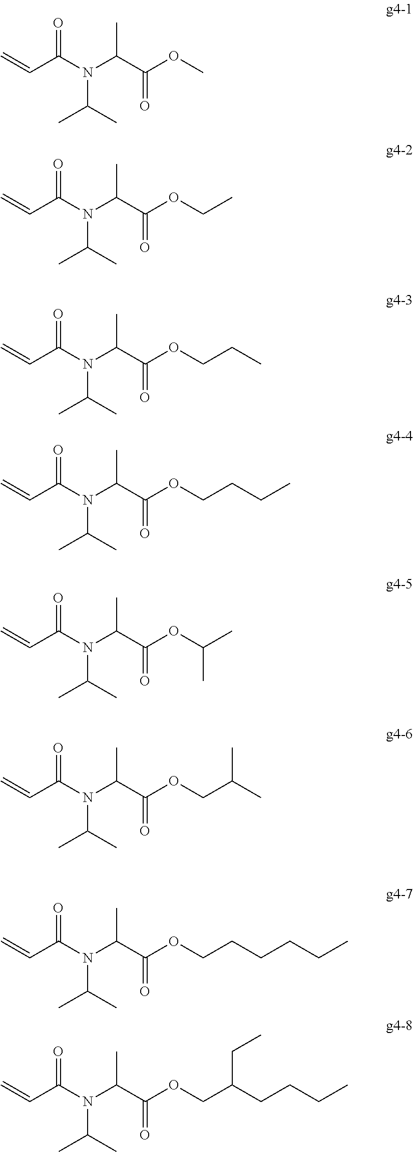

### <<Group g5 of Example Compounds>>

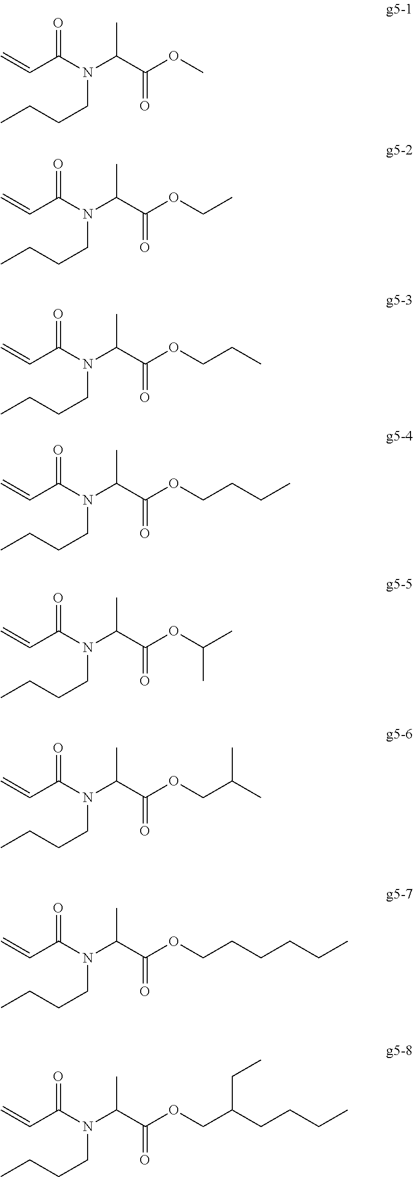

### <<Group g6 of Example Compounds>>

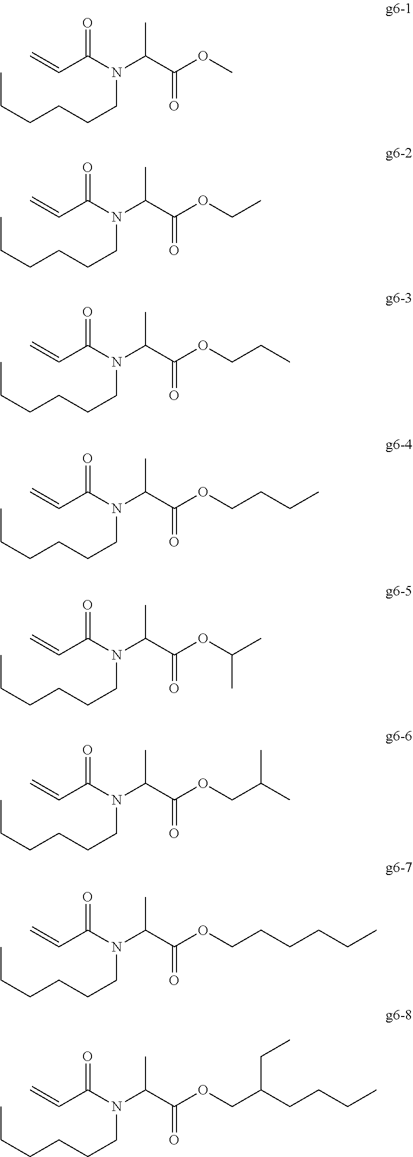

Examples of compounds in the group “h” of example compounds include, but are not limited to, the compounds of the group hl presented below. One of these compounds may be used alone or two or more of these compounds may be used in combination.

<<Group of Example Compounds h1>>

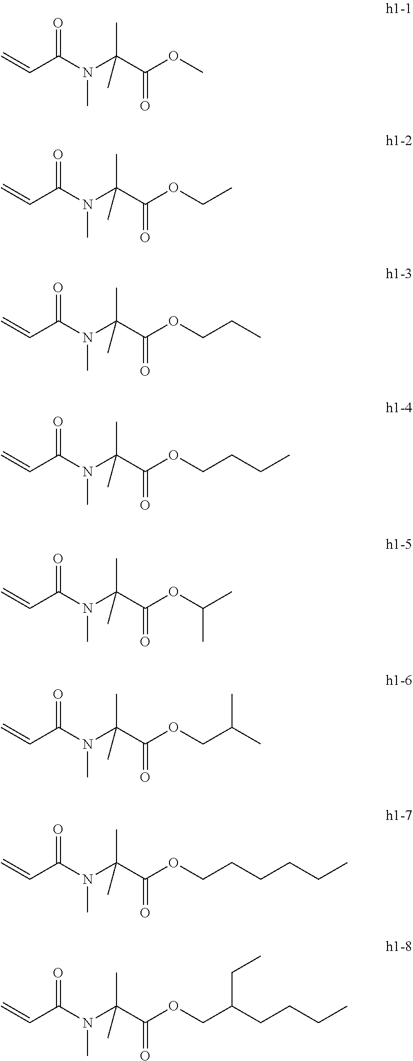

Examples of compounds in the group “i” of example compounds include, but are not limited to, the compounds of the groups i1 to i6 presented below. One of these compounds may be used alone or two or more of these compounds may be used in combination.

<<Group of Example Compounds i1>>

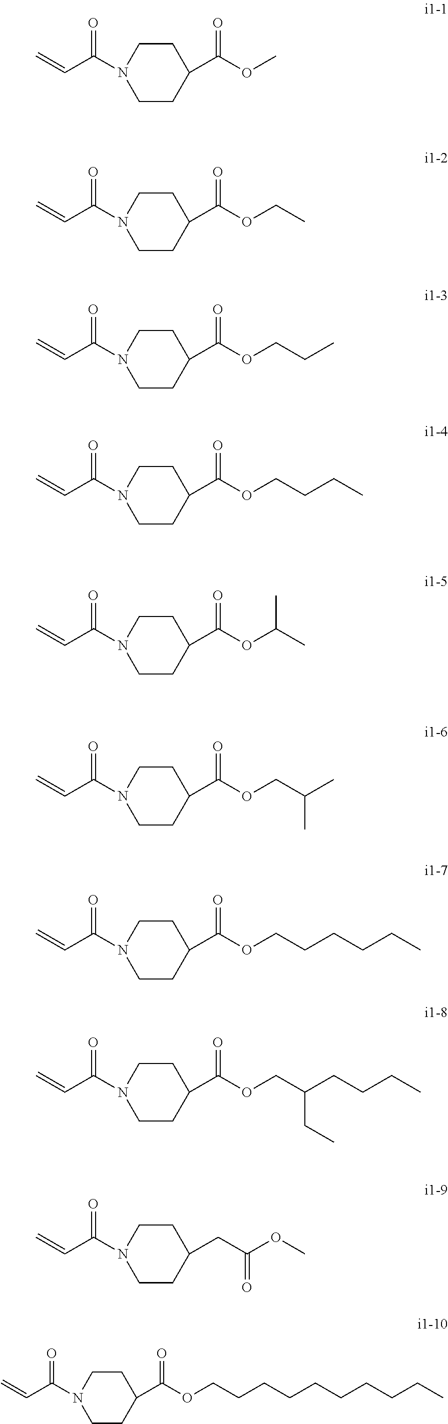

<<Group of Example Compounds i2>>

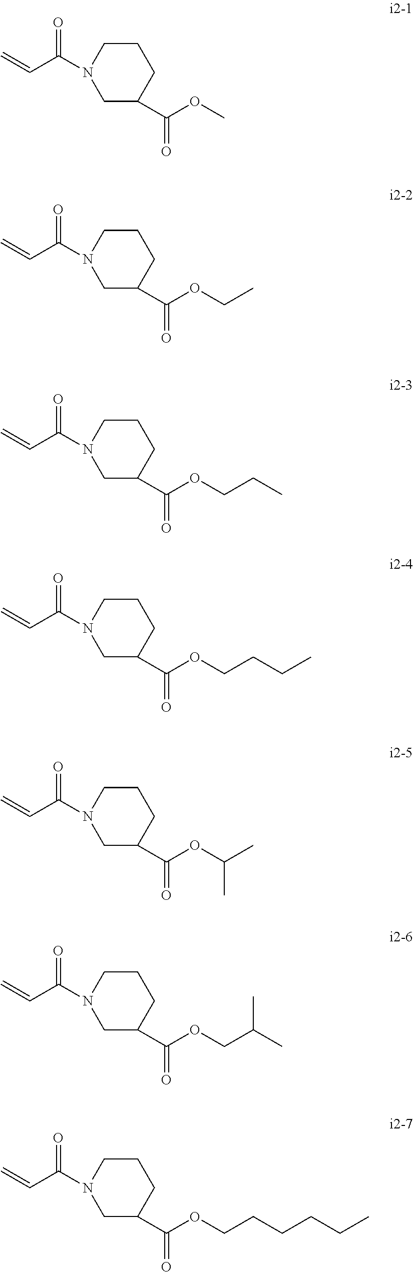

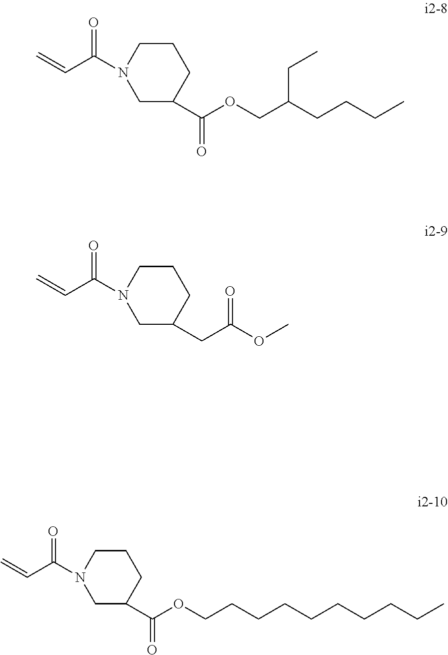

<<Group of Example Compounds i3>>

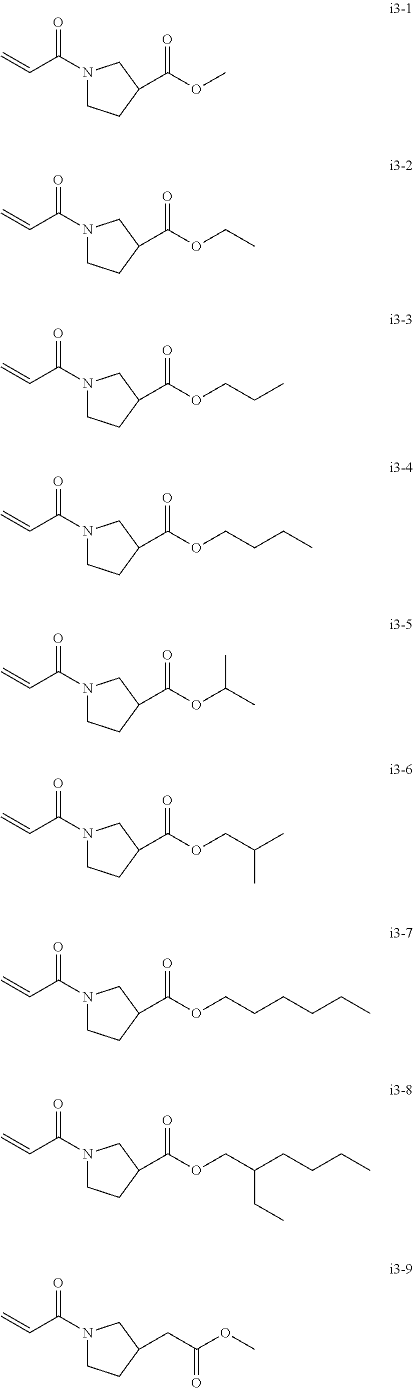

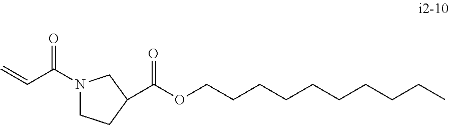 [SMILES: C=CC(=O)N1CCC(C(=O)OCCCCCCCCCC)C1]

<<Group of Example Compounds i4>>

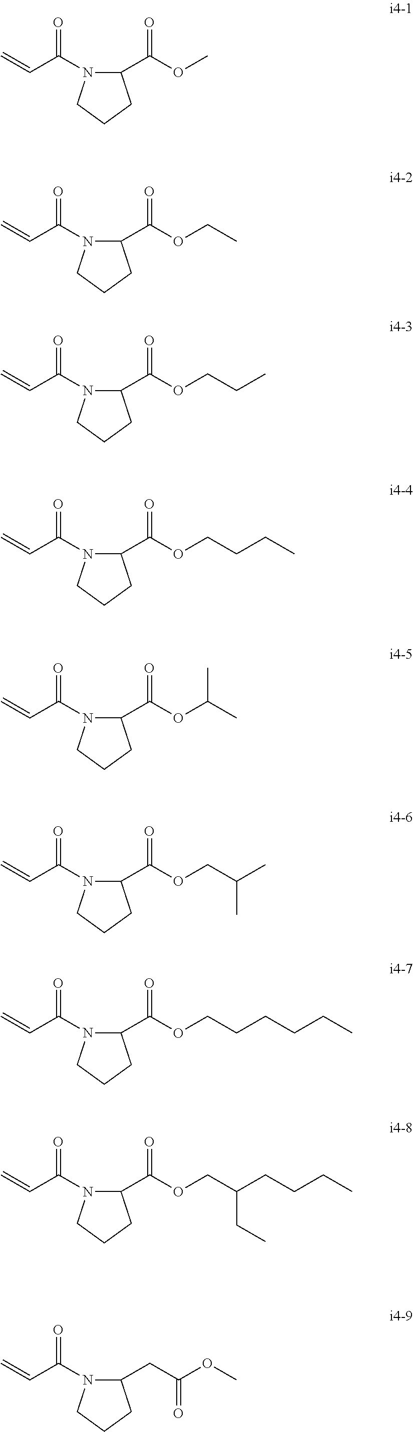

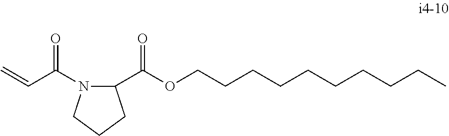 [SMILES: C=CC(=O)N1CCCC1C(=O)OCCCCCCCCCC]

<<Group of Example Compounds i5>>

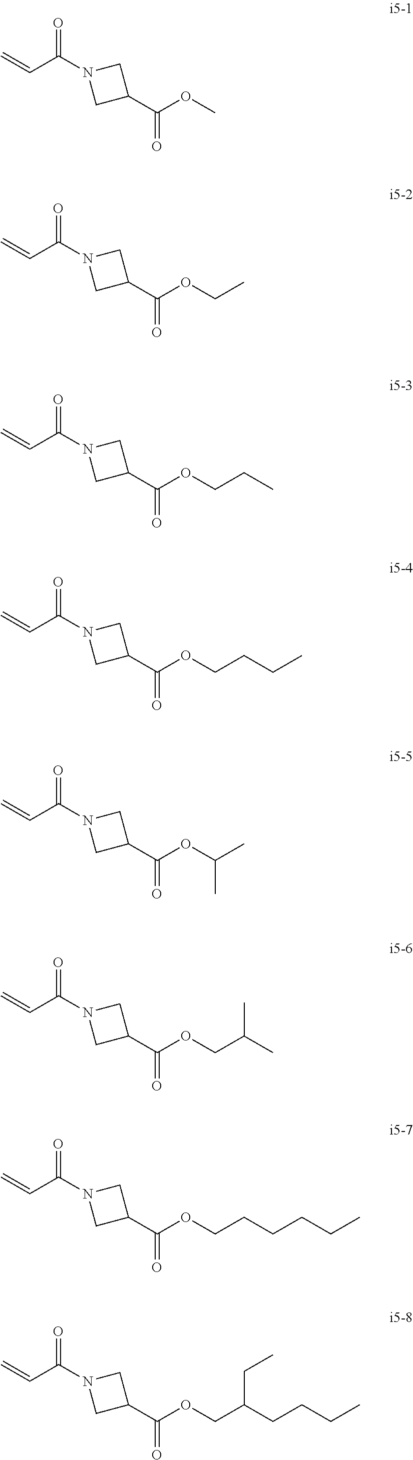

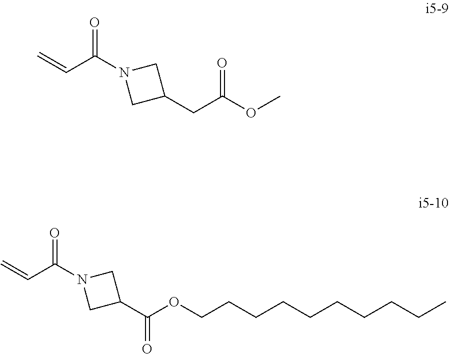 [SMILES: C=CC(=O)N1CC(CC(=O)OC)C1 ; C=CC(=O)N1CC(C(=O)OCCCCCCCCCC)C1]

<<Group of Example Compounds i6>>

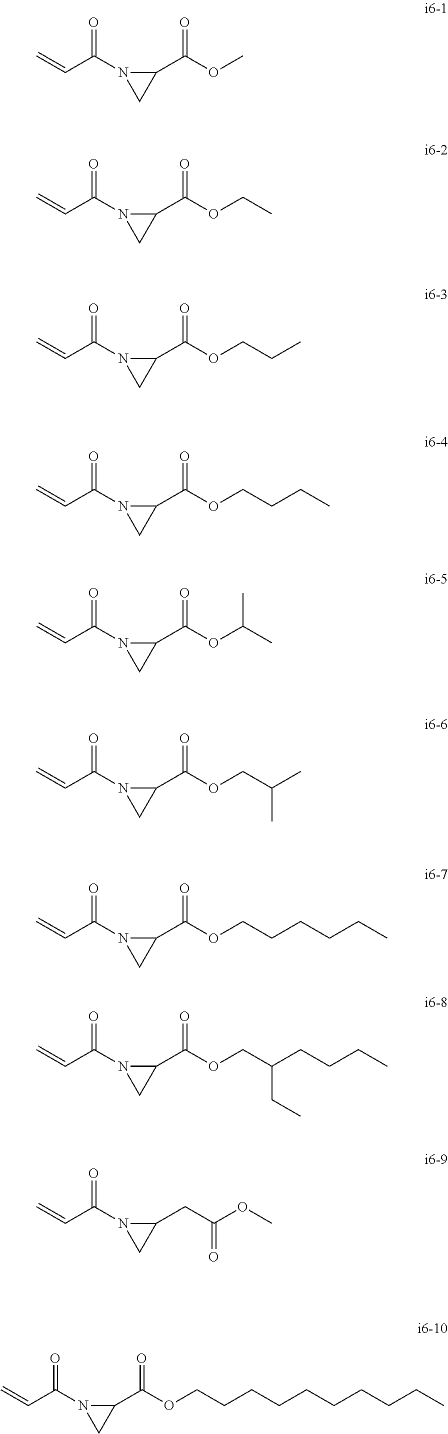

Among the group “a” to group “i” of example compounds, example compound a1-1, example compound a1-4, example compound a6-1, example compound d1-1, example compound d1-2, example compound d1-4, example compound d1-5, example compound d3-2, example compound d4-1, example compound d4-5, example compound d6-1, example compound d6-4, example compound g1-1, example compound g1-2, and example compound g1-5 are preferable, and example compound d1-1, example compound d1-2, example compound g1-1, example compound g1-2, example compound g1-5, example compound i1-2, and example compound i2-2 are more preferable in terms of curability.

### <Bifunctional or Higher Polymerizable Compound (B1)>

The bifunctional or higher polymerizable compound (B1) is not particularly limited and may be appropriately selected depending on the intended purpose. Examples of the bifunctional or higher polymerizable compound (B1) include, but are not limited to, ethylene glycol di(meth)acrylate, hydroxypivalic acid neopentyl glycol di(meth)acrylate, polytetramethylene glycol di(meth)acrylate, trimethylolpropane (meth)acrylic acid benzoic acid ester, triethylene glycol di(meth)acrylate, tetraethylene glycol di(meth)acrylate, polyethylene glycol diacrylate [CH₂=CH—CO—(OC₂H₄)n-OCOCH═CH₂ (n≈4)], polyethylene glycol diacrylate [CH₂=CH—CO—(OC₂H₄)n-OCOCH═CH₂(n≈9)], polyethylene glycol diacrylate [CH₂=CH—CO—(OC₂H₄)n-OCOCH═CH₂ (n≈14)], polyethylene glycol diacrylate [CH₂=CH—CO—(OC₂H₄)n-OCOCH═CH₂ (n≈23)], dipropylene glycol di(meth)acrylate, tripropylene glycol di(meth)acrylate, polypropylene glycol dimethacrylate [CH₂═C(CH₃)—CO—(OC₃H₆)n-OCOC(CH₃)═CH₂ (n≈7)], 1,3-butanediol di(meth)acrylate, 1,4-butanediol diacrylate, 1,6-hexanediol di(meth)acrylate, 1,9-nonanediol di(meth)acrylate, neopentyl glycol diacrylate, tricyclodecane dimethanol diacrylate, propylene oxide-modified bisphenol A di(meth)acrylate, polyethylene glycol di(meth)acrylate, dipentaerythritol hexa(meth)acrylate, propylene oxide-modified tetramethylolmethane tetra(meth)acrylate, dipentaerythritol hydroxypenta(meth)acrylate, caprolactone-modified dipentaerythritol hydroxypenta(meth)acrylate, ditrimethylolpropane tetra(meth)acrylate, pentaerythritol tetra(meth)acrylate, trimethylolpropane triacrylate, ethylene oxide-modified trimethylolpropane tri(meth)acrylate, propylene oxide-modified trimethylolpropane tri(meth)acrylate, caprolactone-modified trimethylolpropane tri(meth)acrylate, pentaerythritol tri(meth)acrylate, tris(2-hydroxyethyl)isocyanurate tri(meth)acrylate, neopentyl glycol diacrylate, ethoxylated neopentyl glycol di(meth)acrylate, propylene oxide-modified neopentyl glycol di(meth)acrylate, propylene oxide-modified glyceryl tri(meth)acrylate, polyester di(meth)acrylate, polyester tri(meth)acrylate, polyester tetra(meth)acrylate, polyester penta(meth)acrylate, polyester poly(meth)acrylate, polyurethane di(meth)acrylate, polyurethane tri(meth)acrylate, polyurethane tetra(meth)acrylate, polyurethane penta(meth)acrylate, polyurethane poly(meth)acrylate, cyclohexane dimethanol divinyl ether, and diethylene glycol divinyl ether. A (meth)acrylic acid ester refers to an acrylic acid ester or a methacrylic acid ester. The same applies to, for example, (meth)acrylate. One of these bifunctional or higher polymerizable compounds may be used alone or two or more of these bifunctional or higher polymerizable compounds may be used in combination.

Examples of the bifunctional or higher polymerizable compound (B1) also include, but are not limited to, urethane (meth)acrylate derivatives obtained by allowing a compound containing an isocyanate group to undergo a reaction with (meth)acrylic acid esters containing a hydroxy group, and epoxy (meth)acrylate derivatives obtained by allowing a compound containing an epoxy group to undergo a reaction with (meth)acrylic acids.

In addition to the (meth)acrylic acid derivatives, vinyl ethers such as diethylene glycol divinyl ethers, triethylene glycol divinyl ethers, and cyclohexane dimethanol divinyl ethers, and allyl compounds such as diallyl phthalate and triallyl trimellitate may also be used.

It is preferable that the bifunctional or higher polymerizable compound (B1) be contained in the composition by 1.0% by mass or greater but 60.0% by mass or less, more preferably by 5.0% by mass or greater but 40.0% by mass or less, and yet more preferably 10.0% by mass or greater but 30.0% by mass or less. One kind of the bifunctional or higher polymerizable compound (B1) may be used alone or two or more kinds of the bifunctional or higher polymerizable compound (B1) may be used in combination.

Combined use of bifunctional or higher polymerizable compounds (B1) makes it possible to easily adjust curability and viscosity of the composition or hardness and adhesiveness of a cured product depending on the intended purpose.

### <Bifunctional or Higher Acrylamide Compound (B2) Represented by General Formula (5)>

It is preferable that the bifunctional or higher polymerizable compound (B1) contain a bifunctional or higher acrylamide compound. Examples of the bifunctional or higher acrylamide compound include, but are not limited to, bifunctional or higher acrylamide compounds (B2) represented by General formula (5) below.

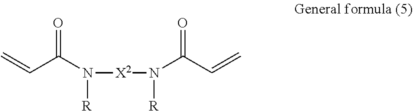

In the formula, R represents a hydrogen atom, or an alkyl group containing from one through four carbon atoms, and may have a branch structure. X² represents an alkylene group containing from one through thirty carbon atoms, or a group in which oxygen, nitrogen, or a sulfur atoms are substituted for some of the carbon atoms of the alkylene group containing from one through thirty carbon atoms, wherein the group may contain a polar functional group, a (meth)acrylate group, or a (meth)acrylamide group as substituents.

The bifunctional or higher acrylamide compound represented by General formula (5) is preferably a compound where R is an alkyl group containing from one through four carbon atoms. When R is an alkyl group containing from one through four carbon atoms, there are two or more tertiary acrylamides with respect to the nucleus structure of the alkylene group. Disclosed use of such compounds includes constituents of resins for dental restoration and dental adhesives. Tertiary acrylamide compounds, which have no such strong intermolecular interaction as hydrogen bonding, hence have a relatively low viscosity, and when cured, form a crosslinked structure that is high in strength represented by, for example, scratch resistance. Moreover, most of such compounds do not have the uncomfortable odor specific to (meth)acrylate compounds, and are hence suitable for active-energy-ray-curable aqueous inks, particularly active-energy-ray-curable aqueous inkjet inks to be discharged in the form of minute liquid droplets.

The number of carbon atoms in the nucleus structure X² of the compound represented by General formula (5) above is preferably 3 or greater. The reason for this is considered the tendency that the viscosity of the compound becomes lower as the number of carbon atoms in X² becomes greater, to increase the degree of freedom of the tertiary acrylamide moieties on both ends and facilitate polymerization reaction. On the other hand, there is a tendency that the strength of a cured product becomes lower as the number of carbon atoms in X² becomes greater. Therefore, the preferable number of carbon atoms in X² is 3 or greater in terms of the balance among viscosity, photopolymerization reactivity, and cured product strength.

Examples of the polar functional groups include, but are not limited to, halogen such as fluorine and chlorine, ester (COOR), amine (NR), a nitro group (NO₂), and a sulfonyl group (SO₃H).

Examples of compounds represented by General formula (5) where R is an alkyl group containing from one through four carbon atoms include, but are not limited to, the following compounds.

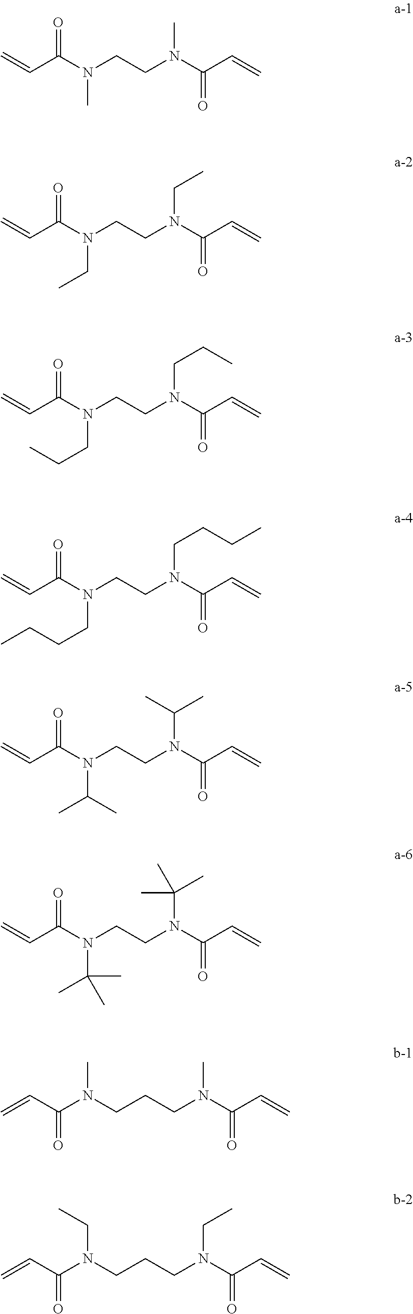

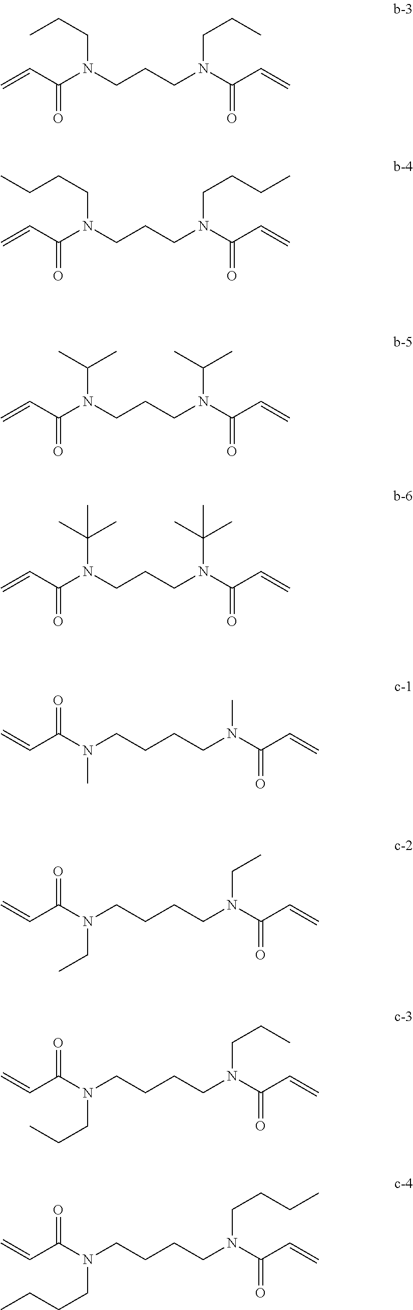

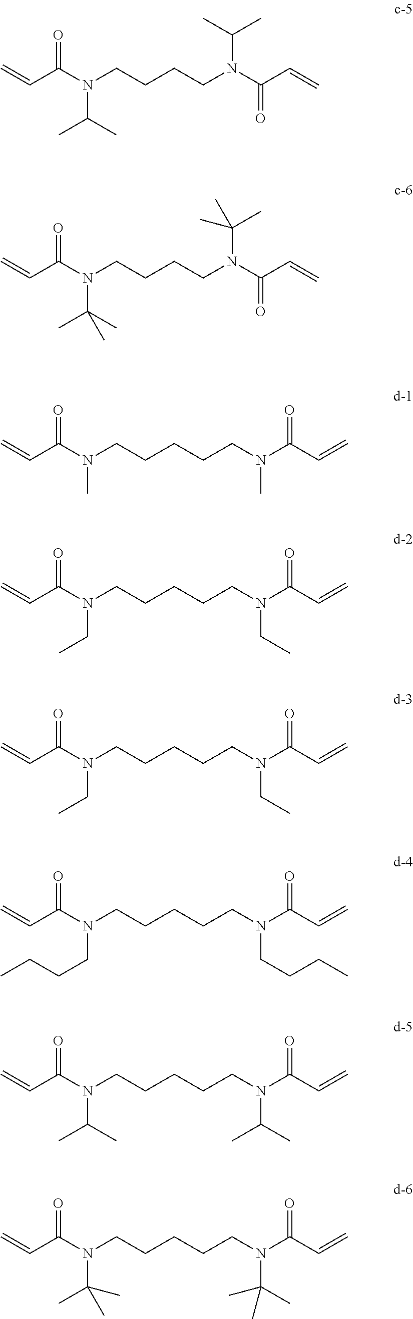

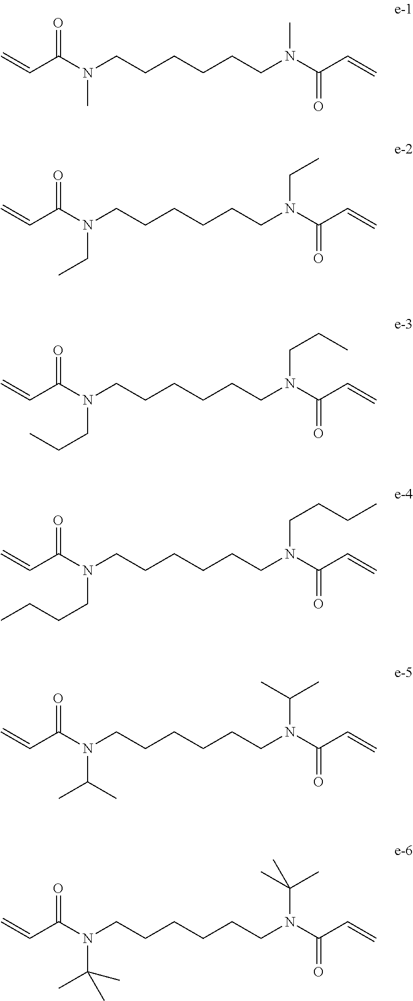

Specific examples of bifunctional or higher secondary acrylamide compounds include, but are not limited to, the following compounds. The following compounds f-1, and f-3 to f-8 are compounds represented by General formula (5) where R is a hydrogen atom.

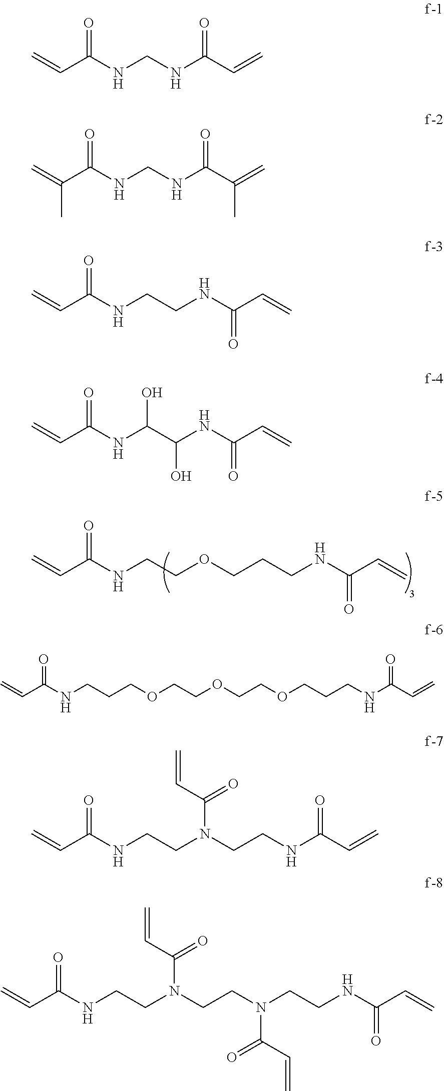

A mixture of two or more kinds of different compounds may be used as the multifunctional acrylamide compound of the present disclosure. In this case, different compounds include structural isomers. The mix proportion is not particularly limited. The content of the multifunctional acrylamide compound in the curable aqueous composition is typically from 0.1% by mass through 50% by mass, preferably 30% by mass or less, and yet more preferably 20% by mass or less.

<Polymerizable Compounds Other than Described Above>

Polymerizable compounds other than described above are not particularly limited and may be appropriately selected depending on the intended purpose so long as they have a reactive substituent that can undergo a polymerization reaction.

As polymerizable monomers, for example, (meth)acrylate, (meth)acrylamide, and vinyl ethers may be used in combination. More specific examples include, but are not limited to, ethylene glycol di(meth)acrylate, γ-butyrolactone acrylate, isobornyl (meth)acrylate, formalized trimethylolpropane mono(meth)acrylate, (meth)acryloylmorpholine, 2-hydroxypropyl (meth)acrylamide, N-vinyl caprolactam, N-vinyl pyrrolidone, N-vinyl formamide, cyclohexane dimethanol monovinyl ether, hydroxyethyl vinyl ether, diethylene glycol monovinyl ether, dicyclopentadiene vinyl ether, tricyclodecane vinyl ether, benzyl vinyl ether, and ethyl oxetane methyl vinyl ether. Any of these examples may be selected and added considering, for example, solubility in water serving as a dispersion medium, the viscosity of the composition, and the thickness of a cured film (coating film) over a base material. In terms of solubility in water, acryloylmorpholine, dimethylaminopropyl acrylamide, polyethylene glycol, or polypropylene glycol-modified acrylate is preferable. One of these may be used alone or two or more of these may be used in combination.

### <Dispersion Containing Resin Particles Having a Polymerizable Group (Dispersion of Reactive Resin Particles)>

A dispersion containing resin particles having a polymerizable group is a water dispersion liquid containing resin particles having reactivity capable of undergoing a polymerization reaction with other particles in response to stimulants such as ultraviolet rays and heat. When the curable aqueous composition contains the dispersion containing resin particles having a polymerizable group, a cured film obtained by curing the curable aqueous composition can have an excellent smoothness (gloss), an excellent flexibility, and an excellent scratch resistance.

The dispersion containing resin particles having a polymerizable group is not particularly limited and may be appropriately selected depending on the intended purpose. Examples of the dispersion containing resin particles having a polymerizable group include, but are not limited to, dispersions containing water-dispersible resin particles having a polymerizable group. Examples of the dispersion containing water-dispersible resin particles having a polymerizable group include, but are not limited to, dispersions of reactive polyurethane particles. Examples of the reactive polyurethane particles include, but are not limited to, (meth)acrylated polyurethane particles.

For example, commercially available products may be used as the dispersion of (meth)acrylated polyurethane particles. Examples of the commercially available product include, but are not limited to, UCECOAT (registered trademark) 6558 (available from Daicel-Allnex Ltd.), UCECOAT (registered trademark) 6559 (available from Daicel-Allnex Ltd.), EBECRYL (registered trademark) 2002 (available from Daicel-Allnex Ltd.), EBECRYL (registered trademark) 2003 (available from Daicel-Allnex Ltd.), UCECOAT (registered trademark) 7710(available from Daicel-Allnex Ltd.), UCECOAT (registered trademark) 7655 (available from Daicel-Allnex Ltd.), NEORAD R (registered trademark) 440 (available from Avecia Limited), NEORAD R (registered trademark) 441 (available from Avecia Limited), NEORAD R (registered trademark) 447 (available from Avecia Limited), NEORAD R (registered trademark) 448 (available from Avecia Limited), BAYHYDROL (registered trademark) U V2317 (available from Covestro AG), BAYHYDROL (registered trademark) UV VP LS2348 (available from Covestro AG), LUX (registered trademark) 430 (available from Alberding Boley Inc.), LUX (registered trademark) 399 (available from Alberding Boley Inc.), LUX (registered trademark) 484 (available from Alberding Boley Inc.), LAROMER (registered trademark) LR8949 (available from BASF GmbH), LAROMER (registered trademark) LR8983 (available from BASF GmbH), LAROMER (registered trademark) PE22WN (available from BASF GmbH), LAROMER (registered trademark) PE55WN (available from BASF GmbH), and LAROMER (registered trademark) UA9060 (available from BASF GmbH). Among these commercially available products, LAROMER (registered trademark) LR8949 (available from BASF GmbH), and LAROMER (registered trademark) LR8983 (available from BASF GmbH) are preferable. LAROMER (registered trademark) LR8949 (available from BASF GmbH) and LAROMER (registered trademark) LR8983 (available from BASF GmbH) can improve scratch resistance.

The content of solid components of the dispersion containing resin particles having a polymerizable group is preferably 2% by mass or greater but 12% by mass or less and more preferably 6% by mass or greater but 12% by mass or less relative to the total amount of the composition. When the content of solid components of the dispersion containing resin particles having a polymerizable group is 2% by mass or greater but 12% by mass or less, scratch resistance can be improved.

### <<Amine Compound>>

In the present disclosure, the curable aqueous composition can contain an amine compound as a pH adjustor. An organic amine compound having a boiling point of 120 degrees C. or higher but 200 degrees C. or lower and a molecular weight of 100 or less is preferable. Moreover, when the content (mass basis) of the resin particles in the curable aqueous composition is assumed to be 1, it is more preferable that the content of the amine compound be 0.01 or greater but 0.1 or less. This realizes a better maintainability.

The amine compound may be any of primary, secondary, tertiary, quaternary amines and salts of these amines. Quaternary amines refer to compounds in which four alkyl groups are substituted for a nitrogen atom.

Compounds represented by the following formula (I) or (II) are preferable as the amine compound.

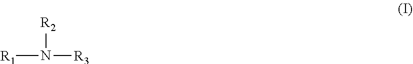

In formula, R₁, R₂, and R₃ each independently represent a hydrogen atom, an alkoxy group containing from one through four carbon atoms, an alkyl group containing from one through six carbon atoms, or a hydroxyethyl group. However, all of R₁, R₂, and R₃ do not represent a hydrogen atom at the same time.

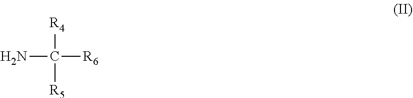

In formula, R₄, R₅, and R₆ each independently represent a hydrogen atom, a hydroxymethyl group, a hydroxyethyl group, and an alkyl group containing from one through four carbon atoms.

Examples of the compounds represented by formulae (I) and (II) include, but are not limited to, triethylamine, 2-amino-2-methyl-1-propanol, 2-amino-2-ethyl-1,3-diol, 1-amino-2-propanol, 3-amino-1-propanol, N-methyl ethanol amine, N,N-dimethyl ethanol amine, and 1-amino-2-methyl-propanol. 2-Amino-2-methyl-1-propanol, 1-amino-2-propanol, 3-amino-1-propanol, N-methylethanolamine, N,N-dimethylethanolamine, and 1-amino-2-methyl-propanol are organic amine compounds having a boiling point of 120 degrees C. or higher but 200 degrees C. or lower and a molecular weight of 100 or less.

The content of the amine compound in the curable aqueous composition is not particularly limited and is preferably from 0.01% by mass through 5% by mass and particularly preferably from 0.05% by mass through 2% by mass in terms of pH adjustment of the curable aqueous composition.

In addition to the amine compounds mentioned above, other amine compounds may be used in combination as the amine compound contained in the curable aqueous composition.

### <Polymerization Initiator (C1)>

The curable aqueous composition of the present disclosure contains a polymerization initiator. The polymerization initiator produces active species such as a radical or a cation upon application of energy of an active energy ray and initiates polymerization of a polymerizable compound (monomer or oligomer). As the polymerization initiator, it is suitable to use a known radical polymerization initiator, cation polymerization initiator, base generator, or a combination thereof. Of these, a radical polymerization initiator is preferable. Moreover, the polymerization initiator preferably accounts for 2 percent by weight to 15 percent by weight of the total content (100% by weight) of the composition to obtain sufficient curing speed.

Specific examples of the radical polymerization initiators include, but are not limited to, aromatic ketones, acylphosphine oxide compounds, aromatic onium chlorides, organic peroxides, thio compounds (thioxanthone compounds, thiophenyl group containing compounds, etc.), hexaaryl biimidazole compounds, ketoxime ester compounds, borate compounds, azinium compounds, metallocene compounds, active ester compounds, and compounds having a carbon halogen bond(s).

A water-soluble polymerization initiator is particularly preferable. A photopolymerization initiator containing a hydroxyl group in a molecule thereof is preferable. As the photopolymerization initiator skeleton, alkylphenone-based and monoacylphosphine oxide-based polymerization initiators are preferable. For example, lithium phenyl (2,4,6-trimethylbenzoyl) phosphinate, 2-hydroxy-4′-(2-hydroxyethoxy)-2-methyl propiophenone (Product name: IRGACURE 2959), thioxanthone ammonium salt (product name: QUANTACURE QTX), and benzophenone ammonium salt (product name: QUANTACURE ABQ) are preferable.

In the present disclosure, a “water-soluble” polymerization initiator refers to one that dissolves by 1% by mass or greater in water.

In addition to the polymerization initiator, a hydrogen donor (sensitizer) may be used in combination. The hydrogen donor is not particularly limited, and is preferably an amine compound having an aromatic ring such as p-diethylaminoacetophenone, ethyl p-dimethylaminobenzoate, p-dimethyl aminobenzoic acid-2-ethylhexyl, N,N-dimethylbenzylamine, and 4,4′-bis(diethylamino)benzophenone. The content of the hydrogen donor may be appropriately set depending on the kind and the amount of the polymerization initiator used. Use of an amine compound having an aromatic ring makes it possible to suppress basicity and enhance temporal stability of, for example, monomers.

### <Organic Solvent>

There is no specific limitation on the type of the organic solvent used in the present disclosure. Water-soluble organic solvents are suitable. Specific examples thereof include, but are not limited to, polyols, ethers such as polyol alkylethers and polyol arylethers, nitrogen-containing heterocyclic compounds, amides, amines, and sulfur-containing compounds.

Specific examples of water-soluble organic solvents include, but are not limited to, polyols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane triol, 1,2,3-butanetriol, 2,2,4-trimethyl-1,3-pentanediol, and petriol; polyol alkylethers such as ethylene glycol monoethylether, ethylene glycol monobutylether, diethylene glycol monomethylether, diethylene glycol monoethylether, diethylene glycol monobutylether, tetraethylene glycol monomethylether, and propylene glycol monoethylether; polyol arylethers such as ethylene glycol monophenylether and ethylene glycol monobenzylether; nitrogen-containing heterocyclic compounds such as 2-pyrolidone, N-methyl-2-pyrolidone, N-hydroxyethyl-2-pyrolidone, 1,3-dimethyl-2-imidazolidinone, ε-caprolactam, and γ-butyrolactone; amides such as formamide, N-methylformamide, N,N-dimethylformamide, 3-methoxy-N,N-dimethyl propionamide, and 3-butoxy-N,N-dimethyl propionamide; sulfur-containing compounds such as dimethyl sulfoxide, sulfolane, and thiodiethanol; and propylene carbonate and ethylene carbonate.

Since the organic solvent serves as a humectant and also imparts a good drying property, it is preferable to use an organic solvent having a boiling point of 250 degrees C. or lower.

Polyol compounds having eight or more carbon atoms and glycol ether compounds are also suitable as the organic solvent. Specific examples of the polyol compounds having eight or more carbon atoms include, but are not limited to, 2-ethyl-1,3-hexanediol and 2,2,4-trimethyl-1,3-pentanediol.

Specific examples of the glycolether compounds include, but are not limited to, polyol alkylethers such as ethyleneglycol monoethylether, ethyleneglycol monobutylether, diethylene glycol monomethylether, diethyleneglycol monoethylether, diethyleneglycol monobutylether, tetraethyleneglycol monomethylether, and propyleneglycol monoethylether; and polyol arylethers such as ethyleneglycol monophenylether and ethyleneglycol monobenzylether.

The polyol compounds having eight or more carbon atoms and glycol ether compounds enhance the permeability of the ink when paper is used as a print medium.

The proportion of the organic solvent in the curable aqueous composition has no particular limit and can be suitably selected to suit a particular application. In terms of the drying property and discharging reliability of the curable aqueous composition, the proportion is preferably from 10 to 40 percent by mass and more preferably from 15 to 30 percent by mass.

### <Water>

The content of water in the curable aqueous composition is not particularly limited may be appropriately selected depending on the intended purpose, and is preferably 1% by mass or greater but 50% by mass or less and more preferably 20% by mass or greater but 45% by mass or less in terms of the drying property and discharging reliability of the curable aqueous composition.

### <Colorant>

The curable aqueous composition of the present disclosure may contain a colorant. As the colorant, various pigments and dyes may be used that impart black, white, magenta, cyan, yellow, green, orange, and gloss colors such as gold and silver, depending on the intended purpose of the composition of the present and requisite properties thereof. A content of the colorant is not particularly limited, may be appropriately determined considering, for example, a desired color density and dispersibility in the composition, and is preferably from 0.1% by mass to 20% by mass relative to the total mass (100% by mass) of the composition. The curable aqueous composition of the present disclosure may be clear and colorless without containing a colorant. In this case, the curable aqueous composition is suitable as, for example, an overcoat layer for protecting an image.

The colorant can be either inorganic or organic, and two or more of the colorants can be used in combination.

As the inorganic pigments, carbon blacks (C.I. Pigment Black 7) such as furnace black, lamp black, acetylene black, and channel black, iron oxides, and titanium oxides can be used.

Specific examples of the organic pigments include, but are not limited to, azo pigments such as insoluble azo pigments, condensed azo pigments, azo lakes, and chelate azo pigments, polycyclic pigments such as phthalocyanine pigments, perylene and perinone pigments, anthraquinone pigments, quinacridone pigments, dioxane pigments, thioindigo pigments, isoindolinone pigments, and quinophthalone pigments, dye chelates (e.g., basic dye chelates, acid dye chelates), dye lakes (e.g., basic dye lakes, acid dye lakes), nitro pigments, nitroso pigments, aniline black, and daylight fluorescent pigments.

The curable aqueous composition may further contain a dispersant in order to improve dispersibility of the pigment. The dispersant is not particularly limited. Examples of the dispersant include, but are not limited to, dispersants commonly used to prepare pigment dispersions, such as polymeric dispersants.

The dyes are not particularly limited. Specific examples of the dyes include, but are not limited to acidic dyes, direct dyes, reactive dyes, and basic dyes. One of these dyes may be used alone or two or more of these dyes may be used in combination.

### <Pigment Dispersion>

The ink can be obtained by mixing a pigment with materials such as water and organic solvent. It is also possible to mix a pigment with water, a dispersant, etc., first to prepare a pigment dispersion and thereafter mix the pigment dispersion with materials such as water and organic solvent to manufacture ink.

The pigment dispersion is obtained by mixing and dispersing water, pigment, pigment dispersant, and other optional components and adjusting the particle diameter. It is good to use a dispersing device for dispersion.

The particle diameter of the pigment in the pigment dispersion has no particular limit. For example, the maximum frequency in the maximum number conversion is preferably from 20 to 500 nm and more preferably from 20 to 150 nm to improve dispersion stability of the pigment and ameliorate the discharging stability and image quality such as image density. The particle diameter of the pigment can be measured using a particle size analyzer (Nanotrac Wave-UT151, manufactured by MicrotracBEL Corp).

In addition, the proportion of the pigment in the pigment dispersion is not particularly limited and can be suitably selected to suit a particular application. In terms of improving discharging stability and image density, the content is preferably from 0.1 to 50 percent by mass and more preferably from 0.1 to 30 percent by mass.

During the production, coarse particles are optionally filtered off from the pigment dispersion with a filter, a centrifuge, etc. preferably followed by degassing.

The particle diameter of the solid portion in ink has no particular limit and can be suitably selected to suit to a particular application. For example, the maximum frequency in the maximum number conversion is preferably from 20 to 1,000 nm and more preferably from 20 to 150 nm to ameliorate the discharging stability and image quality such as image density.

The solid portion includes resin particles, particles of pigments, etc. The particle diameter of the solid portion can be measured by using a particle size analyzer (Nanotrac Wave-UT151, manufactured by MicrotracBEL Corp).

### <Other Components>

The curable aqueous composition of the present disclosure may contain other known components as needed. The other components are not particularly limited. Examples of the other components include, but are not limited to, a surfactant, a polymerization inhibitor, a leveling agent, a defoaming agent, a fluorescent brightener, a permeation enhancer, a wetting agent (humectant), a fixing agent, a viscosity stabilizer, a fungicide, a preservative, an antioxidant, an ultraviolet absorbent, a chelate agent, a pH adjustor, and a thickener that have been hitherto known.

### <Surfactant>

Examples of the surfactant include, but are not limited to, silicone-based surfactants, fluorosurfactants, amphoteric surfactants, nonionic surfactants, and anionic surfactants.

The silicone-based surfactant has no specific limit and can be suitably selected to suit to a particular application. Silicone-based surfactants which are not decomposed even in a high pH environment are preferred. Specific examples thereof include, but are not limited to, side-chain-modified polydimethylsiloxane, both end-modified polydimethylsiloxane, one-end-modified polydimethylsiloxane, and side-chain-both-end-modified polydimethylsiloxane. A silicone-based surfactant having a polyoxyethylene group or a polyoxyethylene polyoxypropylene group as a modifying group is particularly preferable because such an agent demonstrates good characteristics as an aqueous surfactant. It is possible to use a polyether-modified silicone-based surfactant as a silicone-based surfactant. A specific example thereof is a compound in which a polyalkylene oxide structure is introduced into the side chain of the Si site of dimethyl siloxane.

Specific examples of the fluoro surfactants include, but are not limited to, perfluoroalkyl sulfonic acid compounds, perfluoroalkyl carboxylic acid compounds, perfluoroalkyl phosphoric acid ester compounds, adducts of perfluoroalkyl ethylene oxide, and polyoxyalkylene ether polymer compounds having a perfluoroalkyl ether group in its side chain. These fluoro surfactants are particularly preferable because these fluoro surfactants do not foam easily. Specific examples of the perfluoroalkyl sulfonic acid compounds include, but are not limited to, perfluoroalkyl sulfonic acid and salts of perfluoroalkyl sulfonic acid. Specific examples of the perfluoroalkyl carboxylic acid compounds include, but are not limited to, perfluoroalkyl carboxylic acid and salts of perfluoroalkyl carboxylic acid. Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain and salts of polyoxyalkylene ether polymers having a perfluoroalkyl ether group in its side chain. Counter ions of salts in these fluorine-based surfactants are, for example, Li, Na, K, NH₄, NH₃CH₂CH₂OH, NH₂(CH₂CH₂OH)₂, and NH(CH₂CH₂OH)₃.

Specific examples of the amphoteric surfactants include, but are not limited to, lauryl aminopropionic acid salts, lauryl dimethyl betaine, stearyl dimethyl betaine, and lauryl dihydroxy ethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides, etc.

Specific examples of the anionic surfactants include, but are not limited to, polyoxyethylene alkyl ether acetates, dodecyl benzene sulfonates, laurates, and polyoxyethylene alkyl ether sulfates.

These surfactants can be used alone or in combination.

The silicone-based surfactants have no particular limit and can be suitably selected to suit to a particular application. Specific examples thereof include, but are not limited to, side-chain-modified polydimethyl siloxane, both end-modified polydimethylsiloxane, one-end-modified polydimethylsiloxane, and side-chain-both-end-modified polydimethylsiloxane. In particular, a polyether-modified silicone-based surfactant having a polyoxyethylene group or a polyoxyethylene polyoxypropylene group as a modifying group is particularly preferable because such a surfactant demonstrates good characteristics as an aqueous surfactant.

Any suitably synthesized surfactant and any product thereof available on the market is suitable. Products available on the market are obtained from Byk Chemie Japan Co., Ltd., Shin-Etsu Chemical Co., Ltd., Dow Corning Toray Silicone Co., Ltd., NIHON EMULSION Co., Ltd., Kyoeisha Chemical Co., Ltd., etc.

The polyether-modified silicone-based surfactant has no particular limit and can be suitably selected to suit to a particular application. Examples thereof include, but are not limited to, a compound in which the polyalkylene oxide structure represented by the following General formula S-1 is introduced into the side chain of the Si site of dimethyl polysiloxane.

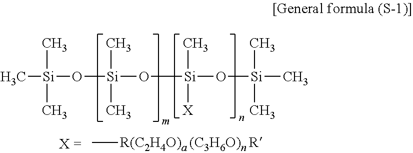

In General formula S-1, “m”, “n”, “a”, and “b” each, respectively represent integers, R represents an alkylene group, and R′ represents an alkyl group.

Products available on the market may be used as the polyether-modified silicone-based surfactants. Specific examples of the products available on the market include, but are not limited to, KF-618, KF-642, and KF-643 (all manufactured by Shin-Etsu Chemical Co., Ltd.), EMALEX-SS-5602 and SS-1906EX (both manufactured by NIHON EMULSION Co., Ltd.), FZ-2105, FZ-2118, FZ-2154, FZ-2161, FZ-2162, FZ-2163, and FZ-2164 (all manufactured by Dow Corning Toray Silicone Co., Ltd.), BYK-33 and BYK-387 (both manufactured by Byk Chemie Japan Co., Ltd.), and TSF4440, TSF4452, and TSF4453 (all manufactured by Toshiba Silicone Co., Ltd.

A fluorosurfactant in which the number of carbon atoms replaced with fluorine atoms is from 2 to 16 and more preferably from 4 to 16 is preferable.

Specific examples of the fluorosurfactants include, but are not limited to, perfluoroalkyl phosphoric acid ester compounds, adducts of perfluoroalkyl ethylene oxide, and polyoxyalkylene ether polymer compounds having a perfluoroalkyl ether group in its side chain.

Of these fluorosurfactants, polyoxyalkylene ether polymer compounds having a perfluoroalkyl ether group in its side chain are preferable because these compounds do not foam easily and the fluorosurfactant represented by the following General formula F-1 or General formula F-2 is particularly preferable.

CF₃CF₂(CF₂CF₂)ₙ—CH₂CH₂O(CH₂CH₂O)ₙH [General formula (F-1)]

In General formula F-1, “m” is preferably 0 or an integer of from 1 to 10 and “n” is preferably 0 or an integer of from 1 to 40 in order to provide water solubility.

CₙF₂ₙ₊₁—CH₂CH(OH)CH₂—O—(CH₂CH₂O)ₐ—Y <General formula (F-2)>

In General formula F-2, Y represents H, CₙF₂₊₁, where “n” is an integer of from 1 to 6, CH₂CH(OH)CH₂—CₙF₂ₙ₊₁, where n represents an integer of from 4 to 6, or CₚH₂ₚ₊₁, where p represents an integer of from 1 to 19. “n” represents an integer of from 1 to 6. “a” represents an integer of from 4 to 14.

Products available on the market may be used as the fluorosurfactant.

Specific examples of the products available on the market include, but are not limited to, SURFLON S-111, S-112, S-113, S-121, S-131, S-132, S-141, and S-145 (all available from AGC Inc.); FLUORAD FC-93, FC-95, FC-98, FC-129, FC-135, FC-170C, FC-430, and FC-431 (all available from Sumitomo 3M Limited); MEGAFAC F-470, F-1405, and F-474 (all available from DIC Corporation); ZONYL TBS, FSP, FSA, FSN-100, FSN, FSO-100, FSO, FS-300, and UR, and CAPSTONE FS-30, FS-31, FS-3100, FS-34, and FS-35 (all available from Chemours Company TT, LLC); FT-110, FT-250, FT-251, FT-400S, FT-150, and FT-400SW (all available from NEOS Company Limited.), POLYFOX PF-136A,PF-156A, PF-151N, PF-154, and PF-159 (available from OMNOVA SOLUTIONS INC.), and UNIDYNE DSN-403N (available from DAIKIN INDUSTRIES). Of these products, FS-3100, FS-34, and FS-300 (all available from Chemours Company TT, LLC), FT-110, FT-250, FT-251, FT-400S, FT-150, and FT-400SW (all available from NEOS Company Limited), POLYFOX PF-151N (available from OMNOVA SOLUTIONS INC.), and UNIDYNE DSN-403N (available from DAIKIN INDUSTRIES) are particularly preferable in terms of good printing quality, coloring in particular, and improvement on permeation, wettability, and uniform dyeing property to paper.

The proportion of the surfactant in the ink is not particularly limited and can be suitably selected to suit to a particular application. It is preferably from 0.001 to 5 percent by mass and more preferably from 0.05 to 5 percent by mass relative to the total amount of the ink in terms of excellent wettability and discharging stability and improvement on image quality.

### <Defoaming Agent>

The defoaming agent has no particular limit. For example, silicone-based defoaming agents, polyether-based defoaming agents, and aliphatic acid ester-based defoaming agents are suitable. These defoaming agents can be used alone or in combination. Of these defoaming agents, silicone-based defoaming agents are preferable to easily break foams.

### <Preservatives and Fungicides>

The preservatives and fungicides are not particularly limited. A specific example is 1,2-benzisothiazolin-3-on.

### <Corrosion Inhibitor>

The corrosion inhibitor has no particular limit. Examples thereof are acid sulfite and sodium thiosulfate.

Physical properties of the curable aqueous composition of the present disclosure are not particularly limited and may be appropriately selected depending on the intended purpose. Preferable ranges of, for example, viscosity, surface tension, and pH are as follows.

The viscosity of the curable aqueous composition of the present disclosure have no particular limit because it can be adjusted depending on the purpose and application devices. For example, if an ejecting device that ejects the composition from nozzles is employed, the viscosity thereof is preferably in the range of 3 mPa·s to 40 mPa·s, more preferably 5 mPa·s to 15 mPa·s, and particularly preferably 6 mPa-s to 12 mPa·s in the temperature range of 20 degrees C. to 65 degrees C., preferably at 25 degrees C. In addition, it is particularly preferable to satisfy this viscosity range by the composition free of the organic solvent described above. Incidentally, the viscosity can be measured by a cone plate rotary viscometer (VISCOMETER TVE-22L, manufactured by TOKI SANGYO CO., LTD.) using a cone rotor (1° 34′×R24) at a number of rotation of 50 rpm with a setting of the temperature of hemathermal circulating water in the range of 20 degrees C. to 65 degrees C. VISCOMATE VM-150III can be used for the temperature adjustment of the circulating water.

The surface tension of the curable aqueous composition of the present disclosure is preferably 35 mN/m or lower and more preferably 32 mN/m or lower at 25 degrees C. because the ink is suitably leveled over a print medium and the drying time of the ink is shortened.

The pH of the curable aqueous composition of the present disclosure is preferably from 7 through 12 and more preferably 8 through 11 in terms of preventing corrosion of metallic members to be contacted by the curable aqueous composition liquid.

### <Curing Method>

Examples of the method for curing the curable aqueous composition of the present disclosure include curing with active energy rays. The curable aqueous composition may also be heated during curing with active energy rays.

Active energy rays used for curing the curable aqueous composition of the present disclosure are not particularly limited, so long as they are able to give necessary energy for allowing polymerization reaction of polymerizable components in the composition to proceed. Examples of the active energy rays include, but are not limited to, electron beams, α-rays, β-rays, γ-rays, and X-rays, in addition to ultraviolet rays. When a light source having a particularly high energy is used, polymerization reaction can be allowed to proceed without a polymerization initiator. In addition, in the case of irradiation with ultraviolet ray, mercury-free is preferred in terms of protection of environment. Therefore, replacement with GaN-based semiconductor ultraviolet light-emitting devices is preferred from industrial and environmental point of view. Furthermore, ultraviolet light-emitting diode (UV-LED) and ultraviolet laser diode (UV-LD) are preferable as an ultraviolet light source. Small sizes, long time working life, high efficiency, and high cost performance make such irradiation sources desirable. The curing method is preferably a UV-LED configured to emit ultraviolet rays having a peak in the wavelength range of from 365 through 405 nm.

### <Preparation of Curable Aqueous Composition>

The curable aqueous composition of the present disclosure can be prepared by using the various components described above. The preparation devices and conditions are not particularly limited. For example, the curable aqueous composition can be prepared by subjecting a polymerizable monomer, a pigment, a dispersant, etc., to a dispersion treatment using a dispersing machine such as a ball mill, a kitty mill, a disk mill, a pin mill, and a DYNO-MILL to prepare a pigment liquid dispersion, and further mixing the pigment liquid dispersion with a polymerizable monomer, an initiator, a polymerization inhibitor, and a surfactant.

### <Application Field>

The application field of the curable aqueous composition of the present disclosure is not particularly limited. The curable aqueous composition can be applied to any field where active-energy-ray-curable compositions are used. For example, the curable aqueous composition is selected to a particular application and used for a resin for processing, a paint, an adhesive, an insulant, a releasing agent, a coating material, a sealing material, various resists, and various optical materials.

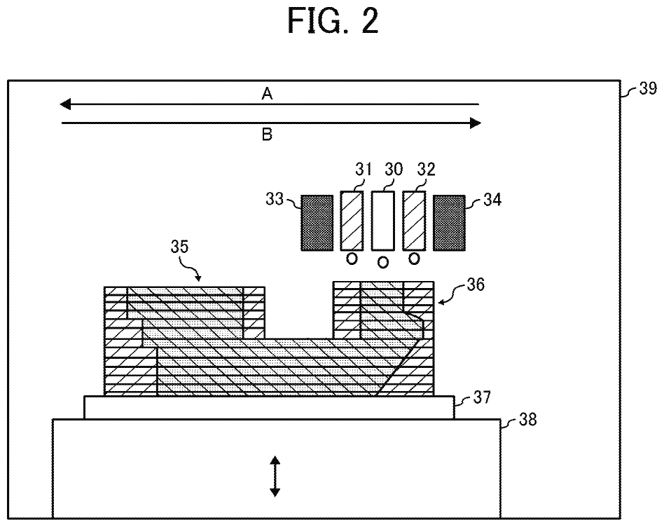

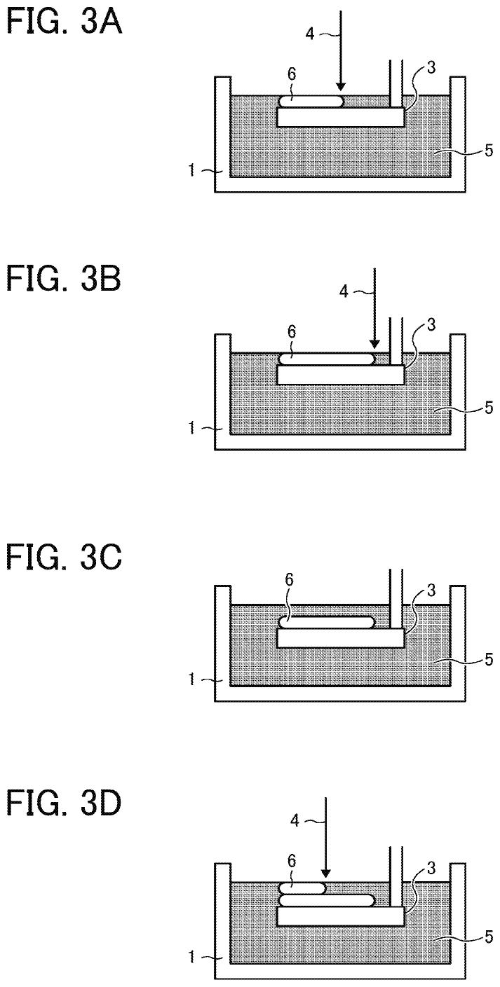

Furthermore, the curable aqueous composition of the present disclosure can be used as an ink to form two-dimensional texts, images, and designed coating film on various substrates and in addition as a solid object forming material to form a three-dimensional object. This three dimensional object forming material may also be used as a binder for powder particles used in a powder layer laminating method of forming a three-dimensional object by repeating curing and layer-forming of powder layers, and as a three-dimensional object constituent material (a model material) and a supporting member used in an additive manufacturing method (a stereolithography method) as illustrated in FIG. 2 and FIGS. 3A to 3D. FIG. 2 is a diagram illustrating a method of additive manufacturing to sequentially form layers of the curable aqueous composition of the present disclosure one on top of the other by repeating discharging the curable aqueous composition to particular areas followed by curing upon irradiation of an active energy ray (to be described in detail below). FIGS. 3A to 3D is a diagram illustrating a method of additive manufacturing to sequentially form cured layers 6 having respective predetermined forms one on top of the other on a movable stage 3 by irradiating a storing pool (storing part) 1 of the curable aqueous composition 5 of the present disclosure with the active energy ray 4.

An apparatus for fabricating a three-dimensional object by the curable aqueous composition of the present disclosure is not particularly limited and can be a known apparatus. For example, the apparatus includes a containing device, a supplying device, and a discharging device of the composition, and an active energy ray irradiator.

In addition, the present disclosure includes cured materials obtained by curing the curable aqueous composition, decorated products having surface decoration formed of the cured materials, and processed products obtained by processing structures having the cured materials on a substrate. The processed product is fabricated by, for example, heat-drawing and punching a cured material or structure having a sheet-like form or film-like form. Examples thereof are products that need processing after decoration of the surface, such as gauges or operation panels of vehicles, office machines, electric and electronic machines, and cameras.

The substrate is not particularly limited. It can suitably be selected to a particular application. Examples thereof include, but are not limited to, paper, thread, fiber, fabrics, leather, metal, plastic, glass, wood, ceramic, or composite materials thereof. Of these, plastic substrates are preferred in terms of processability.

### <Print Medium>

The print medium for use in printing is not particularly limited. Specific examples thereof include, but are not limited to, plain paper, gloss paper, special paper, cloth, film, OHP sheets, printing paper for general purpose.

### <Composition Stored Container>

A composition stored container of the present disclosure contains the active-energy-ray-curable aqueous composition or the active-energy-ray-curable aqueous ink of the present disclosure and is suitable for the applications as described above. For example, if the curable aqueous composition of the present disclosure is used for ink, a container that stores the ink can be used as an ink cartridge or an ink bottle. Therefore, users can avoid direct contact with the ink during operations such as transfer or replacement of the ink, so that fingers and clothes are prevented from contamination. Furthermore, inclusion of foreign matters such as dust in the ink can be prevented. In addition, the container can be of any size, any form, and any material. For example, the container can be designed to a particular application. It is preferable to use a light blocking material to block the light or cover a container with a light blocking sheet, etc.

### <Image Forming Method and Forming Apparatus>

The image forming method of the present disclosure uses active energy rays and may also perform heating during curing.

An image forming method of the present disclosure includes an irradiating step of irradiating the curable aqueous composition or the curable aqueous ink of the present disclosure with an active energy ray to cure the curable aqueous composition or the curable aqueous ink. An image forming apparatus of the present disclosure includes an irradiator to irradiate the curable aqueous composition or the curable aqueous ink of the present disclosure with an active energy ray, and a storing part containing the curable aqueous composition or the curable aqueous ink of the present disclosure. The storing part may include the composition stored container mentioned above. Furthermore, the method and the apparatus may respectively include a discharging step and a discharging device to discharge the curable aqueous composition or the curable aqueous ink. The method of discharging the curable aqueous composition or the curable aqueous ink is not particularly limited, and examples thereof include a continuous jetting method and an on-demand method. The on-demand method includes a piezo method, a thermal method, an electrostatic method, etc.

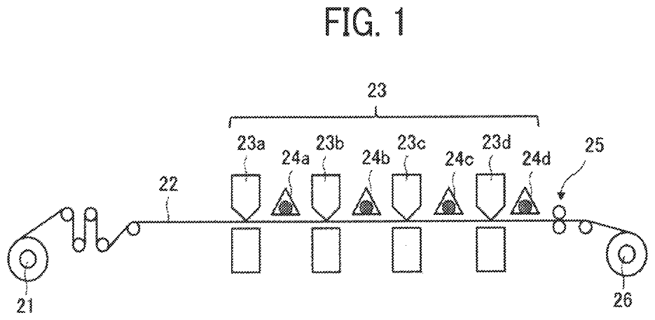

FIG. 1 is a diagram illustrating a two-dimensional image forming apparatus equipped with an inkjet discharging device. Printing units 23a, 23b, 23c, and 23d respectively having ink cartridges and discharging heads for yellow, magenta, cyan, and black curable aqueous inks discharge the inks onto a print medium 22 fed from a supplying roller 21. Thereafter, light sources 24a, 24b, 24c, and 24d configured to cure the inks emit active energy rays to the inks, thereby curing the inks to form a color image. Thereafter, the print medium 22 is conveyed to a processing unit 25 and a printed matter reeling roll 26. Each of the printing unit 23a, 23b, 23c and 23d may have a heating mechanism to liquidize the ink at the ink discharging portion. Moreover, in another embodiment of the present disclosure, a mechanism may optionally be included to cool down the print medium to around room temperature in a contact or non-contact manner. In addition, the inkjet recording method may be either of serial methods or line methods. The serial methods include discharging an ink onto a print medium by moving the head while the print medium intermittently moves according to the width of a discharging head. The line methods include discharging an ink onto a print medium from a discharging head held at a fixed position while the print medium continuously moves.

The print medium 22 is not particularly limited. Specific examples thereof include, but are not limited to, paper, film, ceramic, glass, metal, or complex materials thereof. The print medium 22 takes a sheet-like form but is not limited thereto. The image forming apparatus may have a one-side printing configuration and/or a two-side printing configuration. The print medium is not limited to articles used as typical print media. It is suitable to use cardboard, building materials such as wall paper and floor material, cloth for apparel such as T-shirts, textile, and leather as the print medium.

Optionally, multiple colors can be printed with no or weak active energy ray from the light sources 24a, 24b, and 24c followed by irradiation of the active energy ray from the light source 24d. As a result, energy and cost can be saved.

The printed matter having images printed with the curable aqueous composition of the present disclosure includes articles having printed images or texts on a plain surface of conventional paper, resin film, etc., a rough surface, or a surface made of various materials such as metal or ceramic. In addition, by laminating layers of images in part or the entire of a print medium, a partially stereoscopic image (formed of two dimensional part and three-dimensional part) and a three dimensional objects can be fabricated.

FIG. 2 is a schematic diagram illustrating another example of the image forming apparatus (apparatus to fabricate a 3D object) of the present disclosure. An image forming apparatus 39 illustrated in FIG. 2 sequentially forms thin layers one on top of the other using a head unit having inkjet heads arranged movable in the directions indicated by the arrows A and B. In the image forming apparatus 39, an ejection head unit 30 for additive manufacturing ejects a first curable composition, and ejection head units 31 and 32 for support and curing these compositions eject a second curable composition having a different composition from the first curable composition, while ultraviolet irradiators 33 and 34 adjacent to the ejection head units 31 and 32 cure the compositions. To be more specific, for example, after the ejection head units 31 and 32 for support eject the second curable composition onto a substrate 37 for additive manufacturing and the second curable composition is solidified by irradiation of an active energy ray to form a first substrate layer having a space for composition, the ejection head unit 30 for additive manufacturing ejects the first curable composition onto the pool followed by irradiation of an active energy ray for solidification, thereby forming a first additive manufacturing layer. This step is repeated multiple times lowering the stage 38 movable in the vertical direction to laminate the supporting layer and the additive manufacturing layer to fabricate a solid object 35. Thereafter, an additive manufacturing support 36 is removed, if desired. Although only a single ejection head unit 30 for additive manufacturing is provided to the image forming apparatus illustrated in FIG. 2, it can have two or more units 30.

The active-energy-ray-curable aqueous composition of the present disclosure can be used as at least one selected from the first curable composition and the second curable composition mentioned above.

### <Cured Product>

A cured product of the present disclosure contains a reaction product of at least one kind of an acrylamide compound (A1) selected from the group consisting of acrylamide compounds represented by General formula (1) above and acrylamide compounds represented by General formula (4) above, and a bifunctional or higher polymerizable compound (B1). The cured product can be formed by using the active-energy-ray-curable aqueous composition or the active-energy-ray-curable aqueous ink of the present disclosure.

### EXAMPLES

The present disclosure will be described below by way of Examples. The present disclosure should not be construed as being limited to these Examples.

### <Method for Evaluating SI Value>

The SI value was measured in the manner described below by a skin sensitization test according to a local lymph node assay (LLNA) method.

### [Test Materials]

### <<Positive Control Substance>>

As the positive control substance, α-hexyl cinnamaldehyde (HCA, obtained from Wako Pure Chemical Industries, Ltd.) was used.

### <<Medium>>

As the medium, a mixture liquid containing acetone (obtained from Wako Pure Chemical Industries, Ltd.) and olive oil (obtained from Fudimi Pharmaceutical Co., Ltd.) in a volume ratio of 4:1 (acetone:olive oil) was used.

### <<Animals Used>>

Female mice were acclimated to the test substance, the positive control, and the medium control for 8 days including 6-day quarantine. No abnormalities were found in all of the animals during the quarantine/acclimation period.

Based on the body weights measured 2 days before the initiation of sensitization, the animals were separated into 2 groups (4 mice/group) by the body weight stratified random sampling method in a manner that the body weight of each individual was within ±20% of the average body weight of all individuals. Each of the animals was 8 weeks old to 9 weeks old at the time of the initiation of sensitization. The animals that did not fall into any group were excluded from the test.

The animals used were individually identified by application of an oil-based ink to their tale throughout the test period, and their cages were also identified by labeling.

### <<Rearing Environment>>

Throughout the rearing period including the quarantine/acclimation period, the animals used were reared in a rearing room with a barrier system, which was set to a temperature of from 21 degrees C. through 25 degrees C., a relative humidity of from 40% through 70%, a ventilation frequency of from 10 times/hour through 15 times/hour, and a 12 hour-light-dark cycle (lighting at 7 o'clock and unlighting at 19 o'clock).

As the rearing cages, cages formed of polycarbonate were used. The animals used were reared by 4 animal/cage.

As the feed, the animals used were fed ad libitum with a solid feed for laboratory animals MF (obtained from Oriental Yeast Co., Ltd.). As the drinking water, the animals used were fed ad libitum with tap water in which sodium hypochlorite (PURELOX, obtained from OYALOX Co., Ltd.) was added in a manner that the chlorine concentration was about 5 ppm, using a water-supply bottle. As the bedding, SUNFLAKE (fir wood, shavings of an electric planer, obtained from Charles River Inc.) was used. All of the feed and the rearing equipment used were sterilized in an autoclave (at 121 degrees C. for 30 minutes).

The cages and the bedding were replaced with new ones at the grouping and on the day of removing auricular lymph nodes (i.e., at the times when the animals were taken out from the rearing room). The water-supply bottle and the racks were replaced with new ones at the grouping.

### [Testing Method]

### <<Group Composition>>

The group compositions used in the SI value measuring test are presented in Table 1.

TABLE 1

| | | Sensitizing | Number of | |
|---|---|---|---|---|
| | | dose | times of | Number of |
| | | (microliter/ | sensitiza- | animals |
| Test group | Sensitizer | auricle) | tion | (animal Nos.) |
| Medium | Medium | 25 | once/day × | 4 (1 to 4) |
| control group | only | | 3 days | |
| Positive | 2.50% | 25 | once/day × | 4 (5 to 8) |
| control group | HCA | | 3 days | |

### [Preparation]

### <<Test Substance>>

Table 2 presents the test substance weighing conditions. The test substance was weighed out in a volumetric flask, and the volume of the test substance was adjusted to 1 mL with addition of the medium. The prepared liquid was poured into a light-blocked airtight container (formed of glass).

TABLE 2

| | | Amount of test substance |
|---|---|---|
| | Concentration adjusted | weighed out |
| | (w/v %) | (g) |
| Test substance | 50.0 | 0.5 |

### <<Positive Control Substance>>

HCA was accurately weighed out in an amount of about 0.25 g, and adjusted to 1 mL with addition of the medium, to prepare a 25.0 w/v % liquid. The prepared liquid was poured into a light-blocked airtight container (formed of glass).

### <<BrdU>>

5-Bromo-2′-deoxyuridine (BrdU, obtained from Nacalai Tesque, Inc.) (200 mg) was accurately weighed out in a volumetric flask, and dissolved in saline (obtained from Otsuka Pharmaceutical Co., Ltd.) added in the flask by ultrasonic irradiation. Subsequently, the resultant was adjusted to a volume of 20 mL, to prepare a 10 mg/mL liquid (BrdU preparation liquid). The prepared liquid was sterilized by filtration through a sterilized filtration filter and poured into a sterilized container.

### <<Preparation Timing and Storage Period>>

The positive control substance preparation liquid was prepared on the day before the initiation of sensitization, and stored in a cool place at any time other than use. The medium and test substance preparation liquids were prepared on the day of sensitization of each. The BrdU liquid was prepared two days before administration, and stored in a cool place until the day of administration.

### [Sensitization and BrdU Administration]

### <<Sensitization>>

The preparation liquids of each test substance and the positive control substance, and the medium were each applied to both auricles of the animals by 25 microliters each. A micropipetter was used for the application. This treatment was performed once a day for three consecutive days.

### <<BrdU Administration>>

About 48 hours after the final sensitization, the BrdU preparation liquid was intraperitoneally administered once by 0.5 mL per animal.

### [Observation and Testing]

### <<General Conditions>>

All animals used for the test were observed once a day or more from the day of initiation of sensitization until the day of removing auricular lymph nodes (i.e., the day on which the animals were taken out from the rearing room). The observation days were counted in a manner that the day of initiation of sensitization was Day 1.

### <<Body Weight Measurement>>

The body weights were measured on the day of initiation of sensitization and the day of removing auricular lymph nodes (i.e., the day on which the animals were taken out from the rearing room). The average and the standard error of the body weights were calculated per group.

### <<Removal and Mass Measurement of Auricular Lymph Nodes>>

About 24 hours after the BrdU administration, the animals were subjected to euthanasia, and their auricular lymph nodes were removed. Surrounding tissues of the auricular lymph nodes were removed, and the auricular lymph nodes on both sides were collectively weighted. The average and the standard error of the weights of the auricular lymph nodes were calculated per group. After the mass measurement, the auricular lymph nodes were cryopreserved per individual in a biomedical freezer set to −20 degrees C.

### <<Measurement of BrdU Intake>>

After the auricular lymph nodes were returned to room temperature, the auricular lymph nodes were ground with addition of saline and suspended in the saline. The suspension was filtrated, and then dispensed into a 96-well microplate in 3 wells/individual, to measure the BrdU intake by ELISA method. As the reagent, a commercially available kit (CELL PROLIFERATION ELISA, BRDU COLORIMETRIC, Cat.No. 1647229, obtained from Roche Diagnostics Inc.) was used. The absorbance values (from OD 370 nm to OD 492 nm, BrdU intake) of each individual measured from 3 wells with a multi-plate reader (FLUOSTAR OPTIMA, obtained from BMG Labtech Inc.) were averaged as a BrdU measurement of each individual.

### [Result Evaluation]

### <<Calculation of Stimulation Index (SI)>>

As indicated by the formula below, the BrdU measurement of each individual was divided by the average BrdU measurement of the medium control group, to calculate the SI value of each individual. A result obtained by averaging the SI values of the individuals of each test group was used as the SI value of the test group. The SI values were rounded off at the second decimal place, and expressed to the first decimal place.

$$SI = \frac{\begin{matrix}Average BrdU measurement of \\ each individual ( average of 3 wells )\end{matrix}}{\begin{matrix}Average BrdU measurement of medium control \\ group ( average of 4 animals )\end{matrix}}$$

### <Constituent Components of Compositions>

Abbreviations, compound names, supplier names, and product names of the materials used for preparing the compositions are presented in Tables 3-1 to 3-3. Monomers (A1-1 to A1-7) serving as acrylamide compounds were synthesized by the methods described in Synthesis examples 1 to 7. The synthesized compounds were identified by nuclear magnetic resonance spectroscopy (instrument used: “JNM-ECX500” obtained from JEOL Ltd.), and the purity was measured by a gas chromatograph method (instrument used: “GCMS-QP2010 PLUS” obtained from Shimadzu Corporation). These chemical analyses were performed in routine manners.

Polymerization initiators C-1 to C-6 are water-insoluble, and polymerization initiators C-7 to C-9 are water-soluble.

TABLE 3-1

| | Abbreviation | Compound name or structure | Supplier and product names |
|---|---|---|---|
| Acrylamide compound (A1) | A1-1 | 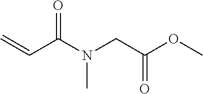 | (see Synthesis example 1) SI = 1.00 |
| | A1-2 | 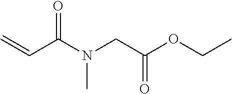 | (see Synthesis example 2) SI = 1.02 |
| | A1-3 | 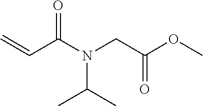 | (see Synthesis example 3) SI = 1.05 |
| | A1-4 | 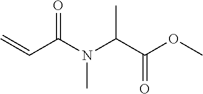 | (see Synthesis example 4) SI = 1.12 |
| | A1-5 | 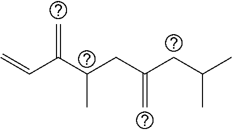 | (see Synthesis example 5) SI = 1.13 |
| | A1-6 | 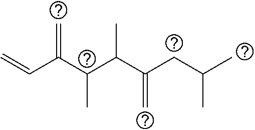 | (see Synthesis example 6) SI = 1.21 |
| | A1-7 | 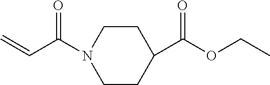 | (see Synthesis example 7) SI = 1.70 |
| | A1-8 | 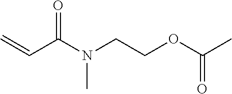 | (see Synthesis example 13) SI = 1.10 |
| Mono functional polymerizable compound (A2) other than A1 | A2-1 | 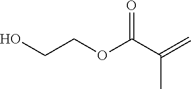 | Tokyo Chemical Industry Co., Ltd., “2-hydroxyethyl methacrylate” SI = 1.26 |
| | A2-2 | 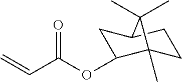 | Osaka Organic Chemical Industry Ltd., “Isobornyl acrylate”, SI = 8.30 |
| Bifunctional or higher polymerizable compound (B1) | B1-1 | 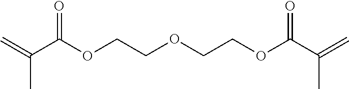 [SMILES: C=C(C)C(=O)OCCOCCOC(=O)C(=C)C] | Shin-Nakamura Chemical Co., Ltd., “2G”, SI = 1.05 |
| | B1-2 | 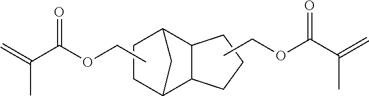 | Shin-Nakamura Chemical Co., Ltd., “DCP”, SI = 1.34 |
| | B1-3 | 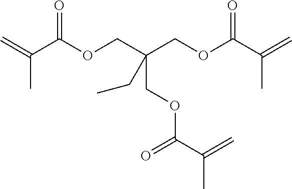 [SMILES: C=C(C)C(=O)OCC(CC)(COC(=O)C(=C)C)COC(=O)C(=C)C] | Shin-Nakamura Chemical Co., Ltd., “TMPT”, SI = 1.03 |
| | B1-4 | 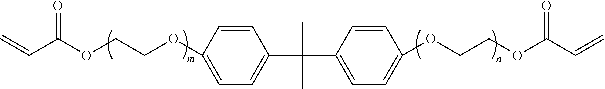 m + n = 10 | Shin-Nakamura Chemical Co., Ltd., “A-BPE-10”, SI = 1.24 |
| | B1-5 | 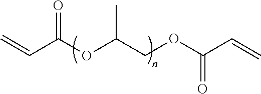 n = 12 | Shin-Nakamura Chemical Co., Ltd., “APG-700”, SI = 1.15 |
| | B1-6 | 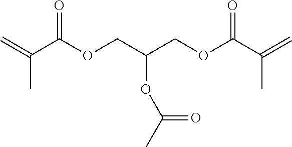 [SMILES: C=C(C)C(=O)OCC(COC(=O)C(=C)C)OC(C)=O] | (see Synthesis example 8) SI = 1.40 |
| | B1-7 | 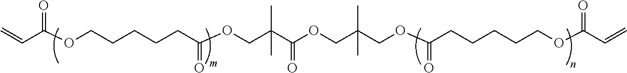 | Nippon Kayaku Co., Ltd., “HX-620”, SI = 0.92 |
| | B1-8 | 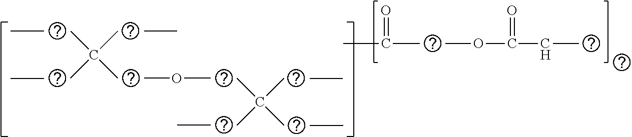 | Nippon Kayaku Co., Ltd., “DPCA-60”, SI = 1.40 |

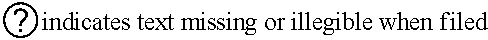

TABLE 3-2

| | | | Supplier and |
|---|---|---|---|
| | Abbreviation | Compound name or structure | product names |
| Bifunctional or higher acrylamide compound (B2) | B2-1 | 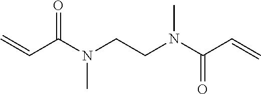 | (see Synthesis example 9) SI = 1.20 |
| | B2-2 | 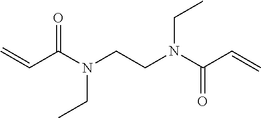 [SMILES: C=CC(=O)N(CC)CCN(CC)C(=O)C=C] | (see Synthesis example 10) SI = 1.33 |
| | B2-3 | 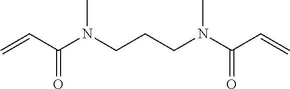 | (see Synthesis example 11) SI = 1.45 |
| | B2-4 | 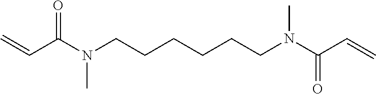 [SMILES: C=CC(=O)N(C)CCCCCCN(C)C(=O)C=C] | (see Synthesis example 12) SI = 1.58 |
| | B2-5 | 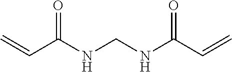 | Tokyo Chemical Industry Co., Ltd., (product No. M2877), SI = 1.08 |
| | B2-6 | 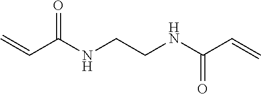 | Tokyo Chemical Industry Co., Ltd., (product No. E1086), SI = 1.23 |
| | B2-7 | 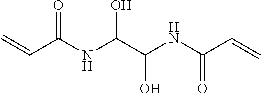 | Tokyo Chemical Industry Co., Ltd., (product No. D2864), SI = 1.01 |
| | B2-8 | 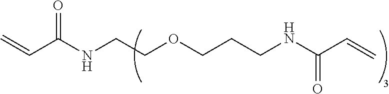 | FUJIFILM Corporation, FOM-03006, SI = 1.07 |
| | B2-9 | 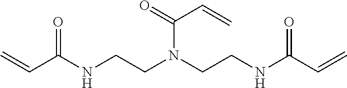 [SMILES: C=CC(=O)NCCN(CCNC(=O)C=C)C(=O)C=C] | FUJIFILM Corporation, FOM-03007, SI = 1.44 |
| | B2-10 | 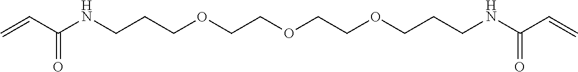 [SMILES: C=CC(=O)NCCCOCCOCCOCCCNC(=O)C=C] | FUJIFILM Corporation, FOM-03008, SI = 1.24 |
| | B2-11 | 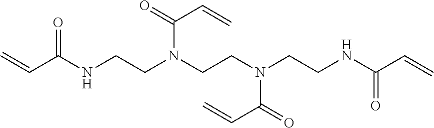 [SMILES: C=CC(=O)NCCN(CCN(CCNC(=O)C=C)C(=O)C=C)C(=O)C=C] | FUJIFILM Corporation, FOM-03009, SI = 1.52 |

TABLE 3-3

| | Abbreviation | Compound name or structure | Supplier and product names |
|---|---|---|---|
| Polymerization initiator (C) | C-1 | 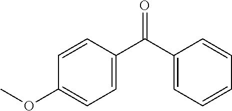 [SMILES: COc1ccc(C(=O)c2ccccc2)cc1] | Tokyo Chemical Industry Co., Ltd., “Methoxybenzophenone” |
| | C-2 | 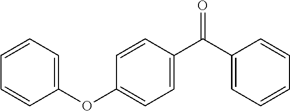 [SMILES: O=C(c1ccccc1)c1ccc(Oc2ccccc2)cc1] | Tokyo Chemical Industry Co., Ltd., “4-Benzyloxybenzophenone” |
| | C-3 | 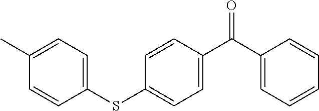 [SMILES: Cc1ccc(Sc2ccc(C(=O)c3ccccc3)cc2)cc1] | Tokyo Chemical Industry Co., Ltd., “4-Benzoyl 4′-methyldiphenyl sulfide (BMS)” |
| | C-4 | 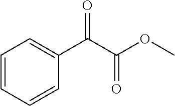 | Tokyo Chemical Industry Co., Ltd., “Methyl benzoyl formate” |
| | C-5 | Bis(2,4,6,-trimethylbenzoyl)phenyl phosphine oxide | BASF Japan Ltd. “IRGACURE 819” |
| | C-6 | 2,4,6-Trimethylbenzoyl-diphenyl-phosphine oxide | BASF Japan Ltd. “IRGACURE TPO” |
| | C-7 | 2-Hydroxy-4′-(2-hydroxyethoxy)-2-methyl propiophenone | BASF Japan Ltd. “IRGACURE 2959” |
| | C-8 | Thioxanthone ammonium salt | Shell Chemicals Co., Ltd., “QUANTACURE QTX” |
| | C-9 | Benzophenone ammonium salt | Shell Chemicals Co., Ltd., “QUANTACURE ABQ” |
| Hydrogen donor (D) | D-1 | 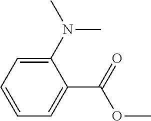 | Tokyo Chemical Industry Co., Ltd., “Methyl N,N-dimethyl anthranilate” |
| | D-2 | 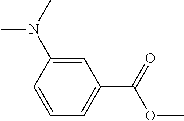 | Tokyo Chemical Industry Co., Ltd., “Methyl m-dimethylaminobenzoate” |
| | D-3 | 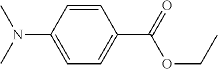 | Tokyo Chemical Industry Co., Ltd., “Ethyl p-dimethylaminobenzoate” |
| | D-4 | 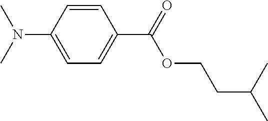 [SMILES: CC(C)CCOC(=O)c1ccc(N(C)C)cc1] | Tokyo Chemical Industry Co., Ltd., “Isoamyl p-dimethylaminobenzoate” |
| | D-5 | 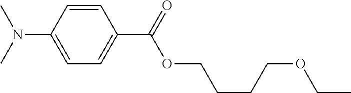 [SMILES: CCOCCCCOC(=O)c1ccc(N(C)C)cc1] | Tokyo Chemical Industry Co., Ltd., “p-Dimethylaminobenzoic acid (2-butoxyethyl)” |
| | D-6 | 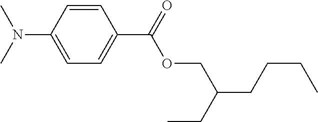 [SMILES: CCCCC(CC)COC(=O)c1ccc(N(C)C)cc1] | IGM Resins B.V., “p-Dimethylaminobenzoic acid (2-ethylhexyl)” |
| | D-7 | 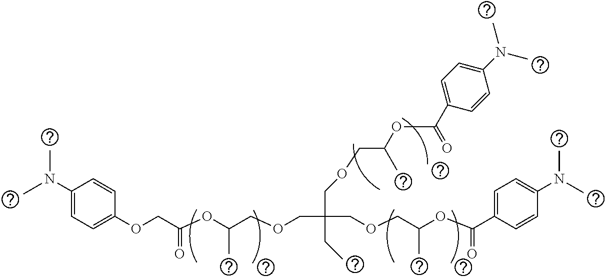 | Lambson Ltd., “SPEEDCURE 7040” |

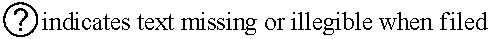

TABLE 3-4

| | | Compound name or | |
|---|---|---|---|
| | Abbreviation | structure | Supplier and product names |
| Polymerization | E-1 | LAROMER UA8983 | BASF GmbH, D50 = 22.6 nm |
| initiator (C) | E-2 | UCECOAT 7571 | Daicel-Allnex Ltd., D50 = 34.5 nm |
| | E-3 | UCECOAT 7849 | Daicel-Allnex Ltd., D50 = 26.2 nm |
| | E-4 | UCECOAT 7788 | Daicel-Allnex Ltd., D50 = 70.7 nm |
| | E-5 | UCECOAT 7200 | Daicel-Allnex Ltd., D50 = 654 nm |
| Urethane | | UX3945 | Sanyo Chemical Industries, Ltd. |
| emulsion | | | |
| pH adjustor | F-1 | Triethylamine | Tokyo Chemical Industry Co., Ltd., (product No. T0424), |
| (F) | | | molecular weight: 101.2, boiling point: 90 degrees C. |
| | F-2 | Dimethylaminoethanol | Tokyo Chemical Industry Co., Ltd., (product No. D0649), |
| | | | molecular weight: 89.1, boiling point: 161 degrees C. |
| | F-3 | 2-Amino-2-methyl-1- | Tokyo Chemical Industry Co., Ltd., (product No. A0333), |
| | | propanol | molecular weight: 89.1, boiling point: 165 degrees C. |
| | F-4 | 2-Amino-2-ethyl-1.3- | Tokyo Chemical Industry Co., Ltd., (product No. A0620), |
| | | propanediol | molecular weight: 119.2, boiling point: 273 degrees C. |
| Solvent (G) | G-1 | 1,2-Propanediol | Tokyo Chemical Industry Co., Ltd., (product No. P0485) |
| | G-2 | 1,3-Butanediol | Tokyo Chemical Industry Co., Ltd., (product No. B3770) |
| | G-3 | Glycerin | Tokyo Chemical Industry Co., Ltd., (product No. D2864) |
| Other | Polymerization | 4-Methoxyphenol | Seiko Chemical Co., Ltd., “METHOQUINONE” |
| components | inhibitor | | |
| | Surfactant | SURFYNOL 440 | Nissin Chemical Co., Ltd. |

[Synthesis examples of acrylamide compounds (A1), bifunctional or higher polymerizable compound (B1), and bifunctional or higher acrylamide compounds (B2)]

Synthesis examples of the acrylamide compounds (A1) of A1-1 to A1-8 presented in Table 3-1 above, the bifunctional or higher polymerizable compound (B1) of B1-6 presented in Table 3-1 above, and the bifunctional or higher acrylamide compounds (B2) of B2-1 to B2-4 presented in Table 3-2 above will be described below.

The acrylamide compounds A1-1 to A1-8 correspond to the example compounds d1-1, d1-2, d4-1, g1-1, d1-5, g1-5, i1-2, and a1-1 respectively, and the bifunctional or higher acrylamide compounds B2-1 to B2-4 correspond to the example compounds a-1, a-2, b-1, and e-1 respectively.

### Synthesis Example 1

### Synthesis of N-acryloyl-N-methylglycinemethyl ester (A1-1)

N-Methylglycine (0.30 moles) and methanol 8400 mL) were stirred and mixed at from 0 degrees C. through 10 degrees C., and with the temperature maintained, thionyl chloride (0.33 moles) was slowly dropped into the resultant. After dropping was completed, methanol was evaporated from the resultant at reduced pressure at from 40 degrees C. through 60 degrees C., to obtain N-methylglycinemethyl ester hydrochloride (0.30 moles) as a white solid. In the resultant, potassium carbonate (obtained from Kanto Chemical Co., Inc., reagent) (0.45 moles) and water (400 mL) were stirred and mixed at from 0 degrees C. through 10 degrees C. With the temperature maintained, acrylic acid chloride (obtained from Wako Pure Chemical Industry Co., Ltd., reagent) (0.33 moles) was slowly dropped into the resultant. After dropping was completed, the resultant was extracted three times with ethyl acetate (obtained from Kanto Chemical Co., Inc., reagent) (400 mL), and washed once with water (400 mL) together with the ethyl acetate layer. Ethyl acetate was evaporated at reduced pressure at 40 degrees C., to obtain intended N-acryloyl-N-methylglycinemethyl ester (A1-1) (0.20 moles) as an almost colorless, clear liquid. The purity was 98.3% by mass.

N-Acryloyl-N-methylglycinemethyl ester (A1-1) had a molecular weight of 157.2, and was a known compound (CAS Registration No. 72065-23-7).

As a safety test, AMES test was performed according to OECD test guideline TG471 (±S9 mix), and the result was negative. Oral toxicity was tested according to OECD test guideline TG423. As a result, none of six cases was a fatal case, and LD50 was 2,000 mg/kg or higher. Skin stimulation was tested according to OECD test guideline TG404, and the result was PII=0.5. Skin sensitizing potential was tested according to OECD test guideline TG442B. As a result, the SI value turned out to be 1.00, and the compound was found to be significantly uninfluential on the health of human bodies.

### Synthesis Example 2

### Synthesis of N-acryloyl-N-methylglycineethyl ester (A1-2)

Intended N-acryloyl-N-methylglycineethyl ester (A1-2) (0.22 moles) was obtained as an almost colorless, clear liquid in the same manner as in Synthesis example 1, except that unlike in Synthesis example 1, N-methylglycinemethyl ester hydrochloride was changed to N-methylglycineethyl ester hydrochloride (obtained from Tokyo Chemical Industry Co., Ltd., reagent). The purity was 98.5 parts by mass.

N-Acryloyl-N-methylglycineethyl ester (A1-2) had a molecular weight of 171.2, and was a known compound (CAS Registration No. 170116-05-9).

### Synthesis Example 3

### Synthesis of N-acryloyl-N-isopropylglycinemethyl ester (A1-3)

Intended N-acryloyl-N-isopropylglycinemethyl ester (A1-3) (0.22 moles) was obtained as an almost colorless, clear liquid in the same manner as in Synthesis example 1, except that unlike in Synthesis example 1, N-methylglycinemethyl ester hydrochloride was changed to N-isopropylglycinemethyl ester hydrochloride (obtained from Tokyo Chemical Industry Co., Ltd., reagent). The purity was 98.5% by mass.

N-acryloyl-N-isopropylglycinemethyl ester (A1-3) had a molecular weight of 185.2.

### Synthesis Example 4

### Synthesis of N-acryloyl-N-methylalaninemethyl ester (A1-4)

Intended N-acryloyl-N-methylalaninemethyl ester (A1-4) (0.22 moles) was obtained as an almost colorless, clear liquid in the same manner as in Synthesis example 1, except that unlike in Synthesis example 1, N-methylglycinemethyl ester hydrochloride was changed to N-methylalaninemethyl ester hydrochloride (obtained from Tokyo Chemical Industry Co., Ltd., reagent). The purity was 98.5% by mass.

N-Acryloyl-N-methylalaninemethyl ester (A1-4) had a molecular weight of 171.2.

### Synthesis Example 5

### Synthesis of N-acryloyl-N-methylglycineisopropyl ester (A1-5)

Intended N-acryloyl-N-methylglycineisopropyl ester (A1-5) (0.22 moles) was obtained as an almost colorless, clear liquid in the same manner as in Synthesis example 1, except that unlike in Synthesis example 1, N-methylglycinemethyl ester hydrochloride was changed to N-methylglycineisopropyl ester hydrochloride (obtained from Tokyo Chemical Industry Co., Ltd., reagent). The purity was 98.5% by mass.

N-Acryloyl-N-methylglycineisopropyl ester (A1-5) had a molecular weight of 185.2.

### Synthesis Example 6

### Synthesis of N-acryloyl-N-methylalanineisopropyl ester (A1-6)

Intended N-acryloyl-N-methylalanineisopropyl ester (A1-6) (0.22 moles) was obtained as an almost colorless, clear liquid in the same manner as in Synthesis example 1, except that unlike in Synthesis example 1, N-methylglycinemethyl ester hydrochloride was changed to N-methylalanineisopropyl ester hydrochloride (obtained from Tokyo Chemical Industry Co., Ltd., reagent). The purity was 98.5% by mass.

N-Acryloyl-N-methylalanineisopropyl ester (A1-6) had a molecular weight of 199.3.

### Synthesis Example 7

### Synthesis of ethyl N-acryloylpiperidine-4-carboxylate (A1-7)

Intended ethyl N-acryloylpiperidine-4-carboxylate (A1-7) (0.27 moles) was obtained as an almost colorless, clear liquid in the same manner as in Synthesis example 1, except that unlike in Synthesis example 1, N-methylglycinemethyl ester hydrochloride was changed to ethyl piperidine-4-carboxylate (obtained from Tokyo Chemical Industry Co., Ltd., reagent). The purity was 99.2% by mass.

Ethyl N-acryloylpiperidine-4-carboxylate (A1-7) had a molecular weight of 211.3, and was a known compound (CAS Registration No. 845907-79-1).

### Synthesis Example 8

### Synthesis of 2-acetyl-1,3-glycerol dimethacrylate (B1-6)

1,3-Glycerol dimethacrylate obtained from Tokyo Chemical Industry Co., Ltd. (57.1 g) (250 mmol) was added in dehydrated dichloromethane (1,000 mL). After the flask was purged with an argon gas, triethylamine (36.0 g) (360 mmol) was added. Next, after the resultant was cooled to about −10 degrees C., acetic acid chloride (24.0 g) (300 mmol) was slowly dropped into the resultant in a manner that the temperature in the system would be from −10 degrees C. through −5 degrees C., and the resultant was stirred at room temperature for 2 hours. Then, after a precipitate was removed by filtration, the filtrate was washed with water, a saturated sodium bicarbonate aqueous solution, and a saturated sodium chloride aqueous solution. Next, the resultant was dried with sodium sulfate, and concentrated at reduced pressure, to obtain a yellow oily matter. Then, the yellow oily matter was purified by column chromatography in which columns were filled with WAKOGEL C300 (obtained from Wako Pure Chemical Industry Co., Ltd.) (2,000 g) and hexane and ethyl acetate were used as eluates, to obtain a colorless oily matter (18.0 g) of 2-acetyl-1,3-glycerol dimethacrylate (B1-6) (at a yield of about 28%). The purity was 99.1% by mass.

### Synthesis of compound B2-1

### Synthesis Example 9

N,N′-Dimethylethylene diamine obtained from Tokyo Chemical Industry Co., Ltd. (9.12 g, 103 mmol) was dissolved in ethyl acetate (80 ml), and an aqueous solution of potassium carbonate (31.37 g, 227 mmol) in water (60 ml) was added in the resultant. In an ice bath, the resultant was cooled to 5 degrees C., and acrylic acid chloride (20.54 g, 227 mmol) was slowly dropped and stirred in the resultant at room temperature for 2 hours. Ethyl acetate layer and water layer were separated from each other, and the water layer was extracted twice with ethyl acetate (50 ml). The ethyl acetate layer was washed with a saturated sodium chloride aqueous solution, dried with sodium sulfate, and then concentrated at reduced pressure, to obtain a colorless oily matter (5.8 g) of the compound (B2-1) (at a yield of about 29%). The identification data are as follows: ¹H-NMR (CDCl₃): δ3.06/3.07 (d, 6H), 3.54-3.56/3.61-3.64 (m, 4H), 5.65-5.74 (m, 2H), 6.25-6.38 (m, 2H), 6.48-6.67 (m, 2H)

### Synthesis of compound B2-2

### Synthesis Example 10

N,N′-Diethylethylene diamine obtained from Tokyo Chemical Industry Co., Ltd. (8.24 g, 71 mmol) was dissolved in ethyl acetate (80 ml), and an aqueous solution of potassium carbonate (21.59 g, 156 mmol) in water (60 ml) was added in the resultant. In an ice bath, the resultant was cooled to 5 degrees C., and acrylic acid chloride (14.10 g, 156 mmol) was slowly dropped and stirred in the resultant at room temperature for 2 hours. Ethyl acetate layer and water layer were separated from each other, and the water layer was extracted twice with ethyl acetate (50 ml). The ethyl acetate layer was washed with a saturated sodium chloride aqueous solution, dried with sodium sulfate, and then concentrated at reduced pressure, to obtain a colorless oily matter (13.1 g) of the compound (B2-2) (at a yield of about 94%).

The identification data are as follows: ¹H-NMR (CDCl₃): δ1.15-1.21 (m, 6H), 3.40-3.57 (m, 8H), 5.66-5.73 (m, 2H), 6.32-6.38 (m, 2H), 6.47-6.73 (m, 2H)

### Synthesis of Compound B2-3

### Synthesis Example 11

N,N-Dimethyl-1,3-propanediamine obtained from Tokyo Chemical Industry Co., Ltd. (10.4 g, 102 mmol) was dissolved in ethyl acetate (80 ml), and an aqueous solution of potassium carbonate (30.96 g, 224 mmol) in water (60 ml) was added in the resultant. In an ice bath, the resultant was cooled to 5 degrees C., and acrylic acid chloride (20.3 g, 224 mmol) was slowly dropped and stirred in the resultant at room temperature for 2 hours. Ethyl acetate layer and water layer were separated from each other, and the water layer was extracted twice with ethyl acetate (50 ml). The ethyl acetate layer was washed with a saturated sodium chloride aqueous solution, dried with sodium sulfate, and then concentrated at reduced pressure, to obtain a colorless oily matter (6.3 g) of the compound (B2-3) (at a yield of about 29%).

The identification data are as follows: ¹H-NMR (CDCl₃): δ1.83-1.89 (m, 2H), 3.01/3.09 (d, 6H), 3.40/3.46 (t, 4H), 5.67-5.74 (m, 2H), 6.29-6.37 (m, 2H), 6.49-6.61 (m, 2H)

### Synthesis of compound B2-4

### Synthesis Example 12

N,N-Dimethyl-1,6-propanediamine obtained from Tokyo Chemical Industry Co., Ltd. (7.21 g, 50 mmol) was dissolved in ethyl acetate (80 ml), and an aqueous solution of potassium carbonate (15.80 g, 110 mmol) in water (60 ml) was added in the resultant. In an ice bath, the resultant was cooled to 5 degrees C., and acrylic acid chloride (9.96 g, 110 mmol) was slowly dropped and stirred in the resultant at room temperature for 2 hours. Ethyl acetate layer and water layer were separated from each other, and the water layer was extracted twice with ethyl acetate (50 ml). The ethyl acetate layer was washed with a saturated sodium chloride aqueous solution, dried with sodium sulfate, and then concentrated at reduced pressure, to obtain a colorless oily matter (5.82 g) of the compound (B2-4) (at a yield of about 46%).

The identification data are as follows: ¹H-NMR (CDCl₃): δ1.34 (bs, 4H), 1.59 (bs, 4H), 2.99/3.05 (d, 6H), 3.32-3.62/3.40-3.44 (b, 4H), 5.64-5.70 (b, 2H), 6.28-6.36 (m, 2H), 6.53-6.62 (m, 2H)

### Synthesis of Compound A1-8

### Synthesis Example 13

N-Methyl-2-hydroxyethyl acrylamide obtained from ABC Laboratory Scientific Co., Ltd. (100 g, 77 mmol) was dissolved in ethyl acetate (800 ml). In an ice bath, the resultant was cooled to 5 degrees C., and acetyl chloride (65.1 g, 83 mmol) was slowly dropped and stirred in the resultant at room temperature for 2 hours. The reaction liquid was poured into water (500 g), ethyl acetate layer and water layer were separated from each other, and the water layer was extracted twice with ethyl acetate (500 ml). The ethyl acetate layer was washed with a saturated sodium chloride aqueous solution, dried with sodium sulfate, and concentrated at reduced pressure, to obtain a colorless oily matter (114 g) of the compound (A1-8) (at a yield of about 86%).

N-(2-Acetyloxyethyl)-N-methyl acrylamide (A1-8) had a molecular weight of 171.2, and was a known compound (CAS Registration No. 17225-73-9).

### (Pigment Dispersion Preparation Example)

A mixture according the prescription described below was premixed, then subjected to circular dispersion treatment for 2 hours using a disk-type bead mill (obtained from Shinmaru Enterprises Corporation, KDL type, using zirconia balls having a diameter of 2.0 mm as media) at a peripheral velocity of 75 rpm, and then filtrated through a membrane filter having an average pore diameter of 1.2 micrometers, to obtain a pigment dispersion 1.

### [Prescription of Mixture]

Carbon black (NIPEX 160, obtained from Degussa AG): 16.0 parts by mass
DISPERBYK-2012 (obtained from Byk-Chemie GmbH): 3.2 parts by mass
Pure water: 80.8 parts by mass

### Example 1

### —Preparation of Active-Energy-Ray-Curable Aqueous Composition—

Water-soluble organic solvents (humectants) (G-1 to G-3) presented in Table 4 below and water were mixed, and stirred for 1 hour to a uniformly mixed state. Polymerizable materials (A1-1, A1-7, B2-1, and B2-2) were added to the resultant and stirred for 1 hour. The pigment dispersion liquid, the polymerization initiator (C-7), the hydrogen donor (D-1), and a dispersion containing urethane resin particles having a polymerizable group (E-1), a surfactant, a pH adjustor (F-1), and a polymerization inhibitor were added to the resultant and stirred for 1 hour. The resultant dispersion liquid was subjected to pressure filtration through a polyvinylidene fluoride membrane filter having an average pore diameter of 5.0 micrometers to remove coarse particles and dust, to produce an active-energy-ray-curable aqueous composition of Example 1.

### Examples 2 to 40 and Comparative Examples 1 to 11

### —Preparation of Active-Energy-Ray-Curable Aqueous Composition—

Active-energy-ray-curable aqueous compositions of Examples 2 to 40 and Comparative Examples 1 to 11 were obtained in the same manner as in Example 1, except that unlike in Example 1, the compositions were changed to as presented in Table 4 to Table 8.

Next, “scratch resistance”, “discharging stability”, and “storage stability” of the obtained active-energy-ray-curable aqueous compositions of Examples 1 to 40 and Comparative Examples 1 to 11 were measured and evaluated in the manners described below. The results are presented in Table 4 to Table 8.

### <Scratch Resistance>

By varying the driving voltage of a piezo element under environmental conditions adjusted to 23±0.5 degrees C. and 50±5% RH, an inkjet printing apparatus (TPSTO GXE-5500, obtained from Ricoh Company, Ltd.) was set in a manner that inks would be applied constantly in the same amount over a commercially available PET film (with a film thickness of 100 micrometers).

Next, the print mode of the inkjet printing apparatus was set to “plain paper clean”, and a solid image chart having a size of 5 cm×20 cm was printed. After the solid image chart was printed, the inkjet ink was dried by hot air blowing for 30 seconds from a distance of 20 cm using a heat gun (PJ-206A1) over a hot plate heated to 120 degrees C., and subsequently irradiated with light of a cumulative amount of 500 mi/cm² in a wavelength range corresponding to the UV-A range (a wavelength range of 350 nm or longer but 400 nm or shorter) using a UV-LED, to cure the inkjet ink and form a coating film (cured product) having an average thickness of 2 micrometers.

Next, the produced cured product and standard adjacent fabric for test (shirting No. 3) compliant with JIS L 0803 were set in a rubbing fastness tester RT-300 (obtained from Daiei Kagaku Seiki MFG. Co., Ltd., an instrument compliant with a rubbing tester Type II (Gakushin-Type) specified in dyed color fastness test method (JIS L-0849)), and a loading weight (500 g) was also set in the tester. Then, the cured product was reciprocally rubbed a hundred times. The carbon black density on the cotton fabric after the test was measured with EXACT SCAN (obtained from X-Rite Inc.), and the density difference with respect to an untested cotton fabric was evaluated. The measurement was evaluated according to the evaluation criteria described below.

### [Evaluation Criteria]

A: 0.02 or less

B: Greater than 0.02 but 0.1 or less

C: Greater than 0.1 but 0.2 or less

D: Greater than 0.2

### <Discharging Stability>

A piezo-type inkjet head in which an ink in a portion from the ink supplying system to the head portion was temperature-adjustable was used as an inkjet printing apparatus. The active-energy-ray-curable aqueous composition of each of Examples 1 to 40 and Comparative Examples 1 to 11 was filled in the inkjet printing apparatus, and adjusted to a temperature at which the viscosity would be 10 mPa·s, to evaluate initial dischargeability at a discharging speed of 3 kHz. The active-energy-ray-curable aqueous composition was discharged continuously for 60 minutes. Sixty minutes later, dischargeability was evaluated according to the evaluation criteria described below (initial dischargeability).

Using a temperature-adjustable cone plate rotary viscometer, a temperature condition at which the ink viscosity would be 10.0±0.5 mPa·s was explored, and used as the heating condition for printing.

### [Evaluation Criteria]

A: The active-energy-ray-curable aqueous composition was discharged normally from 95% or more of the nozzles.

B: The active-energy-ray-curable aqueous composition was discharged normally from 90% or more of the nozzles.

C: The active-energy-ray-curable aqueous composition was discharged normally from 70% or more of the nozzles.

D: The active-energy-ray-curable aqueous composition was discharged normally from less than 70% of the nozzles.

### <Storage Stability>

The viscosity of the active-energy-ray-curable aqueous compositions of Examples 1 to 40 and Comparative Examples 1 to 11 was measured after preparation. The active-energy-ray-curable aqueous compositions were poured into a container made of polyethylene, tightly closed, and stored at 60 degrees C. for 2 weeks. Subsequently, the viscosity was measured again. The absolute value of the difference between the viscosity after storage and the viscosity before storage was divided by the viscosity before storage, to calculate a change ratio, which was evaluated according to the evaluation criteria described below. The viscosity was measured with a viscometer (RL-500, obtained from TOKI SNGYO CO., LTD.)

at 25 degrees C.

### [Evaluation Criteria]

A: Lower than 5%

B: 5% or higher but lower than 10%

C: 10% or higher but lower than 20%

D: 20% or higher

### <Skin Sensitizing Potential>

The stimulation index (SI) value of the compositions produced by the method described above was measured by a LLNA method stipulated by, for example, OECD Test Guideline 429, and evaluated according to the evaluation criteria described below. The results are presented in Table 4 to Table 8. The ratings B and A are practically usable levels.

### [Evaluation Criteria]

A: The SI value was lower than 1.6.

B: The SI value was 1.6 or higher but 3 or lower.

C: The SI value was higher than 3 but lower than 6.

D: The SI value was 6 or higher.

TABLE 4

| | | | Ex. | | | | | | | | | |
|---|---|---|---|---|---|---|---|---|---|---|---|---|
| | | | 1 | 2 | 3 | 4 | 5 | 6 | 7 | 8 | 9 | 10 |
| Acrylamide compound (A1) | | A1-1 | 15.0 | 15.0 | 15.0 | | | | | | | 10.0 |
| | | A1-2 | | | | 15.0 | 15.0 | 15.0 | | | | |
| | | A1-3 | | | | | | | 15.0 | | | |
| | | A1-4 | | | | | | | | 10.0 | | |
| | | A1-5 | | | | | | | | | 10.0 | |
| | | A1-6 | | | | 5.0 | 5.0 | 5.0 | | | | 20.0 |
| | | A1-7 | 5.0 | 5.0 | 5.0 | | | | | | | |
| | | A1-8 | | | | | | | | | | |
| Monofunctional polymerizable | | A2-1 | | | | | | | | | | |
| compound (A2) other than A1 | | A2-2 | | | | | | | | | | |
| Bifunctional | Bifunctional or | B1-1 | | | | | | | | | | |
| or higher | higher | B1-2 | | | | | | | | | | |
| polymerizable | polymerizable | B1-3 | | | | | | | | | | |
| compound | compound (B1) | B1-4 | | | | | | | | | | |
| (B1) | other than B2 | B1-5 | | | | | | | | | | |
| | | B1-6 | | | | | | | | | | |
| | | B1-7 | | | | | | | | | | |
| | | B1-8 | | | | | | | | | | |
| | Bifunctional or | B2-1 | 10.0 | 10.0 | 10.0 | 10.0 | 10.0 | 10.0 | | | | |
| | higher | B2-2 | 10.0 | 10.0 | 10.0 | | | | 10.0 | 10.0 | | |
| | acrylamide | B2-3 | | | | 10.0 | | | | | 10.0 | 10.0 |
| | compound (B2) | B2-4 | | | | | 10.0 | 10.0 | 10.0 | 10.0 | 10.0 | 10.0 |

| | B2-5 | | | | | | | | | | |
|---|---|---|---|---|---|---|---|---|---|---|---|
| | B2-6 | | | | | | | | | | |
| | B2-7 | | | | | | | | | | |
| | B2-8 | | | | | | | | | | |
| | B2-9 | | | | | | | | | | |
| | B2-10 | | | | | | | | | | |
| | B2-11 | | | | | | | | | | |
| Polymerization initiator (C) | C1-1 | | | | | | | | | | |
| | C1-2 | | | | | | | | | | |
| | C1-3 | | | | | | | | | | |
| | C1-4 | | | | | | | | | | |
| | C1-5 | | | | | | | | | | |
| | C1-6 | | | | | | | | | | |
| | C1-7 | 3.0 | 3.0 | 3.0 | | | | | | | |
| | C1-8 | | | | 3.0 | 3.0 | 3.0 | | | | |
| | C1-9 | | | | | | | 3.0 | 3.0 | 3.0 | 3.0 |
| Hydrogen donor (D) | D-1 | 3.0 | 3.0 | 3.0 | | | | | | | |
| | D-2 | | | | 3.0 | 3.0 | 3.0 | | | | |
| | D-3 | | | | | | | | | | |
| | D-4 | | | | | | | 3.0 | 3.0 | | |
| | D-5 | | | | | | | | | | |
| | D-6 | | | | | | | | | | |
| | D-7 | | | | | | | | | 3.0 | 3.0 |
| Dispersion containing | E-1 | 5.0 | | | 5.0 | | | | | | |
| urethane resin particles | E-2 | | 5.0 | | | 5.0 | | | | | |
| having polymerizable | E-3 | | | 5.0 | | | 5.0 | | | | |
| group (E) | E-4 | | | | | | | | | | |
| | E-5 | | | | | | | | | | |
| pH adjustor (F) | F-1 | 0.2 | 0.2 | 0.2 | | | | | | | |
| | F-2 | | | | | | 0.2 | 0.2 | 0.2 | 0.2 | 0.2 |
| | F-3 | | | | | | | | | | |
| | F-4 | | | | 0.2 | 0.2 | | | | | |
| Solvent (G) | G-1 | 5.0 | 10.0 | | 10.0 | 5.0 | 5.0 | 7.0 | 6.0 | 5.0 | 10.0 |
| | G-2 | 5.0 | | 10.0 | | 5.0 | 5.0 | 7.0 | 4.0 | 5.0 | 5.0 |
| | G-3 | 5.0 | 5.0 | 5.0 | 10.0 | 5.0 | 5.0 | | 8.0 | 5.0 | |
| Urethane emulsion | | | | | | | | | | | |
| Pigment dispersion | | 5.0 | 5.0 | 5.0 | 5.0 | 5.0 | 5.0 | 5.0 | 5.0 | 5.0 | 5.0 |
| Water | | 28.2 | 28.2 | 28.2 | 23.2 | 28.2 | 28.2 | 39.2 | 40.2 | 43.2 | 23.2 |
| Polymerization inhibitor | | 0.1 | 0.1 | 0.1 | 0.1 | 0.1 | 2.1 | 0.1 | 0.1 | 0.1 | 0.1 |
| Surfactant | | 0.5 | 0.5 | 0.5 | 0.5 | 0.5 | 0.5 | 0.5 | 0.5 | 0.5 | 0.5 |
| Total of the above components | | 100.0 | 100.0 | 100.0 | 100.0 | 100.0 | 100.0 | 100.0 | 100.0 | 100.0 | 100.0 |
| Evaluation | Scratch resistance | A | A | A | A | A | A | B | B | B | B |
| | Discharging stability | A | A | A | A | A | A | A | A | A | A |
| | Storage stability | A | A | A | A | A | A | A | A | A | A |
| | Skin sensitizing potential | A | A | A | A | A | A | A | A | A | A |

TABLE 5

| | | | Ex. | | | | | | | | | |
|---|---|---|---|---|---|---|---|---|---|---|---|---|
| | | | 11 | 12 | 13 | 14 | 15 | 16 | 17 | 18 | 19 | 20 |
| Acrylamide compound (A1) | | A1-1 | 10.0 | 10.0 | 10.0 | | | | | | | 10.0 |
| | | A1-2 | | | | 5.0 | 5.0 | 5.0 | | | | |
| | | A1-3 | | | | | | | 10.0 | | | |
| | | A1-4 | | | | | | | | 5.0 | | |
| | | A1-5 | | | | | | | | | 5.0 | |
| | | A1-6 | | | | 5.0 | 5.0 | 5.0 | | | | 15.0 |
| | | A1-7 | 5.0 | 5.0 | 5.0 | | | | | | | |
| | | A1-8 | | | | | | | | | | |
| Monofunctional polymerizable | | A2-1 | | | | | | | | | | |
| compound (A2) other than A1 | | A2-2 | | | | | | | | | | |
| Bifunctional | Bifunctional or | B1-1 | 2.0 | | | | | | | | | |
| or higher | higher | B1-2 | 2.0 | 2.0 | 2.0 | | | | | | | |
| polymerizable | polymerizable | B1-3 | 1.0 | 2.0 | 1.0 | | | | | | | |
| compound | compound (B1) | B1-4 | | 1.0 | 2.0 | | | | | | | |
| (B1) | other than B2 | B1-5 | | | | | | | | | | |
| | | B1-6 | | | | | | | | | | |
| | | B1-7 | | | | | | | | | | |
| | | B1-8 | | | | | | | | | | |
| | Bifunctional or | B2-1 | 10.0 | 10.0 | 10.0 | 10.0 | 10.0 | 10.0 | | | | |
| | higher acrylamide | B2-2 | 10.0 | 10.0 | 10.0 | | | | 10.0 | 10.0 | | |
| | compound (B2) | B2-3 | | | | 10.0 | | | | | 10.0 | 10.0 |

| | B2-4 | | | | | 10.0 | 10.0 | 10.0 | 10.0 | 10.0 | 10.0 |
|---|---|---|---|---|---|---|---|---|---|---|---|
| | B2-5 | | | | 5.0 | | | | | | |
| | B2-6 | | | | | 5.0 | | | | | |
| | B2-7 | | | | | | 5.0 | | | | |
| | B2-8 | | | | | | | 5.0 | | | |
| | B2-9 | | | | | | | | 5.0 | | |
| | B2-10 | | | | | | | | | 5.0 | |
| | B2-11 | | | | | | | | | | 5.0 |
| Polymerization initiator (C) | C1-1 | 1.0 | | | | | | 1.0 | 1.0 | 1.0 | 1.0 |
| | C1-2 | | 1.0 | | | | | | | | |
| | C1-3 | | | 1.0 | | | | | | | |
| | C1-4 | | | | 1.0 | | | | | | |
| | C1-5 | | | | | 1.0 | | | | | |
| | C1-6 | | | | | | 1.0 | | | | |
| | C1-7 | 2.0 | 2.0 | 2.0 | | | | | | | |
| | C1-8 | | | | 2.0 | 2.0 | 2.0 | | | | |
| | C1-9 | | | | | | | 2.0 | 2.0 | 2.0 | 2.0 |
| Hydrogen donor (D) | D-1 | 3.0 | 3.0 | 3.0 | | | | | | | |
| | D-2 | | | | 3.0 | 3.0 | 3.0 | | | | |
| | D-3 | | | | | | | | | | |
| | D-4 | | | | | | | 3.0 | 3.0 | | |
| | D-5 | | | | | | | | | | |
| | D-6 | | | | | | | | | | |
| | D-7 | | | | | | | | | 3.0 | 3.0 |
| Dispersion containing urethane | E-1 | 5.0 | | | 5.0 | | | | | | |
| resin particles having | E-2 | | 5.0 | | | 5.0 | | | | | |
| polymerizable | E-3 | | | 5.0 | | | 5.0 | | | | |
| group (E) | E-4 | | | | | | | | | | |
| | E-5 | | | | | | | | | | |
| pH adjustor (F) | F-1 | 0.2 | 0.2 | 0.2 | | | | | | | |
| | F-2 | | | | | | 0.2 | 0.2 | 0.2 | 0.2 | 0.2 |
| | F-3 | | | | | | | | | | |
| | F-4 | | | | 0.2 | 0.2 | | | | | |
| Solvent (G) | G-1 | 5.0 | 10.0 | | 10.0 | 5.0 | 5.0 | 7.0 | 6.0 | 5.0 | 10.0 |
| | G-2 | 5.0 | | 10.0 | | 5.0 | 5.0 | 7.0 | 4.0 | 5.0 | 5.0 |
| | G-3 | 5.0 | 5.0 | 5.0 | 10.0 | 5.0 | 5.0 | | 8.0 | 5.0 | |
| Urethane emulsion | | | | | | | | | | | |
| Pigment dispersion | | 5.0 | 5.0 | 5.0 | 5.0 | 5.0 | 5.0 | 5.0 | 5.0 | 5.0 | 5.0 |
| Water | | 28.2 | 28.2 | 28.2 | 28.2 | 33.2 | 33.2 | 39.2 | 40.2 | 43.2 | 23.2 |
| Polymerization inhibitor | | 0.1 | 0.1 | 0.1 | 0.1 | 0.1 | 0.1 | 0.1 | 0.1 | 0.1 | 0.1 |
| Surfactant | | 0.5 | 0.5 | 0.5 | 0.5 | 0.5 | 0.5 | 0.5 | 0.5 | 0.5 | 0.5 |
| Total of the above components | | 100.0 | 100.0 | 100.0 | 100.0 | 100.0 | 100.0 | 100.0 | 100.0 | 100.0 | 100.0 |
| Evaluation | Scratch resistance | B | B | A | B | B | B | B | B | B | B |
| | Discharging stability | B | B | B | A | B | A | B | B | A | B |
| | Storage stability | A | A | A | B | A | A | B | A | A | B |
| | Skin sensitizing potential | B | A | B | A | B | A | B | A | B | A |

TABLE 6

| | | | Ex. | | | | | | | | | |
|---|---|---|---|---|---|---|---|---|---|---|---|---|
| | | | 21 | 22 | 23 | 24 | 25 | 26 | 27 | 28 | 29 | 30 |
| Acrylamide compound (A1) | | A1-1 | | | | | | | | | | 10.0 |
| | | A1-2 | | | | 5.0 | 5.0 | 5.0 | | | | |
| | | A1-3 | | | | | | | 5.0 | | | |
| | | A1-4 | | | | | | | | 5.0 | 5.0 | |
| | | A1-5 | | | | | | | | 5.0 | 5.0 | |
| | | A1-6 | | | | | | | | | | 5.0 |
| | | A1-7 | 5.0 | 5.0 | 5.0 | | | | | | | |
| | | A1-8 | | | | | | | | | | |
| Monofunctional polymerizable | | A2-1 | | | | | | | | | | |
| compound (A2) other than A1 | | A2-2 | | | | | | | | | | |
| Bifunctional or | Bifunctional | B1-1 | 2.0 | | | 5.0 | | | | | 5.0 | |
| higher | or higher | B1-2 | 2.0 | 2.0 | 2.0 | | 5.0 | | | | | 5.0 |
| polymerizable | polymerizable | B1-3 | 1.0 | 2.0 | 1.0 | | | 5.0 | | | | |
| compound | compound (B1) | B1-4 | | 1.0 | 2.0 | | | | 5.0 | | | |
| (B1) | other than B2 | B1-5 | | | | | | | | 5.0 | | |
| | | B1-6 | 5.0 | 5.0 | 5.0 | | | | | | | |
| | | B1-7 | 5.0 | 5.0 | 5.0 | | | | | | | |
| | | B1-8 | | | | | | | | | | |
| | Bifunctional or | B2-1 | 10.0 | 10.0 | 10.0 | 10.0 | 10.0 | 10.0 | | | | |
| | higher | B2-2 | 10.0 | 10.0 | 10.0 | | | | 10.0 | | | |
| | acrylamide | B2-3 | | | | 5.0 | | | | | 10.0 | 10.0 |
| | compound (B2) | B2-4 | | | | | 5.0 | 5.0 | 10.0 | 10.0 | | 10.0 |
| | | B2-5 | | | | 5.0 | | | | | | |

| | B2-6 | | | | | 5.0 | | | | | |
|---|---|---|---|---|---|---|---|---|---|---|---|
| | B2-7 | | | | | | 5.0 | | | | |
| | B2-8 | | | | | | | 5.0 | | | |
| | B2-9 | | | | | | | | 5.0 | | |
| | B2-10 | | | | | | 5.0 | | | 5.0 | |
| | B2-11 | | | | 5.0 | 5.0 | | | | | 5.0 |
| Polymerization initiator (C) | C1-1 | 1.0 | | | | | | 1.0 | 1.0 | 1.0 | 1.0 |
| | C1-2 | | 1.0 | | | | | | | | |
| | C1-3 | | | 1.0 | | | | | | | |
| | C1-4 | | | | 1.0 | | | | | | |
| | C1-5 | | | | | 1.0 | | | | | |
| | C1-6 | | | | | | 1.0 | | | | |
| | C1-7 | 2.0 | 2.0 | 2.0 | | | | | | | |
| | C1-8 | | | | 2.0 | 2.0 | 2.0 | | | | |
| | C1-9 | | | | | | | 2.0 | 2.0 | 2.0 | 2.0 |
| Hydrogen donor (D) | D-1 | 3.0 | 3.0 | 3.0 | | | | | | | |
| | D-2 | | | | 3.0 | 3.0 | 3.0 | | | | |
| | D-3 | | | | | | | | | | |
| | D-4 | | | | | | | 3.0 | 3.0 | | |
| | D-5 | | | | | | | | | | |
| | D-6 | | | | | | | | | | |
| | D-7 | | | | | | | | | 3.0 | 3.0 |
| Dispersion containing urethane | E-1 | 5.0 | | | 5.0 | | | | | | |
| resin particles having | E-2 | | 5.0 | | | 5.0 | | | | | |
| polymerizable group (E) | E-3 | | | 5.0 | | | 5.0 | | | | |
| | E-4 | | | | | | | | | | |
| | E-5 | | | | | | | | | | |
| pH adjustor (F) | F-1 | 0.2 | 0.2 | 0.2 | | | | | | | |
| | F-2 | | | | | | 0.2 | 0.2 | 0.2 | 0.2 | 0.2 |
| | F-3 | | | | | | | | | | |
| | F-4 | | | | 0.2 | 0.2 | | | | | |
| Solvent (G) | G-1 | 5.0 | 10.0 | | 10.0 | 5.0 | 5.0 | 7.0 | 6.0 | 5.0 | 10.0 |
| | G-2 | 5.0 | | 10.0 | | 5.0 | 5.0 | 7.0 | 4.0 | 5.0 | 5.0 |
| | G-3 | 5.0 | 5.0 | 5.0 | 10.0 | 5.0 | 5.0 | | 8.0 | 5.0 | |
| Urethane emulsion | | | | | | | | | | | |
| Pigment dispersion | | 5.0 | 5.0 | 5.0 | 5.0 | 5.0 | 5.0 | 5.0 | 5.0 | 5.0 | 5.0 |
| Water | | 28.2 | 28.2 | 28.2 | 28.2 | 33.2 | 33.2 | 39.2 | 40.2 | 43.2 | 28.2 |
| Polymerization inhibitor | | 0.1 | 0.1 | 0.1 | 0.1 | 0.1 | 0.1 | 0.1 | 0.1 | 0.1 | 0.1 |
| Surfactant | | 0.5 | 0.5 | 0.5 | 0.5 | 0.5 | 0.5 | 0.5 | 0.5 | 0.5 | 0.5 |
| Total of the above components | | 100.0 | 100.0 | 100.0 | 100.0 | 100.0 | 100.0 | 100.0 | 100.0 | 100.0 | 100.0 |
| Evaluation | Scratch resistance | B | B | B | B | B | B | B | B | B | B |
| | Discharging stability | B | B | B | B | B | B | B | B | A | B |
| | Storage stability | A | B | A | A | B | A | B | A | B | B |
| | Skin sensitizing potential | B | A | A | B | A | B | A | A | B | A |

TABLE 7

| | | | Ex. | | | | | | | | | |
|---|---|---|---|---|---|---|---|---|---|---|---|---|
| | | | 31 | 32 | 33 | 34 | 35 | 36 | 37 | 38 | 39 | 40 |
| Acrylamide compound (A1) | | A1-1 | 20.0 | | | | | 10.0 | 10.0 | 20.0 | | 10.0 |
| | | A1-2 | | 20.0 | | 5.0 | 5.0 | 5.0 | | | | |
| | | A1-3 | | | | | | | | | | |
| | | A1-4 | | | | | | | | | | |
| | | A1-5 | | | | | | | | | | |
| | | A1-6 | | | | | | | | | | 5.0 |
| | | A1-7 | 5.0 | 5.0 | 5.0 | | | | | | | |
| | | A1-8 | | | | | | | | | 15.0 | |
| Monofunctional polymerizable | | A2-1 | | | | | | | | | | |
| compound (A2) other than A1 | | A2-2 | | | | | | | | | | |
| Bifunctional | Bifunctional or | B1-1 | | | | 5.0 | | | | | 5.0 | |
| or higher | higher | B1-2 | | | 2.0 | | 5.0 | | | | | 5.0 |
| polymerizable | polymerizable | B1-3 | | | 1.0 | | | 5.0 | | | | |
| compound | compound (B1) | B1-4 | | | 2.0 | | | | 5.0 | | | |
| (B1) | other than B2 | B1-5 | | | | | | | | 5.0 | | |
| | | B1-6 | | | 5.0 | | | | | | | |
| | | B1-7 | | | 5.0 | | | | | | | |
| | | B1-8 | | | | | | | | | | |
| | Bifunctional or | B2-1 | 10.0 | 10.0 | 10.0 | 10.0 | 8.0 | 10.0 | | | | |
| | higher acrylamide | B2-2 | | 10.0 | 10.0 | | | | 10.0 | 10.0 | | |
| | compound (B2) | B2-3 | 10.0 | | | 5.0 | | | | | 10.0 | |
| | | B2-4 | | | | | 5.0 | | 8.0 | 8.0 | | 10.0 |

| | B2-5 | | | | 5.0 | | | | | | |
|---|---|---|---|---|---|---|---|---|---|---|---|
| | B2-6 | | | | | 5.0 | | | | | |
| | B2-7 | | | | | | | | | | |
| | B2-8 | | | | | | | 5.0 | | | |
| | B2-9 | | | | | | | | 5.0 | | |
| | B2-10 | | | | | | | | | 3.0 | |
| | B2-11 | | | | 5.0 | 5.0 | | | | | 3.0 |
| Polymerization initiator (C) | C1-1 | 1.0 | | | | | | 1.0 | 1.0 | 1.0 | 1.0 |
| | C1-2 | | 1.0 | | | | | | | | |
| | C1-3 | | | 1.0 | | | | | | | |
| | C1-4 | | | | 1.0 | | | | | | |
| | C1-5 | | | | | 1.0 | | | | | |
| | C1-6 | | | | | | 1.0 | | | | |
| | C1-7 | 2.0 | 2.0 | 2.0 | | | | | | | |
| | C1-8 | | | | 2.0 | 2.0 | 2.0 | | | | |
| | C1-9 | | | | | | | 2.0 | 2.0 | 2.0 | 2.0 |
| Hydrogen donor (D) | D-1 | 3.0 | 3.0 | 3.0 | | | | | | | |
| | D-2 | | | | 3.0 | 3.0 | 3.0 | | | | |
| | D-3 | | | | | | | | | | |
| | D-4 | | | | | | | 3.0 | 3.0 | | |
| | D-5 | | | | | | | | | | |
| | D-6 | | | | | | | | | | |
| | D-7 | | | | | | | | | 3.0 | 3.0 |
| Dispersion containing urethane | E-1 | 5.0 | | | 12.0 | | | 2.0 | | | |
| resin particles having | E-2 | | 5.0 | | | 12.0 | | | 2.0 | | |
| polymerizable group (E) | E-3 | | | 5.0 | | | 12.0 | | | | |
| | E-4 | | | | | | | | | 12.0 | |
| | E-5 | | | | | | | | | | 12.0 |
| pH adjustor (F) | F-1 | 0.2 | 0.2 | 0.2 | | | | | | | |
| | F-2 | | | | | | | | | 0.2 | |
| | F-3 | | | | | | 0.2 | 0.2 | 0.2 | | 0.2 |
| | F-4 | | | | 0.2 | 0.2 | | | | | |
| Solvent (G) | G-1 | 5.0 | 10.0 | | 10.0 | 5.0 | | | | | |
| | G-2 | 5.0 | | 10.0 | | 2.0 | 5.0 | 7.0 | 4.0 | 5.0 | 5.0 |
| | G-3 | 5.0 | 5.0 | 5.0 | 10.0 | 3.0 | 3.0 | | 8.0 | 5.0 | |
| Urethane emulsion | | | | | | | | | | | |
| Pigment dispersion | | 5.0 | 5.0 | 5.0 | 5.0 | 5.0 | 5.0 | 5.0 | 5.0 | 5.0 | 5.0 |
| Water | | 23.2 | 23.2 | 28.2 | 21.2 | 33.2 | 33.2 | 29.2 | 20.2 | 28.2 | 28.2 |
| Polymerization inhibitor | | 0.1 | 0.1 | 0.1 | 0.1 | 0.1 | 0.1 | 0.1 | 0.1 | 0.1 | 0.1 |
| Surfactant | | 0.5 | 0.5 | 0.5 | 0.5 | 0.5 | 0.5 | 0.5 | 0.5 | 0.5 | 0.5 |
| Total of the above components | | 100.0 | 100.0 | 100.0 | 100.0 | 100.0 | 100.0 | 100.0 | 100.0 | 100.0 | 100.0 |
| Evaluation | Scratch resistance | B | B | B | B | B | B | B | B | B | B |
| | Discharging stability | B | B | B | B | A | A | A | A | A | A |
| | Storage stability | A | B | A | A | B | A | B | A | B | B |
| | Skin sensitizing potential | B | B | A | B | A | B | A | A | A | A |

TABLE 8

| | | | Comp. Ex. | | | | | | | | | | |
|---|---|---|---|---|---|---|---|---|---|---|---|---|---|
| | | | 1 | 2 | 3 | 4 | 5 | 6 | 7 | 8 | 9 | 10 | 11 |
| Acrylamide compound (A1) | | A1-1 | | | | | | | | | | | 20.0 |
| | | A1-2 | | | | | | | | | | | 15.0 |
| | | A1-3 | | | | | | | | | | | |
| | | A1-4 | | | | | | | | | | | |
| | | A1-5 | | | | | | | | | | | |
| | | A1-6 | | | | | | | | | | | |
| | | A1-7 | | | | | | | | | | | |
| | | A1-8 | | | | | | | | | | | |
| Monofunctional polymerizable | | A2-1 | 5.0 | 5.0 | 5.0 | | | | | | | | |
| compound (A2) other than A1 | | A2-2 | | | | 5.0 | 5.0 | 5.0 | 5.0 | 5.0 | 5.0 | 5.0 | |
| Bifunctional | Bifunctional or | B1-1 | | | | | | | | 5.0 | 5.0 | 5.0 | |
| or higher | higher | B1-2 | | | | | | | | 5.0 | 5.0 | 5.0 | |
| polymerizable | polymerizable | B1-3 | 5.0 | 5.0 | 5.0 | 5.0 | 5.0 | 5.0 | 5.0 | 5.0 | 5.0 | 5.0 | |
| compound | compound (B1) | B1-4 | | 5.0 | | | | | | | | | |
| (B1) | other than B2 | B1-5 | 5.0 | | | | | | | 5.0 | | | |
| | | B1-6 | | | | | | | | | | | |
| | | B1-7 | | | 5.0 | | 5.0 | | 5.0 | | 5.0 | | |
| | | B1-8 | | | | 5.0 | | 5.0 | | | | 5.0 | |
| | Bifunctional or | B2-1 | | | | | | | | | | | |
| | higher acrylamide | B2-2 | | | | | | | | | | | |
| | compound (B2) | B2-3 | | | | | | | | | | | |
| | | B2-4 | | | | | | | | | | | |

| | B2-5 | 5.0 | | | | 5.0 | | | | 5.0 | | |
|---|---|---|---|---|---|---|---|---|---|---|---|---|
| | B2-6 | | 5.0 | | | | 5.0 | | | | 5.0 | |
| | B2-7 | | | 5.0 | | | | 5.0 | | | | |
| | B2-8 | | | | 5.0 | | | | 5.0 | | | |
| | B2-9 | 5.0 | | | | 5.0 | | | | | | |
| | B2-10 | | 5.0 | | | | 5.0 | | | | | |
| | B2-11 | | | | 5.0 | | | 5.0 | 5.0 | 5.0 | 5.0 | |
| Polymerization initiator (C) | C1-1 | 3.0 | | | | | | | | | | |
| | C1-2 | | 3.0 | | | | | 3.0 | | | | |
| | C1-3 | | | 3.0 | | | | | 3.0 | | | |
| | C1-4 | | | | 3.0 | | | | | 3.0 | | |
| | C1-5 | | | | | 3.0 | | | | | 3.0 | 3.0 |
| | C1-6 | | | | | | 3.0 | | | | | |
| | C1-7 | 3.0 | 3.0 | 3.0 | | | | | | | | |
| | C1-8 | | | | 3.0 | 3.0 | 3.0 | | | | | |
| | C1-9 | | | | | | | 3.0 | 3.0 | 3.0 | 3.0 | 3.0 |
| Hydrogen donor (D) | D-1 | | | | | | | | | | | |
| | D-2 | | | | | | | | | | | |
| | D-3 | 1.0 | 1.0 | | | | | | | | | |
| | D-4 | | | 1.0 | 1.0 | | | | | | | |
| | D-5 | | | | | 1.0 | 1.0 | | | | | |
| | D-6 | | | | | | | 1.0 | 1.0 | | | |
| | D-7 | | | | | | | | | 1.0 | 1.0 | 1.0 |
| Dispersion containing urethane | E-1 | | | | | | | | | | | |
| resin particles having | E-2 | | | | | | | | | | | |
| polymerizable group (E) | E-3 | | | | | | | | | | | |
| | E-4 | 5.0 | 5.0 | 5.0 | 5.0 | 5.0 | | | | | | |
| | E-5 | | | | | | 5.0 | 5.0 | 5.0 | | | |
| pH adjustor (F) | F-1 | | | | | | | | | | | |
| | F-2 | | | | | | | | | | | |
| | F-3 | 0.2 | 0.2 | 0.2 | 0.2 | 0.2 | 0.2 | 0.2 | 0.2 | 0.2 | 0.2 | 0.2 |
| | F-4 | | | | | | | | | | | |
| Solvent (G) | G-1 | 5.0 | 10.0 | 10.0 | 10.0 | 5.0 | 5.0 | 7.0 | 6.0 | 5.0 | 10.0 | 10.0 |
| | G-2 | 5.0 | 10.0 | 10.0 | 10.0 | 5.0 | 5.0 | 7.0 | 4.0 | 15.0 | 5.0 | 5.0 |
| | G-3 | 5.0 | 5.0 | 5.0 | 10.0 | 5.0 | 15.0 | 15.0 | 10.0 | 5.0 | 15.0 | 15.0 |
| Urethane emulsion | | | | | | | | | | 8.0 | 8.0 | 8.0 |
| Pigment dispersion | | 5.0 | 5.0 | 5.0 | 5.0 | 5.0 | 5.0 | 5.0 | 5.0 | 5.0 | 5.0 | 5.0 |
| Water | | 42.2 | 32.2 | 32.2 | 27.2 | 42.2 | 32.2 | 28.2 | 27.2 | 19.2 | 14.2 | 14.2 |
| Polymerization inhibitor | | 0.1 | 0.1 | 0.1 | 0.1 | 0.1 | 0.1 | 0.1 | 0.1 | 0.1 | 0.1 | 0.1 |
| Surfactant | | 0.5 | 0.5 | 0.5 | 0.5 | 0.5 | 0.5 | 0.5 | 0.5 | 0.5 | 0.5 | 0.5 |
| Total of the above components | | 100.0 | 100.0 | 100.0 | 100.0 | 100.0 | 100.0 | 100.0 | 100.0 | 100.0 | 100.0 | 100.0 |
| Evaluation | Scratch resistance | C | C | C | C | C | C | C | C | C | C | C |
| | Discharging stability | B | B | B | B | B | B | B | B | B | B | D |
| | Storage stability | D | D | D | C | C | D | D | C | D | C | D |
| | Skin sensitizing potential | B | B | B | D | D | D | D | D | D | D | B |

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. An active-energy-ray-curable aqueous composition comprising:
water;
a polymerizable compound that undergoes radical polymerization in response to active energy rays; and
a polymerization initiator (C1) that produces radicals in response to active energy rays,
wherein the polymerizable compound comprises: at least one kind of an acrylamide compound (A1) selected from the group consisting of acrylamide compounds represented by General formula (1) below and acrylamide compounds represented by General formula (4) below; and a bifunctional or higher polymerizable compound (B1), 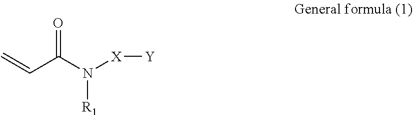
where in the General formula (1), R₁ represents an alkyl group containing from one through six carbon atoms, X represents an alkylene group containing from one through six carbon atoms, and Y represents a group represented by General formula (2) below or General formula (3) below, 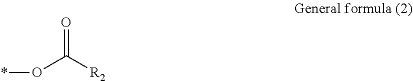
where in the General formula (2), R₂ represents an alkyl group containing from one through ten carbon atoms, and * represents a binding site with the X, 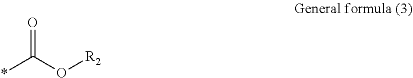
where in the General formula (3), R₂ represents an alkyl group containing from one through ten carbon atoms, and * represents a binding site with the X, 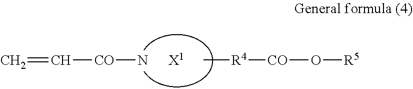
where in the General formula (4), a ring X¹ represents a ring structure containing a nitrogen atom and from two through five carbon atoms, R⁴ represents a single bond, or a straight-chained or branched alkylene group containing from one through three carbon atoms, and R⁵ represents a straight-chained or branched alkyl group containing from one through ten carbon atoms.

2. The active-energy-ray-curable aqueous composition according to claim 1,
wherein the acrylamide compound (A1) comprises an acrylamide compound represented by the General formula (1) in which the Y is a group represented by the General formula (3), and the R₂ is an alkyl group containing one or two carbon atoms.

3. The active-energy-ray-curable aqueous composition according to claim 1,
wherein the bifunctional or higher polymerizable compound (B1) is a bifunctional or higher acrylamide compound (B2) represented by General formula (5) below, 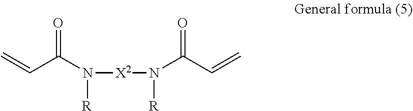
where in the General formula (5), R represents a hydrogen atom, or an alkyl group containing from one through four carbon atoms, and may have a branch structure, and X² represents an alkylene group containing from one through thirty carbon atoms, or a group in which oxygen, nitrogen, or sulfur atoms are substituted for some of the carbon atoms of the alkylene group containing from one through thirty carbon atoms, wherein the group may contain a polar functional group, a (meth)acrylate group, or a (meth)acrylamide group as substituents.

4. The active-energy-ray-curable aqueous composition according to claim 1, further comprising a dispersion containing resin particles having a polymerizable group,
wherein a volume average particle diameter D50 of the resin particles contained in the dispersion is 5 nm or greater but 50 nm or less.

5. The active-energy-ray-curable aqueous composition according to claim 4,
wherein solid components of the dispersion containing resin particles having a polymerizable group account for 2% by mass or greater but 12% by mass or less of the active-energy-ray-curable aqueous composition.

6. The active-energy-ray-curable aqueous composition according to claim 1, further comprising an amine compound,
wherein the amine compound comprises an organic amine compound having a boiling point of 120 degrees C. or higher but 200 degrees C. or less and a molecular weight of 100 or less.

7. The active-energy-ray-curable aqueous composition according to claim 1,
wherein the polymerization initiator (C1) is water-soluble.

8. The active-energy-ray-curable aqueous composition according to claim 1, further comprising a hydrogen donor (D).

9. The active-energy-ray-curable aqueous composition according to claim 1, further comprising a pigment.

10. The active-energy-ray-curable aqueous composition according to claim 1,
wherein the water accounts for 1% by mass or greater but 50% by mass or less of the active-energy-ray-curable aqueous composition.

11. An active-energy-ray-curable aqueous ink comprising
the active-energy-ray-curable aqueous composition according to claim 1.

12. The active-energy-ray-curable aqueous ink according to claim 11,
wherein the active-energy-ray-curable aqueous ink is for inkjet.

13. A composition stored container comprising:
a container; and
the active-energy-ray-curable aqueous composition according to claim 1 contained in the container.

14. A two-dimensional or three-dimensional image forming apparatus comprising:
a storing part including a container containing the active-energy-ray-curable aqueous composition according to claim 1; and
an irradiator configured to irradiate the composition with active energy rays.

15. The two-dimensional or three-dimensional image forming apparatus according to claim 14,
wherein the irradiator is a ultraviolet light-emitting diode configured to emit ultraviolet rays having a peak in a wavelength range of from 365 nm through 405 nm.

16. A two-dimensional or three-dimensional image forming method comprising
irradiating the active-energy-ray-curable aqueous composition according to claim 1 with active energy rays to form a two-dimensional or three-dimensional image.

17. The two-dimensional or three-dimensional image forming method according to claim 16,
wherein the irradiating comprises irradiating the active-energy-ray-curable aqueous composition with ultraviolet rays having a peak in a wavelength range of from 365 nm through 405 nm using a ultraviolet light-emitting diode.

18. A cured product comprising:
a reaction product of: at least one kind of an acrylamide compound (A1) selected from the group consisting of acrylamide compounds represented by General formula (1) below and acrylamide compounds represented by General formula (4) below; and a bifunctional or higher polymerizable compound (B1), 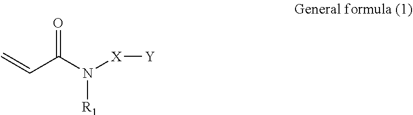
where in the General formula (1), R₁ represents an alkyl group containing from one through six carbon atoms, X represents an alkylene group containing from one through six carbon atoms, and Y represents a group represented by General formula (2) below or General formula (3) below, 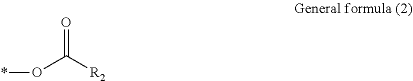
where in the General formula (2), R₂ represents an alkyl group containing from one through ten carbon atoms, and * represents a binding site with the X, 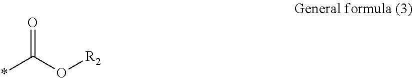
where in the General formula (3), R₂ represents an alkyl group containing from one through ten carbon atoms, and * represents a binding site with the X, 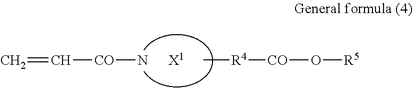
where in the General formula (4), a ring X′ represents a ring structure containing a nitrogen atom and from two through five carbon atoms, R⁴ represents a single bond, or a straight-chained or branched alkylene group containing from one through three carbon atoms, and R⁵ represents a straight-chained or branched alkyl group containing from one through ten carbon atoms.

19. A decorated product comprising:
a base material; and
a surface decoration applied over the base material,
wherein the surface decoration is formed of the cured product according to claim 18.
